(19) United States
(12) Patent Application Publication
(10) Pub. No.: US 2026/0365402 A1
(43) Pub. Date: Nov. 19, 2026

(54) LIQUID-CONTAINING COMBINATION CONTAINER, CONTAINER SET, AND METHOD FOR MANUFACTURING LIQUID-CONTAINING CONTAINER

(71) Applicant: DAI NIPPON PRINTING CO., LTD., Tokyo-to (JP)

(72) Inventors: Takayuki HASEGAWA, Tokyo-to (JP); Noriko NAKATA, Tokyo-to (JP); Masako TSUCHIDA, Tokyo-to (JP); Kazuhiro TAKUSHIMA, Tokyo-to (JP); Shun ISHIKAWA, Tokyo-to (JP); Takuma BABA, Tokyo-to (JP); Noriko KUMAZAWA, Tokyo-to (JP); Koichi TATSUMI, Tokyo-to (JP)

(73) Assignee: DAI NIPPON PRINTING CO., LTD., Tokyo-to (JP)

(21) Appl. No.: 19/116,757

(22) PCT Filed: Sep. 28, 2023
(86) PCT No.: PCT/JP2023/035557

§ 371 Date: Jan. 16, 2026

(30) Foreign Application Priority Data
Sep. 28, 2022 (JP) 2022-155602

(51) Int. Cl. B65D 77/04; B65D 65/40; B65D 81/26

(52) U.S. Cl. CPC B65D 77/0406; B65D 65/40; B65D 81/267

(57) ABSTRACT

A liquid-containing combination container includes a first container containing a liquid and having oxygen permeability and a second container containing the first container and having an oxygen barrier property. The second container includes a laminate. The laminate includes an inner surface facing a storage space and an outer surface opposite to the inner surface. The laminate a sealant layer, a first barrier layer, a resin layer, and a second barrier layer, in that order from the inner surface toward the outer surface.

### TECHNICAL FIELD

The present disclosure relates to a liquid-containing combination container, a container set, and a method for manufacturing a liquid-containing container.

### BACKGROUND ART

A container for containing a liquid is known (for example, Patent Literature 1). Depending on the type of liquid, the liquid is decomposed by oxygen in the container. To address this problem, the use of a container with an oxygen barrier property is considered.
PTL 1: Japanese Unexamined Patent Application Publication No. 2011-212366

### SUMMARY OF INVENTION

However, oxygen can dissolve into the liquid when the liquid is produced. A container with an oxygen barrier property cannot address the deterioration of the liquid caused by dissolved oxygen in the liquid. That is, an existing technique cannot sufficiently suppress the degradation of the liquid contained in the container due to oxygen. It is an object of the present disclosure to suppress the degradation of a liquid due to oxygen.

A first liquid-containing combination container according to an embodiment of the present disclosure includes:
a first container containing a liquid and having oxygen permeability; and
a second container containing the first container and having an oxygen barrier property,
in which the second container includes a laminate,
the laminate includes an inner surface facing a storage space of the second container and an outer surface opposite to the inner surface, and
the laminate includes a sealant layer, a first barrier layer, a resin layer, and a second barrier layer, in that order from the inner surface toward the outer surface.

A second liquid-containing combination container according to an embodiment of the present disclosure includes:
a first container containing liquid and having oxygen permeability;
a second container containing the first container and having an oxygen barrier property; and
an oxygen-absorbing member contained in the second container,
in which the oxygen-absorbing member contains an oxygen absorber that absorbs oxygen in the second container,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the first container is positioned between the first seal portion and the oxygen-absorbing member in the direction in which the first seal portion and the first container face each other.

A third liquid-containing combination container according to an embodiment of the present disclosure includes:
a first container containing a liquid and having oxygen permeability; and
a second container containing the first container and having an oxygen barrier property,
in which the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the seal portion further includes a first side seal portion connected to one end of the first seal portion, a second side seal portion connected to the other end of the first seal portion, and an additional seal portion positioned between the first container and at least one of the first side seal portion or the second side seal portion.

A method for manufacturing a liquid-containing container according to an embodiment of the present disclosure is a method for manufacturing a liquid-containing container using a liquid-containing combination container according to an embodiment of the present disclosure and includes:
closing the second container containing the first container; and
adjusting an oxygen concentration by absorbing oxygen in the second container with an oxygen absorber,
in which in the step of adjusting the oxygen concentration, oxygen in the first container permeates the first container to move outside the first container and is absorbed by the oxygen absorber in the second container.

A first container set according to an embodiment of the present disclosure includes:
a first container containing a liquid; and
a second container containing the first container,
in which the first container has oxygen permeability,
the second container has an oxygen barrier property,
the second container includes a laminate,
the laminate includes an inner surface facing a storage space of the second container and an outer surface opposite to the inner surface, and
the laminate includes a sealant layer, a first barrier layer, a resin layer, and a second barrier layer, in that order from the inner surface toward the outer surface.

A second container set according to an embodiment of the present disclosure includes:
a first container containing a liquid;
a second container containing the first container; and
an oxygen-absorbing member contained in the second container,
in which the first container has oxygen permeability,
the second container has an oxygen barrier property,
the oxygen-absorbing member contains an oxygen absorber that absorbs oxygen in the second container,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the first container is positioned between the first seal portion and the oxygen-absorbing member in the direction in which the first seal portion and the first container face each other.

A third container set according to an embodiment of the present disclosure includes:
a first container containing a liquid; and
a second container containing the first container,
in which the first container has oxygen permeability,
the second container has an oxygen barrier property,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the seal portion further includes a first side seal portion connected to one end of the first seal portion, a second side seal portion connected to the other end of the first seal portion, and an additional seal portion positioned between the first container and at least one of the first side seal portion or the second side seal portion.

A container according to an embodiment of the present disclosure includes:
a laminate,
in which the laminate includes a sealant layer, a first barrier layer, a resin layer, and a second barrier layer, in that order from the inner surface toward the outer surface.

A laminate according to an embodiment of the present disclosure is
a laminate used for a container and includes:
a sealant layer, a first barrier layer, a resin layer, and a second barrier layer, in that order from the inner surface toward the outer surface.

According to the present disclosure, the deterioration of the liquid due to oxygen can be suppressed.

### BRIEF DESCRIPTION OF DRAWINGS

FIG. 1 is a diagram for explaining an embodiment of the present disclosure and is a perspective view illustrating an example of a liquid-containing combination container.

FIG. 2A is a longitudinal sectional view illustrating a liquid-containing first container that can be included in the liquid-containing combination container in FIG. 1.

FIG. 2B is a longitudinal sectional view illustrating a method for measuring the amount of oxygen permeation through a stopper of the first container illustrated in FIG. 2A.

FIG. 3 illustrates an example of a method for manufacturing the liquid-containing combination container in FIG. 1 and the liquid-containing first container in FIG. 2A.

FIG. 4 illustrates an example of the method for manufacturing the liquid-containing combination container in FIG. 1 and the liquid-containing first container in FIG. 2A.

FIG. 5 illustrates an example of the method for manufacturing the liquid-containing combination container in FIG. 1 and the liquid-containing first container in FIG. 2A.

FIG. 6 is a perspective view illustrating a method for using the liquid-containing first container in FIG. 2A.

FIG. 7A is a perspective view illustrating another example of a second container.

FIG. 7B is a perspective view illustrating another example of a second container.

FIG. 7C is a perspective view illustrating another example of a second container.

FIG. 7D is a perspective view illustrating another example of a second container.

FIG. 8 is a perspective view illustrating a variation of a second container.

FIG. 9A is a sectional view illustrating an example of an oxygen-absorbing member containing an oxygen absorber.

FIG. 9B is a sectional view illustrating another example of an oxygen-absorbing member containing an oxygen absorber.

FIG. 9C is a sectional view illustrating an example of an oxygen-absorbing film containing an oxygen absorber.

FIG. 10 is a diagram for explaining a specific example of a second container and is a front view illustrating a liquid-containing combination container.

FIG. 11 is a sectional side view illustrating the liquid-containing combination container illustrated in FIG. 10.

FIG. 12 is a front view illustrating a method for manufacturing the liquid-containing combination container illustrated in FIG. 10.

FIG. 13 is a front view illustrating the method for manufacturing the liquid-containing combination container illustrated in FIG. 10.

FIG. 14 is a front view illustrating the method for manufacturing the liquid-containing combination container illustrated in FIG. 10.

FIG. 15A is a front view illustrating a variation of the first seal portion of the second container illustrated in FIG. 10.

FIG. 15B is a front view illustrating another variation of the first seal portion illustrated in FIG. 10.

FIG. 15C is a front view illustrating another variation of the first seal portion illustrated in FIG. 10.

FIG. 15D is a front view illustrating another variation of the first seal portion illustrated in FIG. 10.

FIG. 16 is a front view illustrating a variation of the auxiliary seal portion of the second container illustrated in FIG. 10.

FIG. 17 is a sectional side view illustrating a variation of the liquid-containing combination container illustrated in FIG. 10.

FIG. 18 is a perspective view illustrating a method for manufacturing the liquid-containing combination container illustrated in FIG. 17.

FIG. 19 is a front view illustrating a variation where the seal portion of the second container illustrated in FIG. 10 is notched.

FIG. 20 is a front view illustrating a variation in which the second container illustrated in FIG. 10 is provided with an additional seal portion.

FIG. 21 is a diagram illustrating a method for opening the second container illustrated in FIG. 20.

FIG. 22 is a front view illustrating a variation of the additional seal portion illustrated in FIG. 20.

FIG. 23 is a front view illustrating another variation of the additional seal portion illustrated in FIG. 20.

FIG. 24 is a front view illustrating another variation of the additional seal portion illustrated in FIG. 20.

FIG. 25 is a front view illustrating another variation of the liquid-containing combination container illustrated in FIG. 10.

FIG. 26A illustrates an example of a layer configuration of a laminate that can be used for a second container as a film container.

FIG. 26B illustrates another example of a layer configuration of a laminate that can be used for a second container as a film container.

FIG. 26C illustrates another example of a layer configuration of a laminate that can be used for a second container as a film container.

FIG. 26D illustrates another example of a layer configuration of a laminate that can be used for a second container as a film container.

FIG. 26E illustrates another example of a layer configuration of a laminate that can be used for a second container as a film container.

FIG. 26F illustrates another example of a layer configuration of a laminate that can be used for a second container as a film container.

### DESCRIPTION OF EMBODIMENTS

Embodiments of the present disclosure relates to [1] to [42] described below.
[1]A liquid-containing combination container, includes:
a first container containing a liquid and having oxygen permeability; and
a second container containing the first container and having an oxygen barrier property,
in which the second container includes a laminate,
the laminate includes an inner surface facing a storage space of the second container and an outer surface opposite to the inner surface, and
the laminate includes a sealant layer, a first barrier layer, a resin layer, and a second barrier layer, in that order from the inner surface toward the outer surface.
[2] In the liquid-containing combination container described in [1], the resin layer contains a thermoplastic resin.
[3] In the liquid-containing combination container described in [1] or [2], the resin layer is a stretched film.
[4] In the liquid-containing combination container described in any one of [1] to [3], the resin layer has a thickness of 5 μm or more.
[5] In the liquid-containing combination container described in any one of [1] to [4], the laminate further includes a first adhesive layer positioned between the first barrier layer and the resin layer and a second adhesive layer positioned between the resin layer and the second barrier layer, and
each of the first adhesive layer and the second adhesive layer contains a cured product of a curable resin composition.
[6] In the liquid-containing combination container described in [5], the first adhesive layer is in contact with the resin layer.
[7] In the liquid-containing combination container described in [5], the first adhesive layer is in contact with the first barrier layer and the resin layer.
[8] In the liquid-containing combination container described in [6] or [7], the laminate further includes a first film substrate for barrier layer in contact with the first barrier layer, and
the first barrier layer is positioned between the first adhesive layer and the first film substrate for barrier layer.
[9] In the liquid-containing combination container described in any one of [5] to [8], the second adhesive layer is in contact with the resin layer.
[10] In the liquid-containing combination container described in any one of [5] to [8], the second adhesive layer is in contact with the second barrier layer and the resin layer.
[11] In the liquid-containing combination container described in [10], the laminate further includes a second film substrate for barrier layer in contact with the second barrier layer, and the second barrier layer is positioned between the second adhesive layer and the second film substrate for barrier layer.
[12] In the liquid-containing combination container described in any one of [1] to [11], the first barrier layer is a transparent vapor-deposited layer, and the second barrier layer is a transparent vapor-deposited layer.
[13] In the liquid-containing combination container described in any one of [1] to [12], the resin layer contains a polyamide.
[14] In the liquid-containing combination container described in any one of [1] to [13], the laminate further includes a second resin layer and a third barrier layer, and
the second barrier layer, the second resin layer, and the third barrier layer are arranged in that order from the inner surface toward the outer surface.
[15] In the liquid-containing combination container described in any one of [1] to [14], the laminate has an oxygen transmission rate of less than 0.20 mL/(m²×day×atm) or less.
[16] The liquid-containing combination container described in any one of [1] to [15] further includes an oxygen absorber that absorbs oxygen in the second container.
[17] In the liquid-containing combination container described in any one of [1] to [16], an oxygen detection member that detects a state of oxygen in the second container is provided.
[18]A liquid-containing combination container includes:
a first container containing a liquid and having oxygen permeability;
a second container containing the first container and having an oxygen barrier property; and
an oxygen-absorbing member contained in the second container,
in which the oxygen-absorbing member contains an oxygen absorber that absorbs oxygen in the second container,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the first container is positioned between the first seal portion and the oxygen-absorbing member in the direction in which the first seal portion and the first container face each other.
[19] In the liquid-containing combination container described in [18], the first container includes a container body including an opening portion and a stopper that closes the opening portion,
the stopper has oxygen permeability,
the container body faces the first seal portion, and the stopper faces the oxygen-absorbing member.
[20] In the liquid-containing combination container described in [18], the first container includes a container body including an opening portion and a stopper that closes the opening portion,
the stopper has oxygen permeability,
the stopper faces the first seal portion, and the container body faces the oxygen-absorbing member.
[21] In the liquid-containing combination container described in any one of [18] to [20], the seal portion includes a first side seal portion connected to one end of the first seal portion and a second side seal portion connected to the other end of the first seal portion,
a space in which the first container is disposed is provided between the first side seal portion and the second side seal portion,
at least one of the first side seal portion or the second side seal portion is provided with a notch, and
the second container is openable by cutting the first film and the second film using the notch as a starting point.
[22] In the liquid-containing combination container described in [21], each of the first film and the second film includes a to-be-opened portion designed to be cut using the notch as a starting point, and
the to-be-opened portion is positioned between the oxygen-absorbing member and the first container.
[23] In the liquid-containing combination container described in any one of [18] to [22], each of the first film and the second film includes a main portion that provides a space in which the first container is disposed and an extension portion connected to the main portion, and
the seal portion includes a main seal portion that defines the space in which the first container is disposed and an auxiliary seal portion that joins the first film and the second film at the extension portion.
[24] In the liquid-containing combination container described in [23], the main seal portion includes the first seal portion, the first side seal portion connected to one end of the first seal portion, and the second side seal portion connected to the other end of the first seal portion, and
the auxiliary seal portion includes a first auxiliary seal portion connected to the first side seal portion, and a second auxiliary seal portion connected to the second side seal portion.
[25] In the liquid-containing combination container described in [23], the auxiliary seal portion is separated from the main seal portion.
[26] In the liquid-containing combination container described in [25], the main seal portion includes the first seal portion, a first side seal portion connected to one end of the first seal portion, and a second side seal portion connected to the other end of the first seal portion, and
the auxiliary seal portion includes a first auxiliary seal portion positioned on an extension line of the first side seal portion and a second auxiliary seal portion positioned on an extension line of the second side seal portion.
[27] In the liquid-containing combination container described in any one of [18] to [26], the seal portion includes the first side seal portion connected to one end of the first seal portion, the second side seal portion connected to the other end of the first seal portion, and an additional seal portion positioned between the first container and at least one of the first side seal portion or the second side seal portion.
[28] In the liquid-containing combination container described in [27], the additional seal portion includes a first additional side seal portion positioned between the first side seal portion and the first container, and a second additional side seal portion positioned between the second side seal portion and the first container.
[29] In the liquid-containing combination container described in [27], the additional seal portion is connected to the at least one of the first side seal portion or the second side seal portion.
[30] In the liquid-containing combination container described in any one of [27] to [29], an end of the first container on a side adjacent (near) to the first seal portion is positioned, in the direction in which the first seal portion and the first container face each other, at a position identical to an end of the additional seal portion on a side adjacent (near) to the first seal portion or at a position closer to the first seal portion than the end of the additional seal portion on a side adjacent (near) to the first seal portion.
[31] In the liquid-containing combination container described in any one of [27] to [30], an inner edge of the additional seal portion facing the first container is positioned further away from the at least one of the first side seal portion or the second side seal portion as the inner edge is positioned closer to the first seal portion in the direction in which the first seal portion and the first container face each other.
[32] In the liquid-containing combination container described in any one of [18] to [31], the second container is bent with the second film inside so that a first portion of the second container containing the first container and a second portion of the second container overlap,
the second portion is positioned on one side of the first portion in the direction in which the first seal portion and the first container face each other in a state where the second container before being bent is unfolded, and
the oxygen-absorbing member is bent together with the second container, with a middle portion of the oxygen-absorbing member positioned on a bend apex portion of the second film.
[33] The liquid-containing combination container described in [32] further includes an oxygen detection member positioned between the oxygen-absorbing member and the first film.
[34] In the liquid-containing combination container described in [32] or [33], the second container is further bent with the second film inside, the first portion and a third portion of the second container overlap,
the third portion is positioned on the other side of the first portion in the direction in which the first seal portion and the first container face each other in a state where the second container is unfolded before being bent, and
the first portion, the third portion, and the second portion overlap each other in that order.
[35] The liquid-containing combination container described in any one of [18] to [34] further includes an outer box containing the second container,
in which the first container includes a container body including an opening portion, and a stopper that closes the opening portion,
the stopper has oxygen permeability,
the second container contains the first container and the oxygen-absorbing member, one of the stopper and the container body is close to the first seal portion, and the other of the stopper and the container body is close to the oxygen-absorbing member,
the second container is bent with the second film inside so that a first portion of the second container containing the first container and a second portion of the second container overlap,
the second container is further bent with the second film inside so that the first portion and a third portion of the second container overlap,
the second portion is positioned on one side of the first portion in the direction in which the first seal portion and the first container face each other in a state where the second container is unfolded before being bent,
the third portion is positioned on the other side of the first portion in the direction in which the first seal portion and the first container face each other in a state where the second container is unfolded before being bent,
the outer box includes a bottom portion, a top portion opposite the bottom portion, and a side wall portion located between the bottom portion and the bottom portion, and
the second container is bent and contained in the outer box, the first portion, the second portion, and the third portion overlap each other, the container body of the first container faces the bottom portion of the outer box, and the stopper of the first container faces the top portion of the outer box.
[36]A liquid-containing combination container includes:
a first container containing a liquid and having oxygen permeability; and
a second container containing the first container and having an oxygen barrier property,
in which the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project away from the first container in a direction in which the first seal portion and the first container face each other, and
the seal portion further includes a first side seal portion connected to one end of the first seal portion, a second side seal portion connected to the other end of the first seal portion, and an additional seal portion positioned between the first container and at least one of the first side seal portion or the second side seal portion.
[37]A method for manufacturing a liquid-containing container using the liquid-containing combination container described in any one of [1] to [36] includes:
closing the second container containing the first container; and
adjusting an oxygen concentration by absorbing oxygen in the second container with an oxygen absorber,
in which in the step of adjusting the oxygen concentration, oxygen in the first container permeates the first container to move outside the first container and is absorbed by the oxygen absorber in the second container.
[38]A container set includes:
a first container containing a liquid; and
a second container containing the first container,
in which the first container has oxygen permeability,
the second container has an oxygen barrier property,
the second container includes a laminate,
the laminate includes an inner surface facing a storage space of the second container and an outer surface opposite to the inner surface, and
the laminate includes a sealant layer, a first barrier layer, a resin layer, and a second barrier layer, in that order from the inner surface toward the outer surface.
[39]A container set includes:
a first container containing a liquid;
a second container containing the first container; and
an oxygen-absorbing member contained in the second container,
in which the first container has oxygen permeability,
the second container has an oxygen barrier property,
the oxygen-absorbing member contains an oxygen absorber that absorbs oxygen in the second container,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the first container is positioned between the first seal portion and the oxygen-absorbing member in the direction in which the first seal portion and the first container face each other.
[40]A container set includes:
a first container containing a liquid; and
a second container containing the first container,
in which the first container has oxygen permeability,
the second container has an oxygen barrier property,
the second container includes a first film and a second film, the first container being contained between the first film and the second film,
the first film and the second film are joined at a seal portion in a peelable manner,
the seal portion includes a first seal portion positioned to face the first container,
the first seal portion is bent so as to project toward a side away from the first container in a direction in which the first seal portion and the first container face each other, and
the seal portion further includes a first side seal portion connected to one end of the first seal portion, a second side seal portion connected to the other end of the first seal portion, and an additional seal portion positioned between the first container and at least one of the first side seal portion or the second side seal portion.
[41]A container includes a laminate,
in which the laminate includes a sealant layer, a first barrier layer, a resin layer, and a second barrier layer, in that order from the inner surface toward the outer surface.
[42]A laminate used for a container includes:
a sealant layer, a first barrier layer, a resin layer, and a second barrier layer, in that order from the inner surface toward the outer surface.

An embodiment of the present invention will be described below with reference to the drawings. In the drawings attached to this specification, a scale, an aspect ratio, and so on are appropriately changed and exaggerated from the actual ones, for the convenience of easiness in illustration and understanding. Components, etc. illustrated in some drawings will sometimes be omitted in other drawings.

In this specification, terms for specifying shapes, geometric conditions, and their degrees, e.g., “parallel”, “orthogonal”, “same”, etc., and values of a length and an angle, are not limited to their strict definitions, but construed to include a range capable of exerting a similar function.

The term “suppression” refers to suppressing realization, occurrence, or the like or to prohibit realization, occurrence, or the like. The term “suppression” refers not only to completely prohibiting realization, occurrence, etc., but also to reducing the possibility of the realization, occurrence, etc., making realization, occurrence, etc., less likely to occur, and so forth.

In this specification, when a plurality of candidates of the upper limit value and a plurality of candidates of the lower limit value are given for a parameter, the numerical range of the parameter may be defined by a combination of any one of the candidates of the upper limit value and any one of the candidates of the lower limit value. As an example, let us consider the description “a parameter B may be A1 or more, A2 or more, or A3 or more, and the parameter B may be A4 or less, A5 or less, or A6 or less”. In this example, the numerical range of the parameter B may be A1 or more and A4 or less, A1 or more and A5 or less, A1 or more and A6 or less, A2 or more and A4 or less, A2 or more and A5 or less, A2 or more and A6 or less, A3 or more and A4 or less, A3 or more and A5 or less, or A3 or more and A6 or less.

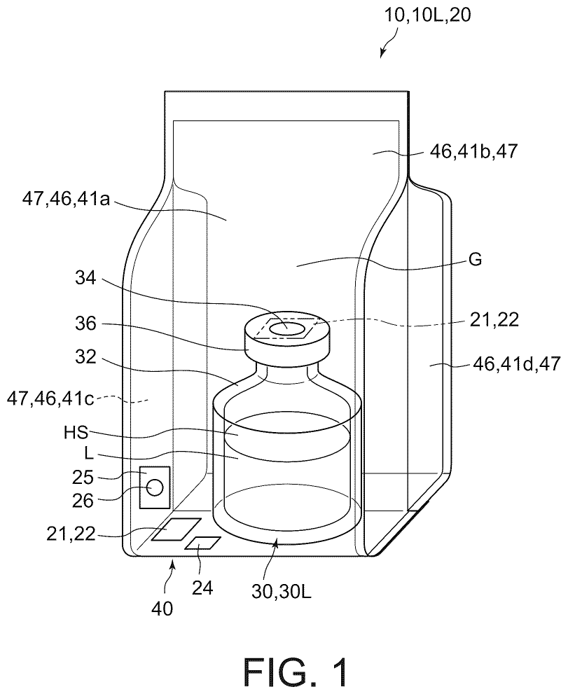

FIGS. 1 to 26F are diagrams for explaining an embodiment of the present disclosure. A container set 20 includes a first container 30 and a second container 40. A liquid-containing first container 30L includes the first container 30 and a liquid L contained in the first container 30. The liquid-containing first container 30L is also referred to as a “liquid-containing container”. The first container 30 has oxygen permeability. The first container 30 includes a portion that is at least partially permeable to oxygen. The second container 40 has an oxygen barrier property. The second container 40 can contain the liquid-containing first container 30L. A liquid-containing combination container 10L includes the liquid-containing first container 30L and the second container 40, and the liquid-containing first container 30L is contained in the second container 40. According to this liquid-containing combination container 10L, not only the oxygen concentration in the first container 30 but also the amount of dissolved oxygen in the liquid L can be adjusted by adjusting the oxygen concentration in the second container 40. The first container 30 having oxygen permeability is an airtight container.

The airtight container refers to a container in which leakage of a gas is not detected by a liquid immersion method defined in JAS Z2330:2012. More specifically, a container in which no bubbles can leak when the container containing a gas is immersed in water is determined as an airtight container. In a state in which no leakage of bubbles is detected when the container containing the gas is immersed in water, an airtight container is determined as being in an airtight state. In a liquid immersion test, the container to be tested is immersed in water at a depth of 10 cm or more and 30 cm or less from the water surface. The presence or absence of bubbles is determined by visual observation over a period of 10 minutes.

Each component of the liquid-containing combination container 10L will be described in more detail with reference to specific examples illustrated in the drawings. First, the liquid-containing first container 30L will be described.

As described above, the liquid-containing first container 30L includes the first container 30 and the liquid L contained in the first container 30. The first container 30 has oxygen permeability. On the other hand, the first container 30 can seal the liquid L. That is, the first container 30 is permeable to oxygen but impermeable to the liquid L.

The liquid L contained in the first container 30 is not particularly limited. The liquid may be a solution containing a solvent and a solute dissolved in the solvent. The solvent is not particularly limited. The solvent may be water or an alcohol. The liquid is not limited to a liquid in the strict sense. The liquid may be a suspension in which solid particles are dispersed. The liquid L as food may be tea, coffee, black tea, soup, juice, soup stock, or a concentrated liquid obtained by concentrating one or more of these. The liquid as a drug may be an internal medicine, an external medicine, or an injectable drug.

The liquid L may be something other than food or drugs. The liquid L may be blood or a body fluid.

The inside of the first container 30 may be in a sterile condition. The liquid L may be a liquid to be maintained in a sterile condition. The liquid L to be maintained in the sterile condition includes a highly sensitive liquid, such as food or a drug. The highly sensitive liquid L is liable to be deteriorated by post-sterilization (also referred to as “terminal sterilization”) performed after production. Post-sterilization cannot be used for the highly sensitive liquid. Examples of the post-sterilization include sterilization, such as a high-pressure steam method, a dry heat method, a radiation method, an ethylene oxide gas method, and a hydrogen peroxide gas plasma method. The highly sensitive liquid L in this specification refers to a liquid in which 5% or more by weight of all active ingredients contained in the liquid are decomposed by post-sterilization of the liquid L, and one or more active ingredients contained in the liquid are decomposed by 1% or more by weight by post-sterilization of the liquid L. The highly sensitive liquid L for which post-sterilization cannot be used can be produced using a production line disposed in a sterile environment. That is, the highly sensitive liquid L can be produced by an aseptic manipulation method. Examples of the highly sensitive liquid L include anticancer drugs, antiviral drugs, vaccines, and antipsychotic drugs.

In order to adjust the amount of oxygen in the liquid L produced by the aseptic manipulation method, the entire space in which the production line of the liquid L is disposed may be purged with an inert gas. However, filling the entire space in which the production line of the liquid L is disposed in an inert gas atmosphere requires a huge capital investment and may also give rise to safety concerns for workers. In view of the above background, the amount of oxygen in the liquid L has typically been adjusted by, for example, replacing the atmosphere in the first container 30 containing the liquid L with an inert gas, or bubbling the liquid L with an inert gas.

In contrast, according to the ingenuity of the inventors of the present invention described below, by placing the liquid-containing first container 30L in the second container 40, the amount of dissolved oxygen in the liquid L can be reduced to less than 0.15 mg/L, 0.04 mg/L or less, 0.03 mg/L or less, 0.02 mg/L or less, or even less than 0.015 mg/L. The effects resulting from the ingenuity of the inventors of the present invention can be considered remarkable, exceeding the range that would be anticipated based on the current level of technology.

Products (liquid L) labeled “sterilized” or “aseptic” and the insides of containers that contain such products, and products (liquid L) such as pharmaceutical products for which “aseptic” is a condition for commercialization and the insides of containers that contain such products fall under the category of the “sterile condition” as used in this specification. A product (liquid L) that satisfies the sterility assurance level (SAL) of 10⁻⁶ specified in JIS T0806:2014 and the inside of a container containing the product also fall under the “sterile condition” used in this specification. Products in which bacteria do not grow when products are stored at a temperature higher than or equal to room temperature (for example, 20 °C) for four weeks and the insides of containers containing such products also fall under the “sterile condition” used in this specification. Products in which bacteria do not grow when products are stored in a refrigerated state (for example, 8 °C or lower) for eight weeks or longer and the insides of containers containing such products also fall under the “sterile condition” used in this specification. Drugs in which bacteria do not grow when drugs are stored at 28 °C or higher and 32 °C or lower for two weeks and the insides of containers containing such chemicals also fall under the “sterile condition” used in this specification.

The first container 30 that contains the liquid L will be described. As described above, the liquid L can be sealed in the first container 30. In other words, the first container 30 can hold the liquid L without leakage.

The first container 30 has oxygen permeability. The expression “a container has oxygen permeability” indicates that in an atmosphere having a temperature of 23 °C and a humidity of 40% RH, oxygen can permeate the container at not less than a predetermined amount of oxygen permeation and move between the inside and outside of the container. The predetermined amount of oxygen permeation is 1×10⁻¹ (mL/(day×atm)) or more. The predetermined amount of oxygen permeation may be 1 (mL/(day×atm)) or more, 1.2 (mL/(day×atm)) or more, or 3 (mL/(day×atm)) or more. For the first container 30 having oxygen permeability, the amount of oxygen in the first container 30 can be adjusted by oxygen permeation through the first container 30.

An upper limit may be set for the amount of oxygen permeation through the first container 30. The setting of the upper limit can suppress leakage of water vapor and the like from the first container 30. The setting of the upper limit can suppress the influence on the liquid L in the first container 30 due to a high gas permeation velocity after the second container 40 is opened. The amount of oxygen permeation through the first container 30 may be 100 (mL/(day×atm)) or less, 50 (mL/(day×atm)) or less, or 10 (mL/(day×atm)) or less.

The range of the amount of oxygen permeation may be determined by combining any of the above-described lower limits of the amount of oxygen permeation with any of the above-described upper limits of the amount of oxygen permeation.

The first container 30 may be permeable to all gases. The first container 30 may be permeable to only some gases, including oxygen, for example, only oxygen.

The first container 30 may have oxygen permeability by virtue of the fact that the entirety of the first container 30 is permeable to oxygen. The first container 30 may have oxygen permeability by virtue of the fact that only a portion of the first container 30 being permeable to oxygen.

A material constituting the oxygen-permeable portion of the first container 30 may have an oxygen permeability coefficient of 1×10⁻¹² (cm³ (STP)·cm/(cm²·sec·Pa)) or more, 5×10⁻¹² (cm³ (STP)·cm/(cm²·sec·Pa)) or more, or 1×10⁻¹¹ (cm³ (STP)·cm/(cm²·sec·Pa)) or more. The setting of the lower limit of the oxygen permeability coefficient promotes the permeation of oxygen through the first container 30, and thus the oxygen concentration in the headspace HS of the first container 30 can be quickly adjusted. When the oxygen-permeable portion includes a plurality of layers, a material constituting at least one layer may have the above-described oxygen permeability coefficient, or each material constituting all the layers may have the above-described oxygen permeability coefficient. The material constituting the oxygen-permeable portion of the first container 30 may have an oxygen permeability coefficient of 1×10⁻⁹ (cm³ (STP)·cm/(cm²·sec·Pa)) or less.

The oxygen concentration (%) in the headspace HS of the first container 30 is also simply referred to as an oxygen concentration (%) in the first container 30.

When an object to be measured does not contain rubber and is not a molded container, the oxygen permeability coefficient is a value measured in accordance with JAS K7126-2:2006 in an environment of a temperature of 23 °C and a relative humidity of 50% RH with an OXTRAN (2/21) transmission rate measurement device manufactured by MOCON Inc., USA. When an object to be measured is at least one of a material containing rubber and a molded container, the oxygen permeability coefficient is a value measured in accordance with ASTM D3985. In this case, the oxygen permeability coefficient is a value measured in an environment of a temperature of 23 °C and a relative humidity of 50% RH with an OXTRAN (2/61) transmission rate measurement device manufactured by MOCON Inc., USA.

The area of the oxygen-permeable portion of the first container 30 may be 1 mm² or more, 10 mm² or more, or 30 mm² or more. Similarly, the oxygen-permeable portion of the first container 30 may have a thickness of 3 mm or less, 1 mm or less, or a few tenths of a millimeter or less. As a result, oxygen permeation through the first container 30 is promoted, and thus the amount of oxygen in the first container 30 can be quickly adjusted.

The first container 30 illustrated includes a container body 32 including an opening portion 33, and a stopper 34 held in the opening portion 33 of the container body 32. The stopper 34 restricts leakage of the liquid L from the opening portion 33. In this example, the stopper 34 may have oxygen permeability. From the viewpoint of promoting the transfer of oxygen from the inside of the first container 30 to the outside of the first container 30, preferably, the oxygen-permeable portion of the first container 30 is not in contact with the liquid L. In the container including the container body 32 and the stopper 34, the stopper 34 is typically separated from the liquid L contained in the container body 32. That is, when the first container 30 is stored in a normal state, oxygen permeation through the stopper 34 of the first container 30 can be promoted. In this respect, the use of the stopper 34 having oxygen permeability makes it possible to quickly adjust the amount of oxygen in the first container 30.

The stopper 34 having oxygen permeability may be made of a material having the above-described oxygen permeability coefficient (cm³ (STP)·cm/(cm²·sec·Pa)). The material constituting the stopper 34 may have a higher oxygen permeability coefficient than the material constituting the container body 32. A portion of the stopper 34 may have oxygen permeability. A portion of the stopper 34 may be made of a material having oxygen permeability throughout its entire thickness. For example, the stopper 34 may be permeable to oxygen throughout its entire thickness in a central portion spaced from the periphery and may have an oxygen barrier property in a peripheral portion surrounding the central portion.

For example, the configuration of the oxygen-permeable portion of the first container may be determined in such a manner that the oxygen concentration (%) in the first container 30 can be reduced by 5% or more by storing the first container 30 containing a liquid having an amount of dissolved oxygen of 8 mg/L in the second container 40 for 4 weeks.

In the illustrated example, the area of the opening portion 33, i.e., the opening area of the container body 32, may be 1 mm² or more, 10 mm² or more, or 30 mm² or more. The thickness of the stopper 34 may be 3 mm or less, or 1 mm or less. As a result, oxygen permeation through the first container 30 is promoted, and thus the oxygen concentration in the first container 30 can be quickly adjusted. The needle of a syringe can be inserted into the stopper 34. From the viewpoint of enabling insertion of a straw, the thickness of the stopper, for example the thickness of a film-like stopper, may be less than a few tenths of a millimeter.

An upper limit may be set for the area of the opening portion 33 from the viewpoints of suppressing leakage of water vapor, etc., and suppressing the influence on the liquid in the first container 30 due to the high gas permeation velocity after the second container 40 is opened.

Specifically, the area of the opening portion 33 may be 5,000 mm2 or less. From the viewpoint of ensuring strength, the thickness of the stopper, for example, the thickness of a rubber stopper, may be 0.01 mm or more.

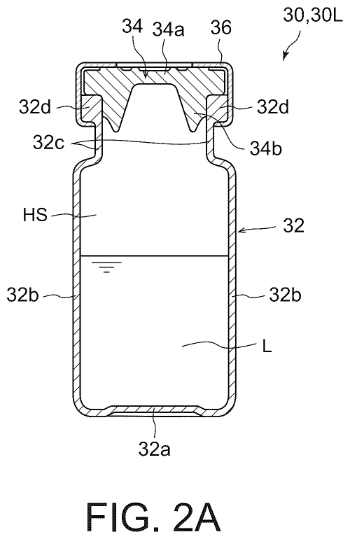

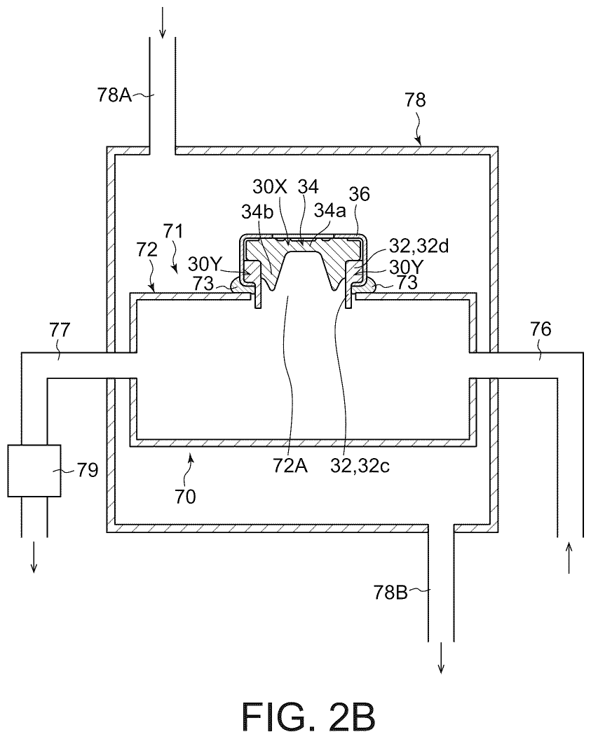

The stopper 34 having oxygen permeability is not particularly limited and may have various configurations. In the illustrated example, the stopper 34 is fitted into the opening portion 33 of the container body 32 to close the opening portion 33. The stopper 34 illustrated in FIG. 2A includes a plate-shaped portion 34a having a plate shape and an insertion protruding portion 34b extending from the plate-shaped portion 34a. The insertion protruding portion 34b is, for example, cylindrical. A plurality of insertion protruding portions 34b may be provided on the circumference. The insertion protruding portion 34b is fitted into the opening portion 33. The plate-shaped portion 34a includes a flange portion that extends radially outward from the insertion protruding portion 34b. The flange portion of the plate-shaped portion 34a is placed on the head portion 32d of the container body 32. The stopper 34 may include an external helix and an internal helix. The stopper 34 may be attached to the container body 32 by means of the engagement of the helices.

The stopper 34 may contain silicone. The stopper 34 may be made solely of silicone. A portion of the stopper 34 may be made of silicone. The silicone contained in the stopper 34 is a solid in an environment in which the first container 30 is intended to be used. The silicone contained in the stopper 34 does not need to contain a liquid silicone in a room-temperature environment, such as silicone oil. Silicones are substances with siloxane bonds as their main chains. The stopper 34 may be made of a silicone elastomer. The stopper 34 may be made of silicone rubber.

The silicone rubber refers to a rubber-like material composed of a silicone. The silicone rubber is a synthetic resin containing silicone as a main component, and is a rubber-like substance. The silicone rubber is a rubber-like substance with siloxane bonds as its main chain. The silicone rubber may be a thermosetting compound containing siloxane bonds. Examples of the silicone rubber include methylsilicone rubber, vinyl-methylsilicone rubber, phenyl-methylsilicone rubber, dimethylsilicone rubber, and fluorosilicone rubber.

The oxygen permeability coefficient of the silicone and the oxygen permeability coefficient of the silicone rubber may be 1×10⁻¹² (cm³ (STP)·cm/(cm²·sec·Pa)) or more, or may be 1×10⁻¹¹ (cm³ (STP)·cm/(cm²·sec·Pa)) or more. The oxygen permeability coefficient of the silicone and the oxygen permeability coefficient of the silicone rubber may be 1×10⁻⁹ (cm³ (STP)·cm/(cm²·sec·Pa)) or less. Compared with natural rubber, each of the silicone and the silicone rubber has a hydrogen permeability coefficient about 10 times, an oxygen permeability coefficient about 20 times, and a nitrogen permeability coefficient about 30 times. Compared with butyl rubber, each of the silicone and the silicone rubber has a hydrogen permeability coefficient 70 or more times, an oxygen permeability coefficient 40 or more times, and a nitrogen permeability coefficient 650 or more times.

The stopper 34 may be at least partially made of the silicone. That is, the whole or part of the stopper 34 may be made of the silicone or silicone rubber. For example, a portion of the stopper 34 may be made of the silicone or silicone rubber throughout its entire thickness. The portion may be the central portion of the stopper 34 or the whole or part of the peripheral portion surrounding the central portion.

As illustrated in FIG. 2A, the container body 32 may include a bottom portion 32a, a body portion 32b, a neck portion 32c, and a head portion 32d, in that order. As illustrated in FIG. 2A, a storage space for the liquid L is formed mainly by the bottom portion 32a and the body portion 32b. The head portion 32d constitutes an end portion of the container body 32. The head portion 32d is thicker than the other portions. The neck portion 32c is located between the body portion 32b and the head portion 32d. The neck portion 32c is reduced in width, particularly in diameter, with respect to the body portion 32b and the head portion 32d.

The container body 32 may include a transparent portion so that the contained liquid L can be observed from the outside. The term “transparent” indicates that the transmission haze of a target portion is 80.0 or less.

A light source simulating the spectrum of D65 standard light (hereinafter, referred to as a “D65 standard light source”) is used to measure the transmission haze. Before measuring the transmission haze, the D65 standard light source is turned on for 15 minutes to stabilize the output of the D65 standard light source. When the transmission haze is measured, the incident angle on a sample is 0°.

When the transmission haze is measured, the test environment includes a temperature of 23 °C±2 °C and a relative humidity of 50%±5%. The sample is placed in the test environment for 16 hours before starting the test. When the transmission haze is measured, other measurement conditions comply with JIS K7136:2000. The transmission haze is the arithmetic mean value of five measured values. The five measured values are measured values measured at five measuring positions of the measurement sample to be evaluated.

The first container 30 illustrated further includes a fixture 36. The fixture 36 suppresses the detachment of the stopper 34 from the container body 32. The fixture 36 is attached to the head portion 32d of the container body 32. The fixture 36 covers the periphery of the plate-shaped portion 34a of the stopper 34, as illustrated in FIGS. 1 and 2A. The fixture 36 presses the flange portion of the plate-shaped portion 34a toward the head portion 32d. Thus, the fixture 36 suppresses the detachment of the stopper 34 from the container body 32 while the stopper 34 is partially exposed. Furthermore, it is possible to maintain a liquid-tight and airtight seal between the stopper 34 and the container body 32. The fixture 36 makes the first container 30 airtight. The fixture 36 may be a sheet-shaped metal fixed to the head portion 32d. The fixture 36 may be a cap screwed to the head portion 32d. The fixture 36 made of a metal has an oxygen barrier property.

In the illustrated example, the oxygen permeability coefficient of the material constituting the container body 32 may be less than the oxygen permeability coefficient of the material constituting the stopper 34. The container body 32 may have an oxygen barrier property. That is, the first container 30 may have oxygen permeability only in a portion thereof. The oxygen permeability coefficient of the material constituting the portion having the oxygen barrier property may be 1×10⁻¹ (cm³ (STP)·cm/(cm²·sec·Pa)) or less, or 1×10⁻¹⁷ (cm³ (STP)·cm/(cm²·sec·Pa)) or less.

Examples of the container body 32 having the oxygen barrier property include a can made of a metal, a container body including a metal layer formed by vapor deposition or transfer, and a glass bottle. The container body 32 made of a resin sheet or a resin plate can also be provided with the oxygen barrier property. In this example, the resin sheet or the resin plate may include a layer having the oxygen barrier property, such as ethylene-vinyl alcohol copolymer (EVOH) or polyvinyl alcohol (PVA). The container body 32 may include a laminate including a metal vapor-deposited film or a vapor-deposited film of a metal-oxide. The container body 32 made of a laminate or glass can be provided with transparency as well as the oxygen barrier property. When the first container 30 or the container body 32 is transparent, the liquid L contained therein can be observed from the outside of the first container 30.

In an atmosphere having a temperature of 23 °C and a relative humidity of 40% RH, the expression “a portion of the container has oxygen permeability” indicates that oxygen can move between the inside and the outside of the container through the portion of the container at not less than a predetermined amount of oxygen permeation. The predetermined amount of oxygen permeation is 1×10⁻¹ (mL/(day×atm)) or more. The predetermined amount of oxygen permeation may be 1 (mL/(day×atm)) or more, 1.2 (mL/(day×atm)) or more, or 3 (mL/(day×atm)) or more. The amount of oxygen in the first container 30 can also be adjusted by virtue of the fact that a portion of the first container 30 has oxygen permeability.

The predetermined amount of oxygen permeation may be 100 (mL/(day×atm)) or less, 50 (mL/(day×atm)) or less, or 10 (mL/(day×atm)) or less. The setting of the upper limit of the amount of oxygen permeation can suppress leakage of water vapor or the like and can suppress the influence on the liquid in the first container 30 due to a high oxygen permeation velocity after opening the second container 40. The range of the amount of oxygen permeation may be determined by combining any of the above-described lower limits of the amount of oxygen permeation with any of the above-described upper limits of the amount of oxygen permeation.

The amount of oxygen permeation through a portion of the container (mL/(day×atm)) is measured using a test container 70 containing the portion, as illustrated in FIG. 2B. The test container 70 includes a partition wall portion 71. The test container 70 includes an internal space defined by the partition wall portion 71. The partition wall portion 71 includes a portion of the container and a main wall portion 72 having the oxygen barrier property. The amount of permeation through the portion of the container is specified as the amount of oxygen permeation (mL/(day×atm)) of the test container 70.

The oxygen concentration in the test container 70 is maintained at 0.05% or less. The test container 70 is connected to a first flow path 76 and a second flow path 77. The second flow path 77 is connected to an oxygen measurement device 79 that measures the amount of oxygen. The oxygen measurement device 79 can measure the amount of oxygen (mL) flowing through the second flow path 77. The oxygen measurement device 79 is a device for measuring the amount of oxygen, used in OXTRAN 2/61 manufactured by MOCON Inc., USA. The first flow path 76 supplies a gas into the test container 70. The first flow path 76 supplies a gas that does not contain oxygen. The first flow path 76 supplies nitrogen. The second flow path 77 discharges the gas in the test container 70. Each of the first flow path 76 and the second flow path 77 has an oxygen barrier property. The first flow path 76 and the second flow path 77 maintain the interior of the test container 70 in a state substantially free of oxygen.

The test container 70 is placed in a test atmosphere having a temperature of 23 °C and a humidity of 40% RH. The oxygen concentration in the atmosphere in which the test container 70 is placed is higher than the oxygen concentration in the test container 70. The test atmosphere is air. The oxygen concentration in the air atmosphere is 20.95%. When the test container 70 is placed in the test atmosphere, oxygen moves from the test atmosphere into the test container 70 through a portion 30X of the container. The gas in the test container 70 is discharged through the second flow path 77. The amount of oxygen permeation through the portion 30X in one day (mL/(day×atm)) in an atmosphere having a temperature of 23 °C and a humidity of 40% RH can be measured by measuring the amount of oxygen flowing through the second flow path 77 with the oxygen measurement device 79.

In the illustrated example, the test container 70 is disposed in a test chamber 78. The atmosphere in the test chamber 78 is maintained at a temperature of 23 °C and a humidity of 40% RH.

Air is supplied into the test chamber 78 through a supply line 78A. A gas in the test chamber 78 is discharged through a discharge line 78B. The supply line 78A and the discharge line 78B circulate air to maintain the oxygen concentration in the test chamber 78 at 20.95%.

In the example illustrated in FIG. 2B, one of the supply line 78A and the discharge line 78B may be provided with a pump for circulating air. As long as the oxygen concentration in the test chamber 78 can be maintained constant, the supply line 78A and the discharge line 78B illustrated in FIG. 2B may be open to an air atmosphere under atmospheric pressure.

FIG. 2B illustrates a method for measuring the amount of oxygen permeation by using the oxygen-permeable portion 30X of the first container 30 as an example. In the example illustrated in FIG. 2B, the partition wall portion 71 includes the oxygen-permeable portion 30X of the first container 30 and the main wall portion 72 having the oxygen barrier property. For example, the partition wall portion 71 may include the portion 30X cut out from the first container 30 and the main wall portion 72 connected to the peripheral portion 30Y of the portion 30X. The main wall portion 72 has a through-hole 72A. The portion 30X is exposed to the through-hole 72A. In other words, the through-hole 72A is closed by the portion 30X. The peripheral portion of the through-hole 72A and the portion 30Y adjacent to the portion 30X are joined together in an airtight manner. In the illustrated example, the portion 30Y adjacent to the portion 30X is joined in an airtight manner to the peripheral portion of the through-hole 72A of the main wall portion 72 with a barrier joint material 73 having an oxygen barrier property interposed therebetween. In the example illustrated in FIG. 2B, the portion adjacent to the stopper 34 of the container set 20 illustrated in FIG. 2A has been cut. In this example, the stopper 34 serves as the portion 30X having oxygen permeability. The portions 32c and 32d constituting the opening portion 33 of the container body 32 and serving as the portion 30Y adjacent to the portion 30X having oxygen permeability, and the fixture 36 are connected in an airtight manner to the main wall portion 72 with the barrier joint material 73 interposed therebetween.

In the example illustrated in FIG. 2B, the container body 32 is cut at the neck portion 32c. The stopper 34 is held in compression within the opening portion 33 formed of the head portion 32d of the container body 32. The fixture 36 ensures airtightness between the container body 32 and the stopper 34. The fixture 36 made of, for example, aluminum having an oxygen barrier property partially covers the stopper 34. The container body 32 and the fixture 36, both of which have the oxygen barrier property, are connected to the main wall portion 72 with the barrier joint material 73 interposed therebetween. The stopper 34 is maintained in a state similar to when the first container 30 is closed during actual use, such as being compressed within the opening portion 33 and tightened by the fixture 36. Therefore, the amount of oxygen permeation through the stopper 34 can be measured under conditions similar to those during actual use.

The method for measuring the amount of oxygen permeation through a portion of the container (mL/(day×atm)) has been described above. The amount of oxygen permeation (mL/(day×atm)) through the entire container can be determined by dividing the container into two or more pieces and adding the amounts of oxygen permeation measured for the pieces. For example, the amount of oxygen permeation through the first container 30 illustrated in FIG. 2A can be determined by measuring the amount of oxygen permeation through the container body 32 and adding the amount of oxygen permeation through the container body 32 and the amount of oxygen permeation through the portion 30X measured by the method illustrated in FIG. 2B. The amount of oxygen permeation (mL/(day×atm)) of the container body 32 can be measured with the test container 70 produced by combining the container body 32 with the main wall portion 72.

The volume of the first container 30 may be, for example, 1 mL or more and 1,100 mL or less, 3 mL or more and 700 mL or less, or 5 mL or more and 200 mL or less.

In the illustrated example, the container body 32 is a colorless or colored glass bottle. The container body 32 is made of, for example, borosilicate glass. The first container 30 may be a vial. The vial is a container that includes a container body, a stopper that is inserted into the opening portion of the container body, and a seal that serves as the fixture 36 for fixing the stopper, and the seal is crimped to the head portion of the container body together with the stopper using a hand gripper or the like.

The volume of the first container 30 that is a vial may be 1 mL or more, or 3 mL or more. The volume of the first container 30 that is a vial may be 500 mL or less, or 200 mL or less.

When the first container 30 is a vial, the oxygen permeability coefficient of the material constituting the stopper 34 may be greater than the oxygen permeability coefficient of the glass constituting the container body 32. The oxygen-permeable portion of the first container 30 is separated from the liquid L, thereby making it possible to promote the transfer of oxygen from the inside of the first container 30 to the outside of the first container 30. The first container 30 that is a vial can be stably placed on the mounting surface by bringing the bottom portion 32a of the container body 32 into contact with the mounting surface. At this time, the stopper 34 is separated from the liquid L. The stopper 34 does not come into contact with the liquid L. Therefore, when the first container 30 is stored in a normal state, oxygen permeation through the stopper 34 of the first container 30 can be promoted.

The illustrated first container 30 can maintain a negative internal pressure under atmospheric pressure. Under atmospheric pressure, the first container 30 can contain a gas while the gas is maintained at a negative pressure. Under atmospheric pressure, the first container 30 may be capable of containing a gas while the gas is maintained at a positive pressure. In these examples, the first container 30 may be sufficiently rigid to maintain its shape. However, the first container 30 may deform to some extent under atmospheric pressure when the internal pressure is maintained at a negative or positive pressure. Examples of the first container 30 that can maintain a negative or positive internal pressure include the above-described vial and a can made of a metal.

The expression “under atmospheric pressure, a gas can be contained while the gas is maintained at a negative pressure” indicates that the gas can be contained while the internal pressure is maintained at a negative pressure of 0.80 atm or more without damage. A container that, under atmospheric pressure, can contain a gas while the gas is maintained at a negative pressure may be in an airtight state when the internal pressure is 0.80 atm. In a container that, under atmospheric pressure, can contain a gas while the gas is maintained at a negative pressure, the volume when the internal pressure is 0.80 atm may be maintained at 95% or more of the volume when the internal pressure is 1.0 atm. The expression “in the atmosphere, a gas can be contained while the gas is maintained at a positive pressure indicates that the gas can be contained while the internal pressure is maintained at a positive pressure of 1.2 atm or less without damage. Under atmospheric pressure, a container that can contain a gas while the gas is maintained at a positive pressure may be in an airtight state when the internal pressure is 1.20 atm. In a container that, under atmospheric pressure, can store a gas while the gas is maintained at a positive pressure, the volume when the internal pressure is 1.2 atm may be maintained at 105% or less of the volume when the internal pressure is 1.0 atm.

The first container 30 is intended to be contained within the second container 40 having the oxygen barrier property. The first container 30 contained in the second container 40 may be able to contain a gas without being damaged when a difference in internal pressure between the first container 30 and the second container 40 is 0.2 atm or less. The first container 30 contained in the second container 40 may be in an airtight state when the difference in internal pressure between the first container 30 and the second container 40 is 0.2 atm or less. In the case where the difference in internal pressure between the first container 30 and the second container 40 is 0.2 atm or less, the first container 30 contained in the second container 40 may have a volume of 95% or more and 105% or less of the volume of the first container 30 when the internal pressure of the first container 30 is the same as the internal pressure of the second container 40. In these states in which the first container 30 is contained in the second container 40, the internal pressure of the first container 30 may be less than the internal pressure of the second container 40, or the internal pressure of the first container 30 may be greater than the internal pressure of the second container 40.

The second container 40 has a sufficient volume to accommodate the first container 30. The second container 40 can be sealed by welding, such as heat sealing or ultrasonic bonding, or by joining using a joining material, such as an adhesive material or a bonding material. The second container 40 may be an airtight container. The volume of the second container 40 may be, for example, 5 mL or more and 1,200 mL or less. When the first container 30 is a small container such as a vial, for example a container with a volume of 1 mL or more and 20 mL or less, the volume of the second container may be 1.5 mL or more and 500 mL or less.

The second container 40 has the oxygen barrier property. The expression “the second container 40 has the oxygen barrier property” indicates that the oxygen transmission rate (mL/(m²×day×atm)) of the container is 1 or less. The oxygen transmission rate (mL/(m²×day×atm)) of a container having the oxygen barrier property may be 0.5 or less, or may be 0.1 or less. When an object to be measured does not contain rubber and is not a molded container, the oxygen transmission rate is a value measured in accordance with JAS K7126-2:2006 in an environment of a temperature of 23 °C and a humidity of 50% RH with an OXTRAN (2/21) transmission rate measurement device manufactured by MOCON Inc., USA.

When an object to be measured is at least one of a material containing rubber and a molded container, the oxygen transmission rate is a value measured in accordance with ASTM D3985. In this case, the oxygen transmission rate is a value measured in an environment of a temperature of 23 °C and a relative humidity of 50% RH with an OXTRAN (2/61) transmission rate measurement device manufactured by MOCON Inc., USA.

The oxygen permeability coefficient of the material constituting the second container 40 having the oxygen barrier property may be 1×10⁻¹³ (cm³ (STP)·cm/(cm²·sec·Pa)) or less, or 1×10⁻¹ (cm³ (STP)·cm/(cm²·sec·Pa)) or less.

Examples of the second container 40 having the oxygen barrier property include a can made of a metal, a container having a metal layer formed by vapor deposition or transfer, and a glass bottle. The second container 40 may include a laminate including a layer having an oxygen barrier property. The laminate may include a resin layer having an oxygen barrier property, such as an ethylene-vinyl alcohol copolymer (EVOH) or polyvinyl alcohol (PVA), or a metal vapor-deposited film. The second container 40 may include a transparent portion. A part of the second container 40 may be transparent. The entire second container 40 may be transparent. The second container 40 including the laminate and the second container 40 including glass or resin can be provided with transparency as well as the oxygen barrier property. When the second container 40 has transparency, the liquid-containing first container 30L contained therein can be observed from the outside of the second container 40.

In the example illustrated in FIG. 1, the second container 40 is made of a resin film having an oxygen barrier property. The second container 40 is what is called a pouch. The second container 40 illustrated in FIG. 1 is what is called a gusset bag. The second container 40 includes a first film 41a (first main film), a second film (second main film) 41b, a first gusset film 41c and a second gusset film 41d.

The first film 41a and the second film 41b face each other. The first gusset film 41c is creased and positioned between the first film 41a and the second film 41b. The first gusset film 41c connects one side edge of the first film 41a and one side edge of the second film 41b. The second gusset film 41d is creased and positioned between the first film 41a and the second film 41b. The second gusset film 41d connects the other side edge of the first film 41a and the other side edge of the second film 41b. The first and second films 41a and 41b and the first and second gusset films 41c and 41d are also joined to each other at the top and bottom edges. The films 41a to 41d are joined in an airtight manner by welding, such as heat sealing or ultrasonic bonding, or by joining using a joining material, such as an adhesive material or a bonding material.

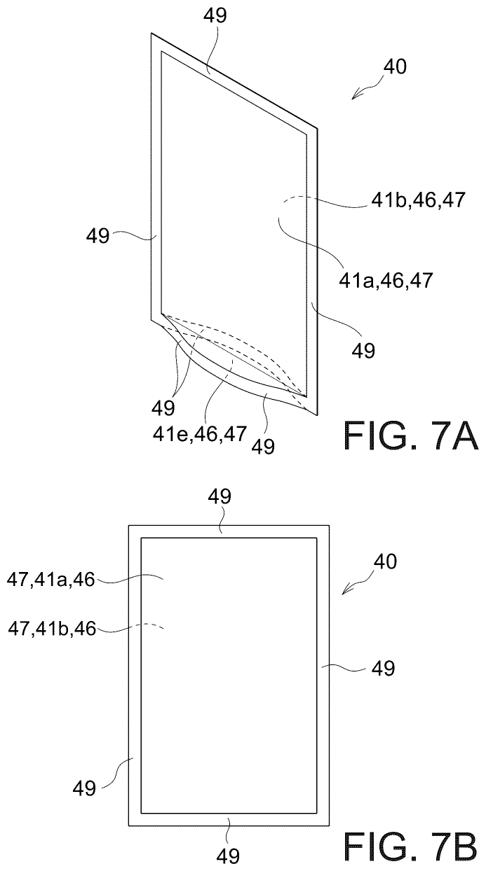

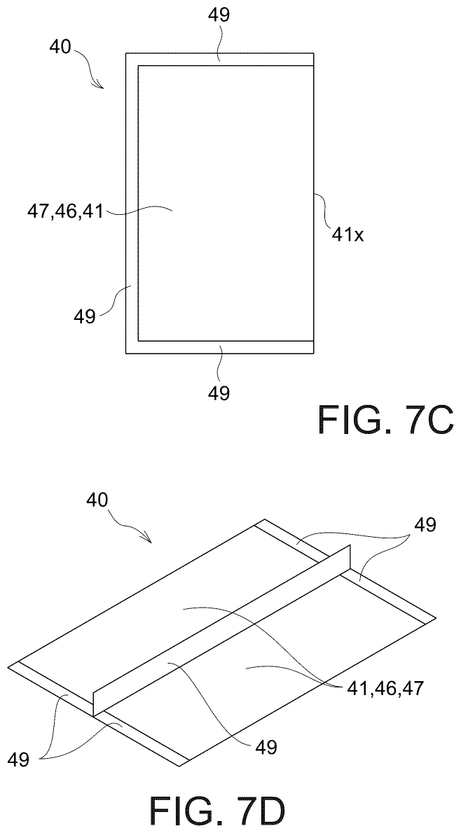

In the second container 40 illustrated in FIG. 1, instead of joining separate films, one folded film may constitute two or more films 41a to 41d disposed adjacent to each other. In other words, two or more films including the films 41a to 41d may be made of a single seamless film material. As illustrated in FIG. 1, the gusset bag can provide the second container 40 with a rectangular bottom face. The first container 30 is placed on the bottom face, and thus the first container 30 can be stably stored in the second container 40. However, as illustrated in FIG. 7A, the second container 40 may include a bottom film 41e in addition to the first film 41a and the second film 41b, instead of the gusset bag. This pouch is also called a standing pouch. This pouch can also form a bottom face, allowing the first container 30 to be stably stored in the second container 40.

As illustrated in FIGS. 7B to 7D, a second container 40 that can be developed into a flat shape may be used. Any of the second containers 40 illustrated in FIGS. 7B to 7D can be produced by joining resin films with a seal portion 49. The second container 40 illustrated in FIG. 7B can be produced by joining the first film 41a and the second film 41b at the seal portion 49 provided in the periphery.

The second container 40 illustrated in FIG. 7C has a film 41 folded back at a folded portion 41x. The facing portions of the folded film 41 are joined at the seal portion 49 to produce the second container 40. In the second container 40 illustrated in FIG. 7C, a storage space is formed in the area surrounded by the folded portion 41x and the three-sided seal portion 49. In the example illustrated in FIG. 7C, the first film 41a and the second film 41b that provide a storage space for the first container 30 between the first film 41a and the second film 41b are made of a single film material. There is no seam between the first film 41a and the second film 41b.

The second container 40 illustrated in FIG. 7D is also called a pillow type. Both ends of the single film 41 are joined to each other as the seal portion 49 to form the film 41 into a cylindrical shape, and both end portions of the cylindrical shape are further joined to form the seal portions 49 to provide the second container 40. In the example illustrated in FIG. 7D, the first film 41a and the second film 41b that provide a storage space for the first container 30 between the first film 41a and the second film 41b are made of a single film material. There is no seam between the first film 41a and the second film 41b.

In the various examples discussed above, the film used to form the second container 40 may be transparent.

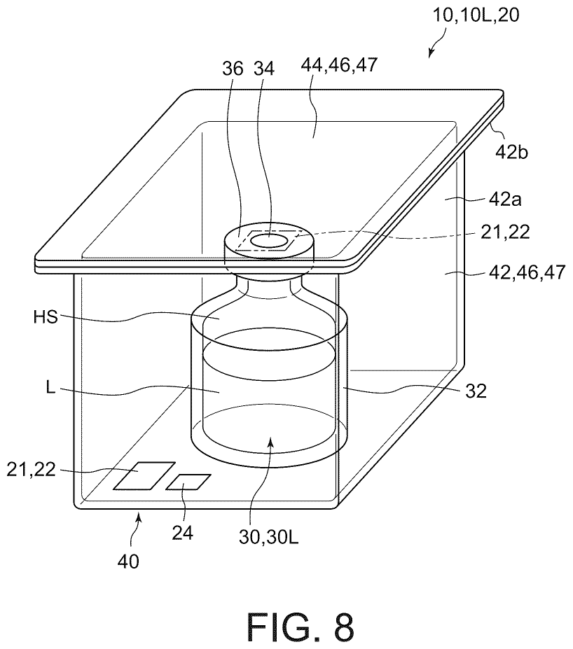

FIG. 8 illustrates yet another example of the second container 40. As illustrated in FIG. 8, the second container 40 may include a container body 42 and a lid 44. The container body 42 includes a storage portion 42a and a flange portion 42b. The storage portion 42a may provide a storage space having a rectangular parallelepiped shape. The first container 30 is stored in this storage space. The storage portion 42a may have a rectangular parallelepiped outer shape with one side open. The flange portion 42b is provided on the periphery of the opening of the storage portion 42a. The lid 44 is flat. The peripheral portion of the lid 44 can be joined in an airtight manner to the flange portion 42b of the container body 42. The container body 42 and the lid 44 may be made of resin plates having an oxygen barrier property. The lid 44 and the container body 42 may be transparent. The thickness of each resin plate having the oxygen barrier property may be 0.05 mm or more and 2 mm or less, or 0.1 mm or more and 1.5 mm or less.

The second container 40 illustrated in FIG. 8 can maintain a negative internal pressure under atmospheric pressure. Under atmospheric pressure, the second container 40 can contain the gas while the gas is maintained at a negative pressure. Under atmospheric pressure, the second container 40 may be capable of containing a gas while the gas is maintained at a positive pressure. In these examples, the second container 40 may be rigid enough to maintain its shape. However, the second container 40 may deform to some extent under atmospheric pressure when the internal pressure is maintained at a negative or positive pressure. An example of the second container 40 capable of maintaining a negative or positive internal pressure is a can made of a metal.

The oxygen-permeable portion of the first container 30 is at least partially separated from the second container 40 having the oxygen barrier property, thereby making it possible to promote the transfer of oxygen from the inside of the first container 30 to the inside of the second container 40. In the example illustrated in FIG. 1, a gap G is formed between the second container 40 and the stopper 34 of the first container 30 contained in the second container 40. When the storage space of the second container 40 is larger than the external shape of the first container 30, the gap G can be ensured. When the second container 40 is made of a flexible material, such as resin film, the gap G between the stopper 34 and the second container 40 can be formed by adjusting the shape of the second container 40.

The first container 30 and the second container 40 described above constitute the container set 20 and the combination container 10. The liquid-containing combination container 10L is obtained using the liquid-containing first container 30L and the second container 40.

A method for manufacturing the liquid-containing combination container 10L will be described below. The manufacture of the liquid-containing combination container 10L provides the liquid-containing first container 30L with an adjusted oxygen concentration.

The liquid-containing first container 30L and the second container 40 before being closed are prepared. The liquid-containing first container 30L is manufactured by placing the liquid L into the first container 30. For example, the liquid L, such as food or a drug, is produced using a production line installed in a sterile environment maintained at a positive pressure. In a sterile environment, a positive pressure is maintained in order to suppress the invasion of foreign matter, such as bacteria. As a result, the internal pressure of the liquid-containing first container 30L is a positive pressure, as in the manufacturing environment.

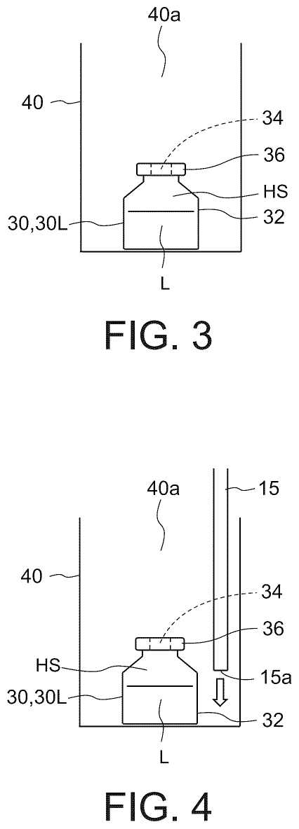

As illustrated in FIG. 3, an opening 40a for receiving the liquid-containing first container 30L remains in the second container 40 before being closed. In the second container 40 illustrated in FIG. 1, for example, the upper edges of the films 41a to 41d are not joined to each other and form the opening 40a. In the second container 40 illustrated in FIG. 8, the container body 42 without the lid 44 attached is prepared. As illustrated in FIG. 3, the liquid-containing first container 30L is then placed in the second container 40 through the opening 40a.

Thereafter, the second container 40 is filled with an inert gas, for example, nitrogen. In the example illustrated in FIG. 4, the inert gas is supplied through a supply pipe 15. The supply pipe 15 extends through the opening 40a into the second container 40. The outlet 15a of the supply pipe 15 is located inside the second container 40. An inert gas is supplied from the supply pipe 15 to purge the inside of the second container 40 with the inert gas. That is, the liquid-containing first container 30L is placed in an inert gas atmosphere. The inert gas is a stable gas with low reactivity. Examples of the inert gas include rare gases, such as helium, neon, and argon, and nitrogen.

The filling of the second container 40 with the inert gas and the placement of the liquid-containing first container 30L in the second container 40 may be performed in any order, or may be performed at the same time.

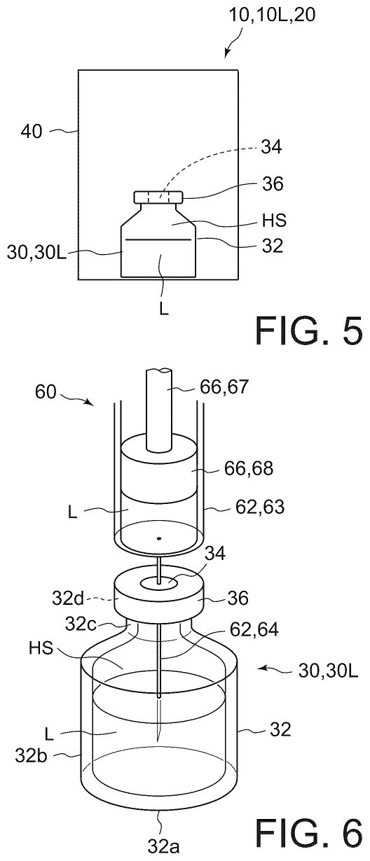

As illustrated in FIG. 5, the second container 40 is closed while being filled with the inert gas and containing the liquid-containing first container 30L. In the second container 40 illustrated in FIG. 1, the upper edge portions of the films 41a to 41d are joined together to close the opening 40a, thereby closing the second container 40. In the second container 40 illustrated in FIG. 8, the peripheral portion of the lid 44 is joined to the flange portion 42b of the container body 42, thereby closing the second container 40. The joining may be performed using a joining material, such as an adhesive material or a bonding material, or may be performed by welding, such as heat sealing or ultrasonic bonding. The second container 40 is in an airtight state.

Instead of supplying the inert gas from the supply pipe 15, the second container 40 containing the liquid-containing first container 30L may be closed in an inert gas atmosphere. This method also allows the liquid-containing first container 30L to be sealed in the second container 40 together with the inert gas.

The steps up to closing the second container 40 may be performed in a sterile environment. That is, the liquid-containing first container 30L manufactured in a sterile condition and the second container 40 that has been sterilized or manufactured in the sterile condition are brought into a sterile environment, such as a sterile chamber. If this chamber is partitioned from the air atmosphere and has an inert gas atmosphere, the supply of the inert gas through the supply pipe 15 can be omitted. In the sterile environment, the second container 40 containing the liquid-containing first container 30L is then closed. Therefore, the inside of the second container 40 containing the liquid-containing first container 30L is also in a sterile condition. That is, the liquid-containing first container 30L can be stored in the second container 40 in the sterile condition.

Thereafter, the liquid-containing first container 30L is stored in the second container 40. As described above, the second container 40 has the oxygen barrier property. The permeation of oxygen through the second container 40 is effectively suppressed. The first container 30 has oxygen permeability at least in part. The second container 40 is filled with an inert gas, and thus the oxygen concentration in the second container 40 is very low. In this liquid-containing combination container 10L, oxygen in the first container 30 permeates the first container 30 and moves into the second container 40. As oxygen moves from the first container 30 to the second container 40, the oxygen concentration in the second container 40 increases and the oxygen concentration in the first container 30 decreases. At the final equilibrium state where oxygen permeation through the first container 30 is balanced, the oxygen concentration in the first container 30 may match the oxygen concentration in the second container 40.

When the oxygen concentration in the first container 30 decreases, the oxygen partial pressure in the first container 30 decreases. When the oxygen partial pressure in the first container 30 decreases, the saturation solubility of oxygen (mg/L) in the liquid L in the first container 30 also decreases. As a result, the amount of oxygen (mg/L) dissolved in the liquid L decreases.

As described above, by storing the liquid-containing first container 30L in the second container 40, the oxygen concentration (%) of the gas contained together with the liquid in the first container 30 can be reduced. In addition, the amount of oxygen (mg/L) dissolved in the liquid L in the first container 30 can also be reduced. For example, the amount of oxygen (mg/L) dissolved in the liquid L in the first container 30 before use can be reduced by storing the liquid-containing first container 30L in the second container 40.

A highly sensitive liquid L, for example, food or a drug, can be decomposed by oxygen. For example, a solute in an aqueous solution as a drug can be decomposed by oxygen. A solute in a liquid as a drug or an aqueous solution as a drug can be decomposed by oxygen. Particles dispersed in the liquid of a suspension as a drug or food can be decomposed by oxygen. In contrast, the decomposition of the liquid L due to oxygen can be suppressed by storing the liquid L in the first container 30 disposed in the second container 40. That is, the present embodiment, which can adjust the oxygen concentration in the first container 30 after the liquid L is sealed therein, is suitable for a highly sensitive liquid L, such as food or a drug.

Instead of filling the second container 40 with an inert gas or in addition to filling the second container 40 with an inert gas when the second container 40 is closed, an oxygen absorber 21 that absorbs oxygen in the second container 40 may be provided. As the oxygen absorber 21 absorbs oxygen, the oxygen concentration in the second container 40 decreases, and oxygen in the first container 30 moves to the second container 40. The use of the oxygen absorber 21 can more effectively reduce the oxygen concentration in the second container 40 and the oxygen concentration in the first container 30.

The inventors have found that the use of a sufficient amount of the oxygen absorber 21 can maintain the oxygen concentration in the second container 40 and the oxygen concentration in the first container 30 at low levels, for example, at less than 0.3%, 0.1% or less, 0.05% or less, less than 0.03%, or even 0%.

Furthermore, as the oxygen concentration in the first container 30 decreases, the amount of dissolved oxygen in the liquid L contained in the first container 30 also decreases. The inventors have found that in the case of using a sufficient amount of the oxygen absorber 21, the amount of dissolved oxygen in the liquid L can be significantly reduced and can be maintained at, for example, less than 0.15 mg/L, 0.04 mg/L or less, 0.03 mg/L or less, 0.02 mg/L or less, less than 0.015 mg/L, or even 0 mg/L.

The amount of the oxygen absorber 21 is set to an amount sufficient to absorb the total amount of oxygen present in the first container 30 and the second container 40.

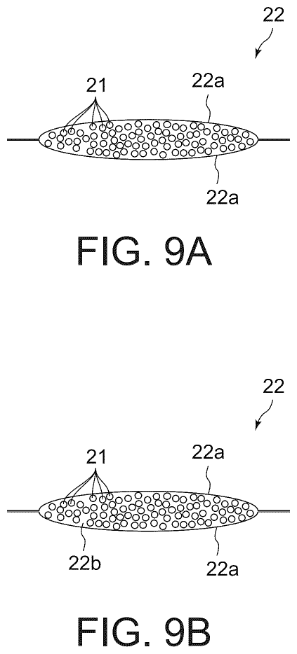

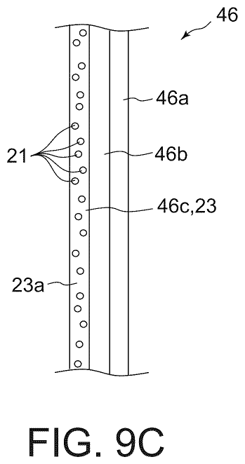

The oxygen absorber 21 is not particularly limited as long as it is a composition that can absorb oxygen. As the oxygen absorber 21, an iron-based oxygen absorber or a non-iron-based oxygen absorber can be used. For example, an oxygen absorber composition containing, as a main agent for an oxygen absorption reaction, a metal powder, such as iron powder, a reducing inorganic substance, such as an iron compound, a reducing organic substance, such as polyhydric phenols, polyhydric alcohols, ascorbic acid, or a salt thereof, or a metal complex may be used as an oxygen absorber. As illustrated in each of FIGS. 1 and 8, the combination container 10 may contain an oxygen-absorbing member 22 placed in the second container 40 together with the liquid-containing first container 30L. As illustrated in FIG. 9A, the oxygen-absorbing member 22 may include a package 22a having oxygen permeability and the oxygen absorber 21 contained in the package 22a. The oxygen-absorbing member 22 containing the oxygen absorber 21 may be an iron-based moisture-dependent FX type, an iron-based self-reacting S type, an SPE type, a ZP type, a ZI-PT type, a ZJ-PK type, or an E type, all of which are available from Mitsubishi Gas Chemical Company, Inc. The oxygen-absorbing member 22 containing the oxygen absorber 21 may be an organic self-reacting GLS type, a GL-M type, a GE type, or the like available from Mitsubishi Gas Chemical Company, Inc. The oxygen-absorbing member 22 containing the oxygen absorber 21 may be a ZH type, Z-PK Ya, Z-PR, Z-PKR, or a ZM type for pharmaceuticals, available from Mitsubishi Gas Chemical Company, Inc.

In order to promote oxygen absorption by the oxygen absorber 21, as illustrated in FIG. 9B, the oxygen-absorbing member 22 may contain a water-retaining agent 22b that retains water. The water-retaining agent 22b may be, for example, one or more selected from the group consisting of diatomaceous earth, silica, and activated carbon. The water-retaining agent 22b may be used as a carrier for supporting the oxygen absorber 21.

In an example in which the liquid L contains a non-aqueous solvent, such as alcohol or oil, the water-retaining agent 22b that retains water is effective in ensuring the oxygen-absorbing function of the oxygen absorber 21. A nonaqueous solvent refers to a solvent in which the main component having the largest proportion by volume is a component other than water. The nonaqueous solvent may be substantially free of water. The percentage of water by volume in the nonaqueous solvent may be 2% or less, 1% or less, 0.5% or less, or 0.5% or less. The nonaqueous solvent need not contain water.

When the liquid L is an aqueous solution, the oxygen-absorbing member 22 does not need to contain the water-retaining agent 22b. The first container 30 having oxygen permeability often has water vapor permeability. In this example, water can be supplied to the oxygen absorber 21 without using the water-retaining agent 22b. Rather, the water absorption by the water-retaining agent 22b may be suppressed. For example, the amount of water that can be absorbed by the water-retaining agent 22b used in the oxygen-absorbing member 22 may be 5% or less of the volume (mL) of the liquid L contained in the first container 30. As storage conditions for a liquid, such as a pharmaceutical product, the amount of decrease in the volume can be set to 5% or less during the effective period (for example, three years) of the pharmaceutical product. A decrease in the amount of the liquid L in the first container 30 can be regulated. This storage condition can be met by setting the amount of water that can be absorbed by the water-retaining agent 22b to 5% or less of the initial volume (mL) of the liquid L.

When the oxygen absorber 21 is activated by water vapor that has permeated the first container 30 and moved into the second container 40, the whole or part of the oxygen absorber 21 and the whole or part of the oxygen-absorbing member 22 may be arranged vertically above the oxygen-permeable portion of the first container 30. For example, in the case where the container body 32 has the oxygen barrier property and where the stopper 34 has oxygen permeability, the whole or part of the oxygen absorber 21 may be disposed above the stopper 34. In the case where the container body 32 has the oxygen barrier property and where the stopper 34 has oxygen permeability, the whole or part of the oxygen-absorbing member 22 may be disposed above the stopper 34. Water vapor is lighter than nitrogen, oxygen, and many inert gases. Thus, the water vapor that has permeated the first container 30 can be efficiently used to activate the oxygen absorber 21.

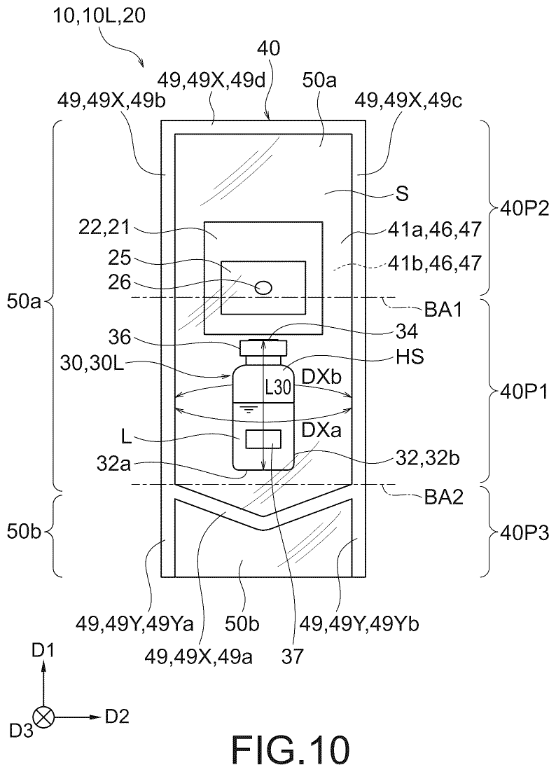

The oxygen absorber 21 may be contained in an oxygen-absorbing film 23. FIG. 9C illustrates an example of a laminate 46 including the oxygen-absorbing film 23. The laminate 46 including the oxygen-absorbing film 23 may include the films 41a to 41e of the second container 40 illustrated in FIGS. 1 and 7A to 7C. The laminate 46 including the oxygen-absorbing film 23 may constitute each of the container body 42 and the lid 44 of the second container 40 illustrated in FIG. 8. The laminate 46 including the oxygen-absorbing film 23 may constitute each of the films 41a and 41b of the second container 40 illustrated in FIGS. 10 to 25 described below. The laminate 46 illustrated in FIG. 9C includes a first layer 46a, a second layer 46b, and a third layer 46c. The first layer 46a may be an outermost layer made of polyethylene terephthalate, polyamide, or the like. The second layer 46b may be an oxygen barrier layer made of, for example, aluminum foil, a metal oxide vapor-deposited film, or a metal vapor-deposited film. The third layer 46c may be an innermost layer serving as a heat seal layer. The illustrated third layer 46c includes a base material 23a made of a thermoplastic resin and the oxygen absorber 21 dispersed in the base material 23a. As an example illustrated in FIG. 9C, the second container 40 may include the oxygen-absorbing film 23 containing the oxygen absorber 21 as part of a laminate 46. The oxygen absorber 21 is not limited to being contained in the heat seal layer or the innermost layer 46c, but may be contained in an intermediate layer, such as an adhesive layer, of the laminate.

As another example, the first container 30 may include the oxygen-absorbing film 23 containing the oxygen absorber 21. The oxygen absorber 21 may be provided separately from the first container 30 or the second container 40 as in the examples illustrated in FIGS. 1 and 8, or may be provided as a part of the first container 30 or the second container 40 as illustrated in FIG. 9C.

The oxygen concentration (%) in the first container 30 and the oxygen concentration (%) in the second container 40 are determined by a measurement device suitable for measuring these oxygen concentrations. As a measurement device for measuring an oxygen concentration, an oxygen content measurement device using a headspace method, a fluorescent contact-type oxygen content measurement device and a fluorescent non-contact-type oxygen content measurement device are known. The amount of oxygen (mg/L) dissolved in the liquid contained in the first container 30 is determined by a measurement device suitable for measuring the amount of dissolved oxygen in the liquid. As a measurement device for measuring the amount of dissolved oxygen, a fluorescent contact-type oxygen content measurement device and a fluorescent non-contact-type oxygen content measurement device are known. As a measurement device for measuring an oxygen concentration and the amount of dissolved oxygen, an appropriate measurement device is selected in consideration of a measurement limit, measurement stability in an oxygen concentration band to be measured, a measurement environment, measurement conditions, and the like.

As the oxygen content measurement device using the headspace method, an FMS 760 headspace analyzer manufactured by Lighthouse Instruments is used. In measurements using this measurement device, the container containing the oxygen to be measured is irradiated with light of a frequency that can be absorbed by oxygen from the outside of the container, and light emerging from the container through the headspace HS of the container is received. A change in light intensity before and after transmission is measured, and the oxygen concentration (%) in the container can be specified based on the change in light intensity. Therefore, if the first container 30 is capable of transmitting light from the measurement device, the oxygen concentration in the first container 30 can be specified without opening the first container 30. If the second container 40 is capable of transmitting light from the measurement device, the oxygen concentration in the first container 30 can also be measured by irradiating the first container 30 contained in the second container 40 with light from the outside of the second container 40 without opening the second container 40. The oxygen concentration (%) in the second container 40 can also be measured using the FMS 760 headspace analyzer manufactured by Lighthouse Instruments. The saturation solubility of oxygen in the liquid L can be specified from the measured oxygen concentration (%) in the headspace HS and the temperature. The amount of oxygen (mg/L) dissolved in the liquid L can be specified based on the specified saturation solubility. In this way, the FMS 760 headspace analyzer can measure the oxygen concentration in the container from the outside of the container. However, the lower limit of the oxygen concentration that can be measured by the FMS 760 headspace analyzer is higher than the lower limit of the oxygen concentration that can be measured by other measurement devices.

As the fluorescent contact-type oxygen content measurement device, a Microx 4 oxygen content measurement device manufactured by PreSens Precision Sensing GmbH, Germany, is used. The Microx 4 oxygen content measurement device is a needle-type device. The Microx 4 oxygen content analyzer can measure the oxygen concentration and the amount of dissolved oxygen in a container by the insertion of a needle into the container, and has excellent measurement stability, although it depends on the configuration of the portion of the container where the needle is inserted. A plurality of combination containers or containers produced under the same conditions are prepared, and the amount of oxygen in each container is measured at different times using the needle-type oxygen content measurement device, so that a temporal change in the amount of oxygen can be evaluated.

By placing an oxygen sensor in a container in advance, the oxygen concentration and the amount of dissolved oxygen in the first container 30 and the second container 40 can be measured using a fluorescent non-contact-type oxygen content measurement device. As the fluorescent non-contact-type oxygen measurement device, a Fibox 3 oxygen content measurement device manufactured by PreSens Precision Sensing GmbH, Germany, is used. The oxygen sensor emits fluorescence when the oxygen sensor receives light in a specific wavelength range. The amount of fluorescent signal from the oxygen sensor varies as the amount of oxygen around the sensor increases. A fluorescent non-contact-type oxygen content measurement device can emit light of a specific wavelength that causes the oxygen sensor to emit fluorescence, and can measure the oxygen concentration (%) and the amount of dissolved oxygen (mg/L) by measuring the amount of signal due to the fluorescence emission of the oxygen sensor. When the first container 30 is contained in the second container 40, the amount of dissolved oxygen in the liquid L can be measured by light irradiation from the outside of the second container 40 without opening the second container 40.

As illustrated in FIGS. 1 and 8, the container set 20 and the combination container 10 may be provided with a dehydrator 24 that absorbs moisture in the second container 40. The dehydrator 24 is a substance having the property of absorbing moisture, such as water vapor or water, or a composition containing such a substance. Examples of the dehydrator 24 can include calcium chloride, soda lime and silica gel. The dehydrator 24 may be contained in the second container 40 together with the first container 30, and the second container 40 may be closed. In the example illustrated in FIG. 1, the dehydrator 24 is disposed in the second container 40 as a dehydrating member contained in a package.

Similar to the oxygen absorber described above, a dehydrating film containing a dehydrating material may be included as a part of the first container 30 or the second container 40. In this example, the oxygen barrier layer constituting the second container 40 and the dehydrating film containing the dehydrator 24 may be laminated and integrated together. When a nonaqueous solvent, such as glycerin or alcohol, is contained in the first container 30, moisture, such as water vapor and water, in the first container 30 can be removed by the dehydrator 24 contained in the second container. The inventors have found that when the dehydrator is contained in the second container 40, the water content in the first container 30 is reduced to 100 μg or less, 50 μg or less, or 10 μg or less.

When the dehydrator 24 is used, moisture, such as water vapor and water, in the first container 30 is measured by the Karl Fischer method. Specifically, the amount of moisture in the first container 30 is determined by coulometric titration using an MKC-610 Karl Fischer moisture meter manufactured by Kyoto Electronics Manufacturing Co., Ltd. If the MKC-610 Karl Fischer moisture meter cannot be used, the amount of moisture in the first container 30 is determined using an MKC-710M Karl Fischer moisture meter manufactured by Kyoto Electronics Manufacturing Co., Ltd.

The container set 20 and the combination container 10 may include an oxygen detection member 25 for detecting the state of oxygen in the second container 40. The oxygen detection member 25 may display information regarding the detected state of oxygen. The oxygen detection member 25 may include a display portion 26 that displays information regarding the state of oxygen. The oxygen detection member 25 may detect an oxygen concentration. The oxygen detection member 25 may display the detected value of the oxygen concentration. The oxygen detection member 25 may display the value of the detected oxygen concentration by color. The oxygen detection member 25 may display, by color, the oxygen concentration range to which the value of the detected oxygen concentration belongs.

The oxygen detection member 25 may include a variable organic dye that reversibly changes color upon oxidation and reduction. For example, the oxygen reducing agent includes an organic dye, such as a thiazine dye, an azine dye, or an oxazine dye, and a reducing agent, and may be in a solid form.

The oxygen reducing agent may contain an oxygen-indicator-ink composition. The oxygen-indicator-ink composition may contain a resin solution, a thiazine dye or the like, a reducing sugar, and an alkaline substance. The thiazine dye or the like, the reducing sugar, and the alkaline substance may be dissolved or dispersed in the resin solution. The substance contained in the oxygen detection member 25 may be reversibly changed by oxidation and reduction. When the oxygen detection member 25 containing a reversible substance is used, the oxygen detection member 25 contained in the container before the deoxygenation is completed changes its display color in accordance with the deoxygenation of the inside of the container. The oxygen-related state in the container can be determined by observing the display on the oxygen detection material 25. In addition, the oxygen detection material 25 contained in the container can indicate an increase in the oxygen concentration after deoxygenation is completed, for example, a state in which a pinhole or the like is formed in the container during, for example, the distribution process and oxygen flows into the container, by changing the display color.

The oxygen detection member 25 may be a commercially available tablet-type oxygen detection member. The oxygen detection member 25 may be an oxygen detection member available from Mitsubishi Gas Chemical Company, Inc. under the trade name “AGELESS-EYE”. The oxygen detection member 25 may be an oxygen detection member coated with an ink composition having the function of detecting oxygen, for example, an oxygen detection member available from Mitsubishi Gas Chemical Co., Ltd. under the trade name “Paper Eye”. “Ageless-Eye” and “Paper Eye” are functional products that can easily indicate an oxygen-free state with an oxygen concentration of less than 0.1% by volume in a transparent container by color change. As the oxygen detection member 25, an oxygen detection member that can be used for maintaining the freshness of food and the quality of pharmaceutical products, etc., together with an oxygen absorber, for example, an oxygen absorber available from Mitsubishi Gas Chemical Company, Inc. under the trade name “Ageless,” may be used.

As illustrated in FIG. 1, the oxygen detection member 25 may be disposed in such a manner that the display portion 26 can be observed from the outside of the transparent second container 40. In the example illustrated in FIG. 1, the oxygen detection member 25 is contained in the second container 40, similarly to the oxygen absorber 21 and the oxygen-absorbing member 22. The oxygen detection member 25 may be joined to the inner surface of the second container 40 or the outer surface of the first container 30 by welding with a bonding material. The oxygen detection member 25 may be disposed in such a manner that the display portion 26 is not rendered unobservable by the oxygen-absorbing member 22 or the dehydrator 24. When a label is attached to the first container 30, the oxygen-absorbing member 22, the dehydrator 24, and the oxygen detection member 25 are preferably arranged so as not to cover the label.

The oxygen detection member 25 may detect the state of oxygen in the first container 30. That is, the container set 20 and the combination container 10 may include an oxygen detection member 25 that detects the state of oxygen in the first container 30. The oxygen detection member 25 may be contained in the first container 30. The oxygen detection member 25 may display information regarding the detected state of oxygen in the first container 30. The oxygen detection member 25 may include a display portion 26 that displays information regarding the state of oxygen in the first container 30. The oxygen detection member 25 may detect the oxygen concentration in the first container 30. The oxygen detection member 25 may display the value of the detected oxygen concentration in the first container 30. The oxygen detection member 25 may display the value of the detected oxygen concentration in the first container 30 by color. The oxygen detection member 25 may display, by color, the oxygen concentration range to which the value of the detected oxygen concentration in the first container 30 belongs.

The oxygen concentration in the space not occupied by the liquid L in the first container 30, the what is called a headspace HS, can be reduced to approximately 1.5% or less by, for example, replacing the headspace HS with an inert gas or bubbling the liquid L with an inert gas before attaching the stopper 34 to the container body 32. It is believed that in the case where a liquid in an atmosphere replaced with an inert gas is produced and where the liquid is stored in a container with an oxygen barrier property, the amount of dissolved oxygen in the liquid stored in the container can be reduced.

However, installing the entire liquid production line in an atmosphere replaced with an inert gas requires extensive modification of the production equipment and huge capital investment. In the field of expensive drugs and the like, the drugs are sometimes freeze-dried and stored in a powder state in order to ensure stability against temperature, oxygen, moisture, light, and the like. However, converting liquid drugs into powder form for storage and then converting the powdered drugs back into a liquid when used has significant disadvantages in terms of effort, time, and cost.

In contrast, according to the present embodiment, the liquid-containing first container can be manufactured in the conventional manner using existing equipment and the like. Therefore, equipment renovation and capital investment can be avoided. This is especially useful in the application of liquids, such as drugs, in that it eliminates the need to apply for approval from public authorities for changes in manufacturing facilities and processes. Furthermore, the effort of freeze-drying the liquid L or returning the powder to a liquid can be eliminated. Furthermore, there are no particular restrictions on the first container 30. Therefore, materials that are widely used as containers for foods and drugs because of their low amounts of elution, such as glass and resins, e.g., polyethylene and polypropylene, can be used as the material for the first container.

In the above-described specific example, the first container 30 includes the container body 32 and the stopper 34. The first container 30 may be a vial. However, conventionally, vials containing liquid, particularly vials containing liquid in a sterile condition, are made of butyl rubber or fluororubber, which have low oxygen permeability and further oxygen barrier properties. In contrast, in the specific example described above, the stopper 34 has oxygen permeability. That is, oxygen can permeate the stopper 34. For example, the oxygen permeability coefficient (cm³ (STP)·cm/(cm²·sec·Pa)) of the material constituting the stopper 34 is set to be high. The stopper 34 may be made from silicone or silicone rubber. The oxygen permeability coefficient of the silicone or silicone rubber that constitutes the stopper 34 may be greater than the oxygen permeability coefficient of the material that constitutes the container body 32. In this specific example, oxygen permeates the stopper 34 to move outside the first container 30. Therefore, the use of the stopper 34 having oxygen permeability can easily impart oxygen permeability to an existing container, such as a vial conventionally used.

In this specific example, the time to reach equilibrium depends on the amount of oxygen that can permeate the stopper 34. Therefore, by adjusting the area of the opening portion 33 of the container body 32 and the thickness of the stopper 34 as described above, the time from when the first container 30 is placed in the second container 40 to when the permeation of oxygen through the first container 30 reaches equilibrium can be reduced. This can suppress decomposition of the liquid L due to oxygen.

The partial volume of the first container 30 (the volume of the headspace HS) obtained by subtracting the volume of the liquid L from the volume of the first container 30 may be 50 mL or less, 30 mL or less, 10 mL or less, or 5 mL or less. As described above, the setting of the upper limit of the partial volume (volume of the headspace HS) of the first container 30 can reduce the amount of oxygen in that volume. Thus, in the liquid-containing combination container 10L, the time from when the second container 40 containing the first container 30 is closed to when the oxygen permeation through the first container 30 reaches equilibrium can be reduced. This can suppress decomposition of the liquid L due to oxygen.

Similarly, the volume of the liquid L contained in the first container 30 may be 20 mL or less, or 10 mL or less. In the liquid-containing combination container 10L, the time from when the second container 40 containing the first container 30 is closed to when the oxygen permeation through the first container 30 reaches equilibrium can be reduced. This can suppress decomposition of the liquid L due to oxygen.

An upper limit and a lower limit may be set for the proportion (%) of the partial volume (volume of the headspace HS) (mL) of the first container 30 obtained by subtracting the volume of the liquid L from the volume of the first container 30 to the partial volume (mL) of the second container 40 obtained by subtracting the volume occupied by the first container 30 from the volume of the second container 40. This proportion may be 50% or less, or may be 20% or less. By setting the upper limit, the oxygen concentration in the first container 30 can be sufficiently reduced. Furthermore, a storage space for the first container 30 can be ensured in the second container 40, and thus the first container 30 can be easily stored in the second container 40. Moreover, the time from closing the second container 40 containing the first container 30 to the equilibrium of oxygen permeation through the first container 30 can be reduced. This can suppress decomposition of the liquid L due to oxygen. This percentage may be 5% or more, or 10% or more. By setting the lower limit, the second container 40 is not too large with respect to the first container 30, so that deterioration in the handleability of the combination container 10 can be suppressed.

Whether the oxygen permeation through the first container 30 is in equilibrium is determined based on the oxygen concentration in the first container 30. With regard to this determination, when the difference between the oxygen concentration value (%) in the first container 30 at a given point in time and the oxygen concentration value (%) in the first container 30 24 hours before that point in time is ±5% or less of the oxygen concentration value (%) in the first container 30 at that point in time, the state is determined as an equilibrium state.

In this manner, it is possible to produce the liquid-containing first container 30L and the liquid-containing combination container 10L in which the oxygen concentration and the amount of dissolved oxygen are adjusted. In the conventional art, it has often been difficult to reduce the oxygen concentration (%) in the headspace HS in the first container 30 by simply replacing the gas with an inert gas or by bubbling the gas, because the liquid L is contained in the first container 30. As a result, it has been difficult to reduce the amount of dissolved oxygen in the liquid L. In contrast to this, in the above-described specific example according to an embodiment, the second container 40 contains the liquid-containing first container 30L and a gas, and there is no need to contain the liquid L as it is. Therefore, the oxygen concentration in the second container 40 can be sufficiently reduced. By adjusting the volume of the second container 40, the oxygen concentration in the first container 30 at equilibrium can be maintained at less than 1%. Such effects are suitable when the liquid L is a highly sensitive drug or food.

In particular, when the oxygen absorber 21 that absorbs oxygen in the second container 40 is used, the oxygen concentration in the first container 30 can be reduced to less than 0.3%, 0.1% or less, 0.05% or less, less than 0.03%, or even 0%, and the oxygen concentration in the second container 40 can be reduced to less than 0.3%, 0.1% or less, 0.05% or less, less than 0.03%, or even 0%. In addition, when the oxygen absorber 21 that absorbs oxygen in the second container 40 is used, the amount of dissolved oxygen in the liquid L in the first container 30 can be reduced to less than 0.15 mg/L, 0.04 mg/L or less, 0.03 mg/L or less, less than 0.015 mg/L, or even 0 mg/L. In addition, the oxygen absorber 21 is placed on the outside of the first container 30, and thus the oxygen absorber 21 does not impair the sterilized state of the inside of the first container 30.

If it takes a long time for the oxygen concentration or the amount of dissolved oxygen to decrease, deterioration of the liquid L due to oxygen will progress. The period or time from when the second container 40 is closed to when oxygen permeation through the first container 30 reaches equilibrium is preferably within four weeks. When the equilibrium state is reached within four weeks, for example, the oxygen concentration in the second container 40 is less than 1%, deterioration of the liquid L as a drug can be effectively suppressed. For a highly sensitive liquid L, the time to equilibrium is preferably within 20 days, more preferably within 1 week, and even more preferably within 3 days.

Meanwhile, it takes a certain period of time to reach an equilibrium state in which the amount of dissolved oxygen in the liquid L is reduced to a certain degree. The period or time from when the second container 40 is closed to when the oxygen permeation through the first container 30 reaches equilibrium may be one hour or more.

The adjustment of the amount of oxygen in the first container 30 inside the second container 40 may be performed until the permeation of oxygen through the first container 30 reaches equilibrium.

The adjustment of the amount of oxygen in the first container 30 inside the second container 40 may be performed until the oxygen concentration in the second container 40 increases to a predetermined value. The adjustment of the amount of oxygen in the first container 30 inside the second container 40 may be performed until the oxygen concentration in the first container 30 decreases to a predetermined value. The adjustment of the amount of oxygen in the first container 30 inside the second container 40 may be performed until the amount of dissolved oxygen in the liquid L in the first container 30 decreases to a predetermined value. The adjustment of the amount of oxygen in the first container 30 inside the second container 40 may be performed until the time of use of the liquid L in the combination container 10. While the first container 30 is stored in the second container 40 to adjust the amount of oxygen, the liquid-containing combination container 10L may be distributed.

A method of using the liquid-containing combination container 10L will be described.

In using the liquid L contained in the combination container 10, the second container 40 is first opened. The first container 30L containing the liquid is then removed from the opened second container 40. Thereafter, the liquid L can be removed from the liquid-containing first container 30L and used. For the illustrated first container 30, the first container 30 can be opened by removing the fixture 36 from the container body 32 and then removing the stopper 34 from the container body 32. Thus, the liquid L in the first container 30 can be used.

As illustrated in FIG. 6, liquid L may be a drug injected into a syringe 60. The liquid L may be a liquid contained in the first container 30 that is a vial. The liquid L may be an injectable drug. Examples of injectable drugs include anticancer drugs, antiviral drugs, vaccines, and antipsychotics. The syringe 60 may include a cylinder 62 and a piston 66. The cylinder 62 may include a cylinder body 63 and a needle 64 protruding from the cylinder body 63. The cylindrical needle 64 provides access to the space in the cylinder body 63 for containing the liquid L. The piston 66 may include a piston body 67 and a gasket 68 retained in the piston body 67. The gasket 68 may be made of rubber or the like. The gasket 68 is inserted into the cylinder body 63 to define a storage space for the liquid L in the cylinder body 63. The liquid L injected into the syringe 60 may be transferred from the syringe 60 to another syringe, a container, or the like, before being administered to a patient, or the like. In this example, it may be administered to the patient from a separate syringe, container, etc.

The pressure inside the liquid-containing first container 30L is preferably adjusted. As an example, it is preferable that the pressure inside the liquid-containing first container 30L is maintained low, and in particular, that it is maintained at a negative pressure. According to this example, unintended leakage of the liquid during storage of the liquid-containing first container 30L, splashing of the liquid L during opening of the first container 30, and the like can be effectively suppressed. The problem of leakage and splashing is more serious with toxic liquids, such as highly pharmacologically active drugs. In the example illustrated in FIG. 6, when the pressure in the liquid-containing first container 30L is positive, the liquid L automatically flows into the syringe 60. In this case, it is difficult to inject a desired amount of the liquid L into the syringe 60 with high accuracy.

Meanwhile, highly sensitive liquids that are deteriorated by post-sterilization treatment performed after production using, for example, gas, heat, gamma rays, etc., such as food and drugs, more specifically, anticancer drugs, antiviral drugs, vaccines, antipsychotics, etc., are produced under sterile environments and sealed in containers. That is, liquids for which a terminal sterilization method cannot be used are produced by an aseptic manipulation method. The sterile environment is usually maintained at a predetermined positive pressure in order to suppress the invasion of bacteria.

Therefore, the pressure in the container is a predetermined positive pressure corresponding to the sterile environment, and it is difficult to adjust the internal pressure of the container after the container is closed.

According to the present embodiment, such defects can be addressed. As described above, the liquid-containing first container 30L is stored in the second container 40. During the storage, oxygen in the first container 30 permeates the first container 30 to move into the second container 40 due to a decrease in the oxygen concentration in the second container 40 caused by the oxygen absorber 21 and a decrease in the oxygen concentration in the second container 40 caused by the replacement with the inert gas. Thus, the pressure in the first container 30 can be reduced. That is, the pressure of the first container 30 containing the liquid L can be adjusted after the first container 30 is closed and the liquid L is sealed therein.

From the viewpoint of adjusting the internal pressure of the first container 30, the second container 40 that, under atmospheric pressure, can contain it while a gas is maintained at a negative pressure may be used. For example, the second container 40 Illustrated in FIG. 8 may be used, and the second container 40 containing the first container 30 may be closed in an inert gas atmosphere maintained at a negative pressure. The pressure in the closed second container 40 is less than atmospheric pressure. In this case, oxygen permeation from the first container 30 to the second container 40 is promoted. In particular, the pressure in the first container 30 can be greatly adjusted by ensuring a large volume of the second container 40 or by greatly reducing the initial pressure of the second container 40. Thus, the pressure in the first container 30, which was initially positive, can be adjusted to be lower than or equal to atmospheric pressure (1 atm) by storing the first container 30 in the second container 40, and further can be adjusted to a negative pressure. Thus, a pressure-adjusted liquid-containing first container 30L can be produced without depending on a method for producing the liquid L, a method for sealing the liquid L in the first container 30, or the like.

Closing the second container 40 under negative pressure promotes oxygen permeation through the first container 30. Therefore, the time from when the second container 40 containing the liquid-containing first container 30L is closed to when oxygen permeation through the first container 30 reaches equilibrium can be reduced.

The term “negative pressure” refers to a pressure less than atmospheric pressure, i.e., a pressure less than 1 atm. The term “positive pressure” refers to a pressure greater than atmospheric pressure, i.e., a pressure greater than 1 atm. If the container is provided with a pressure gauge, whether the pressure inside the container is negative is determined using the pressure gauge. If the container is not provided with a pressure gauge, the pressure can be determined using a syringe.

Specifically, the pressure is determined by whether the liquid or gas contained in the syringe flows into the container when the needle of the syringe is inserted into the target container with only atmospheric pressure applied to the piston of the syringe. When the liquid or gas contained in the syringe flows into the container, the pressure inside the container is determined to be negative. Similarly, whether the inside of the container is positive is determined using a pressure gauge. If the container is not provided with a pressure gauge, the pressure can be determined using a syringe. Specifically, the pressure is determined by whether the liquid or gas contained in the container flows into the container when the needle of the syringe is inserted into the syringe with only atmospheric pressure applied to the piston of the syringe. When the liquid or gas contained in the container flows into the syringe, the pressure inside the container is determined to be positive.

In an embodiment described above, the container set 20 includes the first container 30 having oxygen permeability at least in part, and the second container 40 that can contain the first container 30 and that has the oxygen barrier property. The liquid-containing combination container 10L includes the first container 30 that contains the liquid L and that has oxygen permeability at least in part, and the second container 40 that contains the first container 30 and has the oxygen barrier property. When oxygen permeation through the first container 30 is in equilibrium, the oxygen concentration in the first container 30 may be less than 1%. A method for manufacturing the liquid-containing first container 30L includes the steps of closing the second container 40 containing the liquid-containing first container 30L, and adjusting the amount of oxygen in the liquid-containing first container 30L contained in the second container 40. In the step of adjusting the amount of oxygen, the oxygen in the first container 30 permeates the first container 30; hence, the oxygen concentration in the first container 30 can be reduced to reduce the amount of dissolved oxygen in the liquid L.

As illustrated in FIG. 1, the gap G may be formed between the second container 40 and the oxygen-permeable stopper 34 of the first container 30 contained in the second container 40. According to this example, it is possible to suppress the second container 40 having the oxygen barrier property from covering the stopper 34 having oxygen permeability. This can suppress oxygen permeation through the first container 30 from being hindered by the second container 40. Therefore, by providing the gap G, the reduction in the amount of oxygen inside the first container 30 can be promoted.

According to such an embodiment, oxygen in the first container 30 can permeate the first container 30 to move into the second container 40. If the atmosphere in the second container 40 is replaced with inert gas, the oxygen concentration (%) in the second container 40 can be increased and the oxygen concentration (%) in the first container 30 can be decreased. As the oxygen concentration (%) in the first container 30 decreases, the amount of dissolved oxygen in the liquid L (mg/L) also decreases. Therefore, the amount of dissolved oxygen in the liquid L can be reduced, and decomposition of the liquid L due to oxygen can be suppressed.

If the oxygen absorber 21 that absorbs oxygen in the second container 40 is used instead of purging the inside of the second container 40 with an inert gas or in addition to purging the inside of the second container 40 with an inert gas, the oxygen concentration in the first container 30 and the amount of dissolved oxygen in the liquid L in the first container 30 can be further reduced. The use of the oxygen absorber 21 can reduce the oxygen concentration in the first container 30 to less than 0.3%, 0.1% or less, 0.05% or less, less than 0.03%, or even 0%, and can reduce the oxygen concentration in the second container 40 to less than 0.3%, 0.1% or less, 0.05% or less, less than 0.03%, or even 0%. The use of the oxygen absorber 21 can reduce the amount of dissolved oxygen in the liquid L in the first container 30 to less than 0.15 mg/L, 0.04 mg/L or less, 0.03 mg/L or less, less than 0.015 mg/L, or even 0 mg/L. Since the oxygen absorber 21 can be disposed outside the first container 30, the oxygen absorber 21 does not impair the sterile condition of the inside of the first container 30.

In this combination container 10, the second container 40 is responsible for reducing the amount of oxygen and for providing the oxygen barrier property. The liquid-containing first container 30L may be responsible for the sterility of its interior and the liquid L contained therein. In this way, the storage environment required for the liquid L is efficiently provided by the combination of the first container 30 and the second container 40. According to the combination container 10 and the container set 20, the storage environment required for the liquid L can be provided inexpensively and easily with high flexibility.

In the above-described specific example of an embodiment, the first container 30 includes the container body 32 having the opening portion 33 and the stopper 34 that closes the opening portion 33.

The stopper 34 may have oxygen permeability. The stopper 34 may contain silicone. The material constituting the stopper 34 may have an oxygen permeability coefficient of 1×10⁻¹² (cm³ (STP)·cm/(cm²·sec·Pa)) or more. The oxygen permeability coefficient (cm³ (STP)·cm/(cm²·sec·Pa)) of the material constituting the stopper 34 may be greater than the oxygen permeability coefficient (cm³ (STP)·cm/(cm²·sec·Pa)) of the material constituting the container body 32. In this specific example, oxygen permeates the stopper 34 to move outside the first container 30. Accordingly, oxygen permeability can be imparted to a region located above the liquid L in the first container 30, such as what is called the headspace HS. This allows oxygen permeation through the first container 30 to proceed smoothly, and the time from when the first container 30 is placed in the second container 40 to when oxygen permeation through the first container 30 reaches equilibrium can be reduced.

In the above-described specific example of an embodiment, the container body 32 may have the oxygen barrier property. Oxygen that had permeated the first container 30 enters a region, such as a headspace HS, separated from the liquid L in the first container 30. Therefore, dissolution of oxygen that has permeated the first container 30 into the liquid L can be suppressed.

In the above-described specific example of an embodiment, the area of the opening portion 33 of the container body 32 may be 10 mm² or more and 500 mm² or less. The thickness of the stopper 34 may be 0.1 mm or more and 5 mm or less. According to the liquid-containing combination container 10L, the time from when the first container 30 is placed in the second container 40 to when oxygen permeation through the first container 30 reaches equilibrium can be reduced. This can suppress decomposition of the liquid L due to oxygen.

Here, the results of experiments performed by the inventors will be described.

### Example 1

A vial with a capacity of about 9.2 mL was provided as a first container. The first container had the configuration illustrated in FIG. 1. The vial serving as the first container included a glass container body. The container body had an oxygen barrier property. Under atmospheric pressure, the first container was capable of containing a gas while the gas was maintained at a negative pressure. About 4 mL of water for injection (aqueous solution) was placed in the first container as a liquid L. The opening portion of the container body containing the water for injection was closed with a rubber stopper. The rubber stopper was made of silicone rubber. The rubber stopper had oxygen permeability. An aluminum seal was fixed to the head portion of the container body using a hand clipper to prepare a liquid-containing first container. The aluminum seal served as the fixture illustrated in FIG. 2A. That is, the aluminum seal restricted the detachment of the rubber stopper from the container body. After sealing with the aluminum seal, the space between the container body and the rubber stopper was in an airtight state. A headspace with a volume of about 4.2 mL, which was not filled with the water for injection, remained in the first container. The first container was closed in air. Thus, the headspace of the first container 30 contained air. The oxygen concentration in the headspace of the first container 30 was 21.0%. The amount of dissolved oxygen in the water for injection contained in the first container was 8.84 mg/L. The amount of oxygen permeation through the stopper of the first container was measured by the method illustrated in FIG. 2B and was found to be 3 (mL/(day×atm)), indicating that the first container in Example 1 had oxygen permeability.

A second container made of a transparent oxygen-barrier packaging material was provided. The second container had the configuration illustrated in FIG. 1. The second container was what is called a pouch. The liquid-containing first container and an oxygen-absorbing member containing an oxygen absorber were placed in the second container, and the second container was sealed by heat sealing. The closed second container contained about 100 mL of air. The oxygen-absorbing member contained an oxygen absorber capable of absorbing 200 mL of oxygen.

All materials, members, and so forth used for the first container of Example 1 were sterilized before use. The placement of water for injection in the first container, the closure of the first container, the placement of the liquid-containing first container and the oxygen absorber in the second container, and the closure of the second container were performed in a sterile isolator. In Comparative Examples 1 and 2 described below, the use of sterilized materials and the operation in the sterile isolator were also performed in the same manner.

### Comparative Example 1

A liquid-containing first container was produced in the same manner as in Example 1. This liquid-containing first container was used as Comparative Example 1. That is, in Comparative Example 1, the second container was omitted. The rubber stopper of the first container was made of silicone rubber, as in Example 1.

### Comparative Example 2

In Comparative Example 2, the rubber stopper closing the opening portion of the container body of the first container was made of butyl rubber. Comparative Example 2 differed from Example 1 in this respect, but was otherwise the same as Example 1. The oxygen transmission rate of the butyl rubber of which the rubber stopper in Comparative Example 1 was made was about 80 (cm³/(m²×24 h×atm)), indicating that the butyl rubber had almost no oxygen permeability.

### <Evaluation>

In each of Example 1 and Comparative Example 2, after the second container was closed, the liquid-containing combination container was stored. In Comparative Example 1, after the first container was closed, the liquid-containing first container was stored. The environment in which Example 1, Comparative Example 1, and Comparative Example 2 were stored was in an air atmosphere of 22 °C and atmospheric pressure. Changes over time in the amount of dissolved oxygen (mg/L) in the water for injection, the oxygen concentration (%) in the first container, and the oxygen concentration (%) in the second container were examined during the storage period. The amount of dissolved oxygen (mg/L) in the water for injection, the oxygen concentration (%) in the first container, and the oxygen concentration (%) in the second container were measured with a Fibox 3 oxygen content measurement device manufactured by PreSens Precision Sensing GmbH, Germany. The first container and the second container contained oxygen measuring chips. The amount of dissolved oxygen (mg/L) in the water for injection, the oxygen concentration (%) in the first container, and the oxygen concentration (%) in the second container were measured from the outside of the container without destroying the container with the Fibox 3 oxygen content measurement device. The detection limit of the oxygen concentration with the Fibox 3 oxygen content measurement device was 0.03%. The detection limit of the amount of dissolved oxygen with the Fibox 3 oxygen content measurement device was 0.015 mg/L.

The measurement results of the oxygen concentration (%) in the second container are presented in Table 1. The measurement results of the oxygen concentration (%) in the first container are presented in Table 2. The measurement results of the amount of dissolved oxygen (mg/L) in the water for injection are presented in Table 3. In these tables, “0” indicates that no oxygen was detected.

TABLE 1
Temporal change in oxygen concentration in second container

Oxygen concentration in second container (%)

| Elapsed days | | Comparative | Comparative |
|---|---|---|---|
| (days) | Example 1 | Example 1 | Example 2 |
| 1 | 0 | — | 0 |
| 2 | 0 | — | 0 |
| 3 | 0 | — | 0 |
| 6 | 0 | — | 0 |
| 7 | 0 | — | 0 |
| 8 | 0 | — | 0 |
| 8.5 | 0 | — | 0 |
| 9 | 0 | — | 0 |
| 10 | 0 | — | 0 |
| 17 | 0 | — | 0 |
| 31 | 0 | — | 0 |

TABLE 2
Temporal change in oxygen concentration in first container

Oxygen concentration in first container (%)

| Elapsed days | | Comparative | Comparative |
|---|---|---|---|
| (days) | Example 1 | Example 1 | Example 2 |
| 1 | 14.95 | 22.07 | 22.25 |
| 2 | 9.05 | 22.23 | 22.10 |
| 3 | 6.70 | 21.00 | 21.85 |
| 6 | 1.60 | 20.10 | 20.80 |
| 7 | 1.45 | 21.33 | 21.80 |
| 8 | 0.80 | 20.93 | 22.60 |
| 8.5 | 0.80 | 22.63 | 23.05 |
| 9 | 0.40 | 21.27 | 21.95 |
| 10 | 0.15 | 20.93 | 21.55 |
| 17 | 0 | 21.73 | 22.00 |
| 31 | 0 | — | 21.45 |

TABLE 3
Temporal change in amount of dissolved
oxygen in water for injection

| | Amount of dissolved oxygen in water for injection (mg/L) | | |
|---|---|---|---|
| Elapsed days | | Comparative | Comparative |
| (days) | Example 1 | Example 1 | Example 2 |
| 1 | 5.51 | 8.76 | 8.57 |
| 2 | 3.36 | 8.42 | 8.34 |
| 3 | 2.67 | 8.47 | 8.71 |
| 6 | 0.62 | 7.74 | 7.91 |
| 7 | 0.53 | 8.47 | 8.70 |
| 8 | 0.30 | 8.46 | 8.71 |
| 8.5 | 0.28 | 8.45 | 8.62 |
| 9 | 0.16 | 8.46 | 8.75 |
| 10 | 0.06 | 8.35 | 8.56 |
| 17 | 0 | 8.48 | 8.58 |
| 31 | 0 | — | 8.82 |

As presented in Tables 1 to 3, in Example 1, the oxygen concentration in the second container decreased to 0% one day after the closure of the second container. In Example 1, the oxygen concentration in the first container was reduced to 0%. In Example 1, the amount of dissolved oxygen in the water for injection contained in the first container was reduced to 0 mg/L.

A specific example of the liquid-containing combination container 10L will be further described below. According to the following specific example, the liquid-containing combination container 10L can be easily handled.

In the following description and the drawings used in the following description, the same reference numerals are used for portions that can be configured in the same manner as in the above-described example, or portions that can be configured in the same manner among some specific examples described below, and redundant descriptions are omitted. In the liquid-containing combination container 10L described below, the first container 30, the oxygen-absorbing member 22, the oxygen detection member 25, and so forth may have the same configurations as those described above.

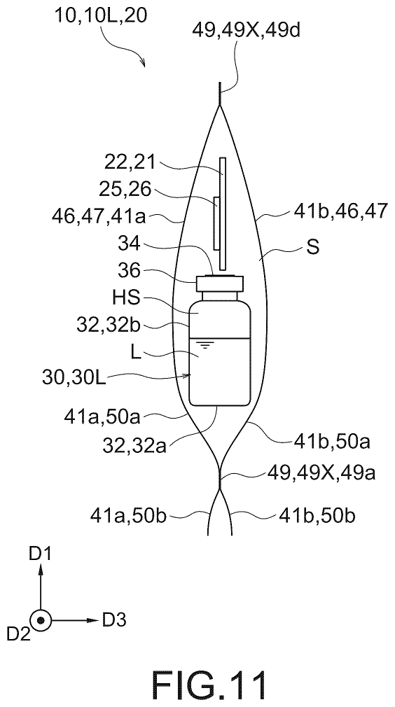

FIGS. 10 to 25 are diagrams for explaining specific examples of the second container 40. FIGS. 10 and 11 illustrate the liquid-containing combination container 10L. FIG. 10 is a front view illustrating the liquid-containing combination container 10L. FIG. 11 is a longitudinal sectional view illustrating the liquid-containing combination container 10L. As illustrated in FIGS. 10 and 11, the liquid-containing combination container 10L includes the liquid-containing first container 30L, the second container 40, and the oxygen absorber 21. In the illustrated example, the liquid-containing combination container 10L contains the oxygen detection member 25. The oxygen detection member 25 may include a display portion 26.

The first container 30 may be configured as described above. The illustrated first container 30 includes the container body 32 having the opening portion 33 and the stopper 34 that closes the opening portion 33. The stopper 34 has oxygen permeability. That is, oxygen can permeate the stopper 34.

The oxygen absorber 21 may be contained in the second container 40 as the oxygen-absorbing member 22. The oxygen-absorbing member 22 may include the package 22a having oxygen permeability and the oxygen absorber 21 contained in the package 22a. The oxygen-absorbing member 22 may further include a water-retaining agent 22b. The second container 40 or the first container 30 may include an oxygen-absorbing film 23.

The second container 40 has the oxygen barrier property. The second container 40 is a container made of a film. The second container includes the first film (first main film) 41a and the second film (second main film) 41b. The first film 41a and the second film 41b are positioned to face each other. The first film 41a and the second film 41b may be different films. The first film 41a and the second film 41b may be a single film that is folded over as described with reference to FIGS. 7C and 7D.

The first film 41a and the second film 41b are joined to each other at a linear seal portion 49. The joining at the seal portion 49 may be performed by, for example, welding, such as heat sealing or ultrasonic bonding, or may be joining using an adhesive material or a bonding material. A storage space S for storing the first container 30 is provided between the first film 41a and the second film 41b.

The first film 41a and the second film 41b are peelable at the seal portion 49. When a user applies a force to peel off the first film 41a and the second film 41b, the first film 41a and the second film 41b are separated from each other at the seal portion 49. The seal portion 49 can be made peelable by adjusting the processing conditions during joining and the material and thickness of the bonding material (sealant layer). The seal portion 49 may be linear.

The term “peelable” indicates that a user of the liquid-containing combination container 10L can hold the second container 40 by hand and peel off the first film 41a and the second film 41b from each other without using a tool or an aid. The heat seal strength, measured in accordance with JIS Z 0238, of the seal portion joined in a peelable manner may be 3 N/15 mm or more and 15 N/15 mm or less, or 4 N/15 mm or more and 7 N/15 mm or less. The heat seal strength is the arithmetic mean value of five measurements.

The seal portion 49 includes a bent first seal portion 49a. The first seal portion 49a may be linear. The first container 30 contained in the second container 40 faces the first seal portion 49a. The first container 30 faces the linear first seal portion 49a in a first direction D1. The first seal portion 49a is bent so as to project away from the first container 30 in the first direction D1. The first seal portion 49a is bent so as to project toward the outside of the storage space S of the second container 40. The first seal portion 49a is bent so as to project toward the side where the storage space S of the second container 40 is expanded.

In the illustrated example, the seal portion 49 includes a first side seal portion 49b connected to one end of the first seal portion 49a, and a second side seal portion 49c connected to the other end of the first seal portion 49a. The storage space S of the second container 40 that stores the first container 30 is provided between the first side seal portion 49b and the second side seal portion 49c. A minimum distance DXa along the first film 41a between the first side seal portion 49b and the second side seal portion 49c may be shorter than the length L30 of the first container 30 in a direction in which the stopper 34 is inserted into the opening portion 33. A minimum distance DXb along the second film 41b between the first side seal portion 49b and the second side seal portion 49c may be shorter than the length L30 of the first container 30 in the direction in which the stopper 34 is inserted into the opening portion 33. In the illustrated example, the direction in which the stopper 34 is inserted into the opening portion 33 is the same as the first direction D1 in which the first container 30 and the first seal portion 49a face each other.

The minimum distance DXa along the first film 41a between the first side seal portion 49b and the second side seal portion 49c is the minimum length of the first film 41a between the first side seal portion 49b and the second side seal portion 49c. The minimum distance DXb along the second film 41b between the first side seal portion 49b and the second side seal portion 49c is the minimum length of the second film 41b between the first side seal portion 49b and the second side seal portion 49c. The length L30 of the first container 30 is the length in the axial direction of the first container 30, and is usually the length in the longitudinal direction of the first container 30.

When each of the minimum distances DXa and DXb along the films 41a and 41b between the side seal portions 49b and 49c is shorter than the length L30 of the first container 30, a significant change in the orientation of the first container 30 in the second container 40 can be suppressed. That is, the orientation of the first container 30 in the second container 40 is stabilized. This makes it possible to stably maintain a state in which the stopper 34 of the first container 30 and the oxygen-absorbing member 22 including the oxygen absorber 21 face each other as described below, and to promote the discharge of oxygen from the first container 30.

The seal portion 49 further includes a second seal portion 49d opposite the first seal portion 49a in the first direction D1. In the illustrated example, the seal portion 49 includes the first seal portion 49a and the second seal portion 49d opposite each other in the first direction D1, and the first side seal portion 49b and the second side seal portion 49c opposite each other in a second direction D2. The first seal portion 49a, the second seal portion 49d, the first side seal portion 49b, and the second side seal portion 49c form the seal portion 49 in an annular shape. The storage space S of the second container 40 is defined by the annular seal portion 49. Instead of the second seal portion 49d, the folded portion 41x formed by folding back a single film as illustrated in FIG. 7C may be provided.

As illustrated in FIGS. 10 and 11, the first film 41a and the second film 41b each include a main portion 50a and an extension portion 50b connected to the main portion 50a, the storage space S being provided by the main portions 50a. The main portion 50a includes the first seal portion 49a, the second seal portion 49d, the first side seal portion 49b, the second side seal portion 49c, and a portion surrounded by these seal portions 49a, 49d, 49b, and 49c. Each extension portion 50b is connected to the main portion 50a at the first seal portion 49a. The extension portion 50b may connect with at least the bend apex portion of the first seal portion 49a. The extension portion 50b may be connected to at least a portion of the first seal portion 49a that projects most from the first container 30 in the first direction D1 in which the first container 30 and the first seal portion 49a face each other. In the extension portion 50b, the space between the first film 41a and the second film 41b is open to the outside. In the extension portion 50b, the space between the first film 41a and the second film 41b is not sealed by a seal portion.

A user can easily apply a peeling force to the first film 41a and the second film 41b by grasping the extension portions 50b. At this time, the peeling force is concentrated at the bend apex of the first seal portion 49a. In the illustrated example, the peeling force is concentrated at the bent portion of the bent first seal portion 49a. Thus, the first film 41a and the second film 41b can be easily and smoothly peeled off from the bent first seal portion 49a as a starting point. In the second container 40, the first seal portion 49a is a to-be-opened portion. The to-be-opened portion is a portion that is intended to be opened when the second container 40 is opened.

In the illustrated example, the second direction D2 is perpendicular to the first direction D1. A third direction D3 is perpendicular to both the first direction D1 and the second direction D2. The first film 41a and the second film 41b face each other in the third direction D3. The first film 41a and the second film 41b each have a rectangular shape when unfolded flat. Each of the first film 41a and the second film 41b includes a pair of edge portions each extending in the first direction D1. Each of the first film 41a and the second film 41b includes a pair of edge portions extending in the second direction D2. The edge portions extending in the first direction D1 serve as the long sides of the rectangular shape. The edge portions extending in the second direction D2 serve as the short sides of the rectangular shape.

In order to clarify the relationship of the directions among the drawings, the common directions are indicated by arrows with common symbols in some of the drawings. The tip side of an arrow is a first side in each direction. The side opposite to the tip of an arrow is a second side in each direction. An arrow pointing in a direction perpendicular to the paper surface of the drawing and pointing into the paper surface is indicated by a symbol of a circle with x in it, as illustrated in FIG. 10, for example. An arrow pointing from the paper surface toward the front in a direction perpendicular to the paper surface of the drawing is represented by a symbol of a dot within a circle, as illustrated in FIG. 11.

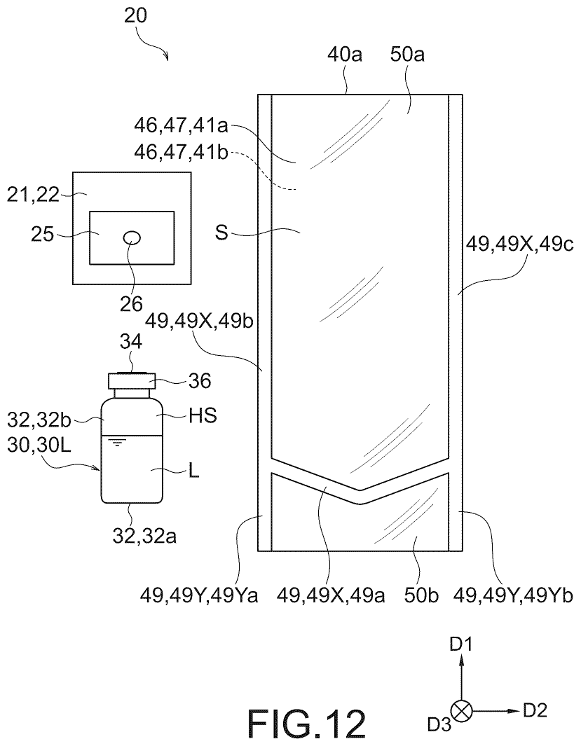

With reference to FIGS. 12 to 14, a method for manufacturing the liquid-containing combination container 10L illustrated in FIGS. 10 and 11 will be described below.

As illustrated in FIG. 12, the liquid-containing first container 30L, the oxygen-absorbing member 22, the oxygen detection member 25, and the second container 40 are prepared. The second container 40 is not yet closed. In the illustrated example, the first film 41a and the second film 41b are joined at the first seal portion 49a, the first side seal portion 49b, and the second side seal portion 49c. The storage space S for receiving the first container 30, the oxygen-absorbing member 22, and the oxygen detection member 25 is generally formed by this three-sided seal. However, the first film 41a and the second film 41b are not joined at the second seal portion 49d. That is, the second container 40 has the opening 40a communicating with the storage space S.

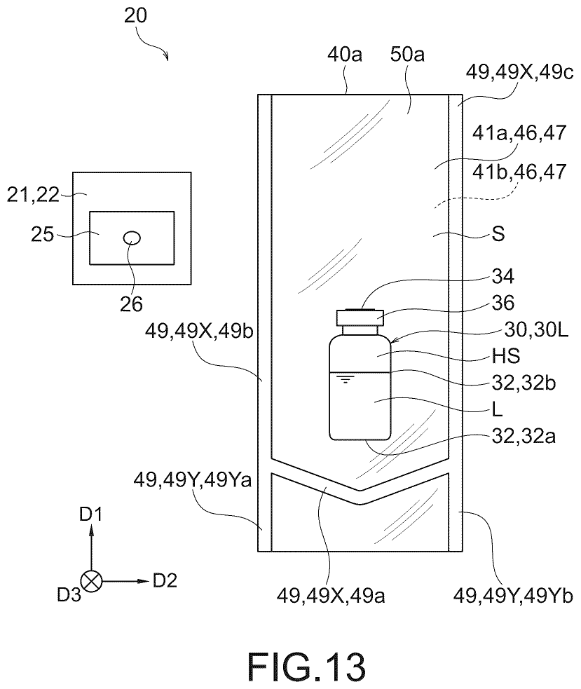

As illustrated in FIG. 13, the first container 30 is placed in the storage space S of the second container 40. In the illustrated example, the first container 30 is placed in the storage space S of the second container 40 in such a manner that the container body 32 of the first container 30 faces the first seal portion 49a. The bottom portion 32a of the container body 32 faces the first seal portion 49a in the first direction D1.

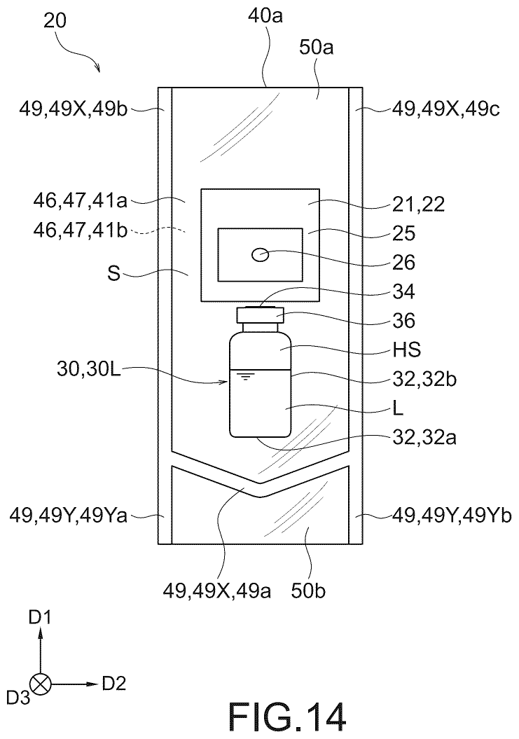

As illustrated in FIG. 14, the oxygen-absorbing member 22 and the oxygen detection member 25 are placed in the storage space S of the second container 40. The oxygen-absorbing member 22 is in sheet form. The oxygen-absorbing member 22 is placed in the storage space S of the second container 40 in such a manner that one side edge of the oxygen-absorbing member 22 in sheet form faces the stopper 34 of the first container 30. The oxygen detection member 25 is in sheet form. The oxygen detection member 25 in sheet form is overlapped with the oxygen-absorbing member 22 in the third direction D3.

The first film 41a and the second film 41b are joined at the second seal portion 49d to close the second container 40. This results in a liquid-containing combination container 10L. Prior to closing the second container 40, the storage space S of the second container 40 may be purged with an inert gas.

The second container 40 may be closed in an inert gas atmosphere. Unlike the first seal portion 49a, the second seal portion 49d can be formed in a straight line. Unlike the first seal portion 49a, the second seal portion 49d may be joined in a non-peelable manner. Therefore, even when the first container 30, the oxygen-absorbing member 22, and the oxygen detection member 25 are contained therein, the first film 41a and the second film 41b can be easily and stably joined at the second seal portion 49d.

In the liquid-containing combination container 10L thus produced, the oxygen absorber 21 of the oxygen-absorbing member 22 absorbs oxygen in the second container 40. As a result, the oxygen concentration in the second container 40 decreases. As the oxygen concentration in the second container 40 decreases, oxygen permeates the oxygen-permeable stopper 34 to move from the first container 30 to the second container 40. This result in a decrease in oxygen concentration in the first container 30 to decrease the amount of dissolved oxygen in the liquid L contained in the first container 30. In particular, the stopper 34 faces the oxygen-absorbing member 22. Therefore, the unintentional blockage of an oxygen transfer path from the inside of the first container 30 to the oxygen-absorbing member 22 through the stopper 34, for example, the adhesion of the pair of films 41a and 41b to each other, can be effectively suppressed.

The liquid-containing combination container 10L described above includes the first container 30 containing the liquid L and having oxygen permeability, the second container 40 containing the first container 30 and has the oxygen barrier property, and the oxygen-absorbing member 22 contained in the second container 40. The oxygen-absorbing member 22 includes the oxygen absorber 21 that absorbs oxygen in the second container 40. The second container 40 includes the first film 41a and the second film 41b, the first container 30 being stored between the first film 41a and the second film 41b.

The first film 41a and the second film 41b are joined at a seal portion 49 in a peelable manner. The seal portion 49 includes the first seal portion 49a positioned to face the first container 30. The first seal portion 49a is bent so as to project toward a side away from the first container 30 in the direction D1 in which the first seal portion 49a and the first container 30 face each other. In the direction D1 in which the first seal portion 49a and the first container 30 face each other, the first container 30 is located between the first seal portion 49a and the oxygen-absorbing member 22.

According to this specific example, as already described, the oxygen concentration in the first container 30 can be reduced, and the amount of dissolved oxygen in the liquid L contained in the first container 30 can be reduced. The second container 40 can be easily opened by peeling off the first film 41a and the second film 41b at the first seal portion 49a, starting from the bent first seal portion 49a.

When the second container 40 is opened, the first container 30 is located at the opening portion of the second container 40. In particular, the first container 30 is positioned in the second container 40 by the first seal portion 49a that projects toward a side away from the first container 30. Thus, when the second container 40 is opened, the first container 30 can be stably held. As a result, the first container 30 can be removed from the inside of the second container 40. That is, when the liquid L contained in the first container 30 is to be used, the first container 30 can be easily removed from the second container 40.

When the second container 40 is opened, no waste, such as a cut piece, is produced. The oxygen-absorbing member 22 and the oxygen detection member 25 are still contained in the second container 40 after the first container 30 is removed from the second container 40. Thus, the second container 40, the oxygen-absorbing member 22, and the oxygen detection member 25, which are discarded after the second container 40 is opened, can be easily handled.

From the above, the liquid-containing combination container 10L described above has the advantage of being able to reduce the oxygen concentration in the first container 30 and the amount of dissolved oxygen in the liquid L, as well as the advantage of being easy to handle during use.

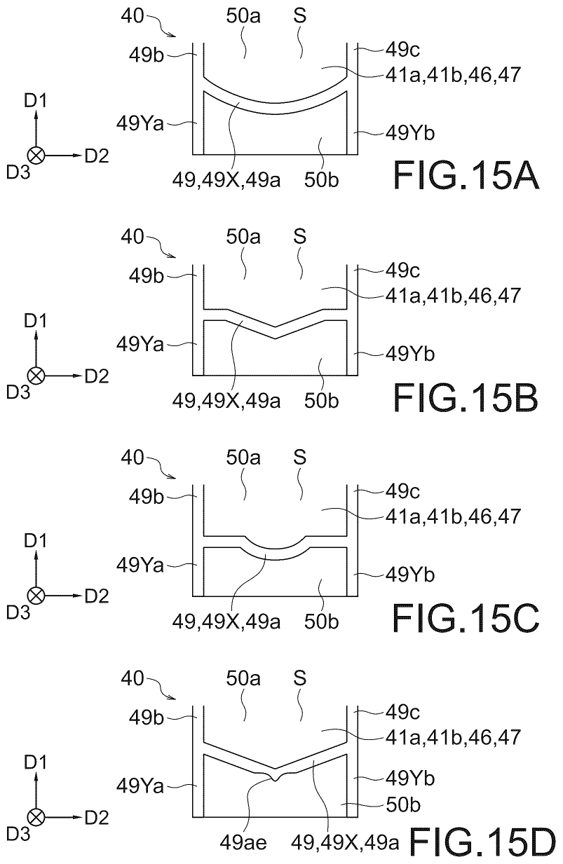

In the above-described specific example, although the first seal portion 49a is bent, the configuration of the first seal portion 49a is not limited to this example. As illustrated in FIG. 15A, the first seal portion 49a may be curved. In the example illustrated in FIG. 15A, the first seal portion 49a is curved so as to project toward a second side away from the first container 30 in the first direction. As illustrated in FIG. 15B, only a portion of the first seal portion 49a may be bent. As illustrated in FIG. 15C, only a portion of the first seal portion 49a may be curved. As in the examples illustrated in FIGS. 15B and 15C, both end portions of the first seal portion 49a may extend linearly in the second direction D2. In these examples as well, the first film 41a and the second film 41b can be easily peeled off from the first seal portion 49a as a starting point.

As illustrated in FIG. 15D, a portion of the first seal portion 49a that projects most toward the side away from the first container 30 in the first direction D1 may extend in a direction closer to the first direction D1 in the first seal portion 49a. That is, in the example illustrated in FIG. 15D, the angle formed by the outer edge 49ae of the first seal portion 49a with respect to the first direction D1 in which the first container 30 and the first seal portion 49a face each other is smallest in the portion of the first seal portion 49a that projects most toward the side away from the first container 30 in the first direction D1.

According to this example, the first film 41a and the second film 41b can be more easily peeled off from the first seal portion 49a as a starting point.

As illustrated in FIG. 10, the seal portion 49 may include a main seal portion 49X that defines the space S that stores the first container 30, and an auxiliary seal portion 49Y that joins the first film 41a and the second film 41b at the extension portions 50b. In the illustrated example, the main seal portion 49X includes the first seal portion 49a, the first side seal portion 49b, the second side seal portion 49c, and the second seal portion 49d described above. Curling of the first film 41a and the second film 41b at the extension portions 50b can be suppressed by providing the auxiliary seal portion 49Y. Thus, the extension portions 50b of the first film 41a and the second film 41b can be easily grasped by providing the auxiliary seal portion 49Y. Thus, the liquid-containing combination container 10L can be handled more easily. Furthermore, the stiffness of the second container 40 is improved at the extension portions 50b, and thus the first container 30 can be protected by the second container 40.

In the example illustrated in FIG. 10, the auxiliary seal portion 49Y includes a first auxiliary seal portion 49Ya connected to the first side seal portion 49b, and a second auxiliary seal portion 49Yb connected to the second side seal portion 49c. The first auxiliary seal portion 49Ya may extend linearly on an extension line of the first side seal portion 49b. The second auxiliary seal portion 49Yb may extend linearly on an extension line of the second side seal portion 49c. According to these examples, curling of the first film 41a and the second film 41b at the extension portions 50b can be more effectively suppressed. According to these examples, the stiffness of the second container 40 is more effectively improved at the extension portions 50b.

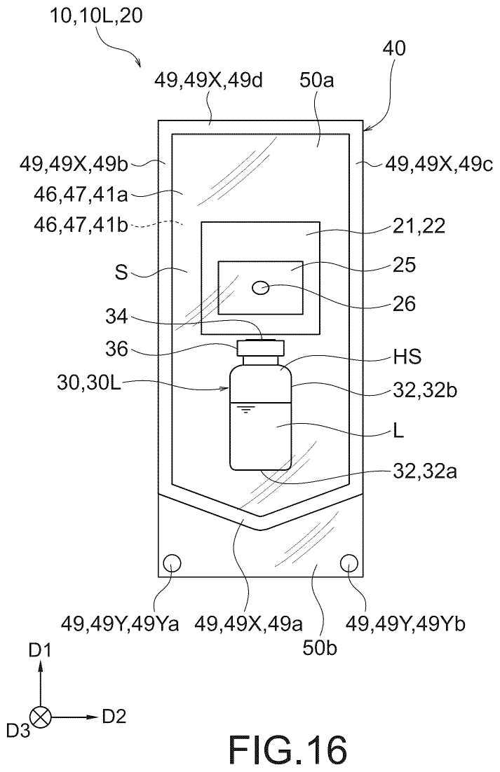

The configuration of the auxiliary seal portion 49Y is not limited to the configuration illustrated in FIG. 10 and so forth. As illustrated in FIG. 16, the auxiliary seal portion 49Y may be spaced apart from the main seal portion 49X. In the example illustrated in FIG. 16, the auxiliary seal portion 49Y includes the first auxiliary seal portion 49Ya located on the extension line of the first side seal portion 49b, and the second auxiliary seal portion 49Yb located on the extension line of the second side seal portion 49c.

The first auxiliary seal portion 49Ya and the second auxiliary seal portion 49Yb have a linear shape, a polygonal line shape, or a dot shape as illustrated in FIG. 16. In these examples as well, curling of the first film 41a and the second film 41b at the extension portions 50b can be suppressed. In these examples as well, the stiffness of the second container 40 is improved at the extension portions 50b.

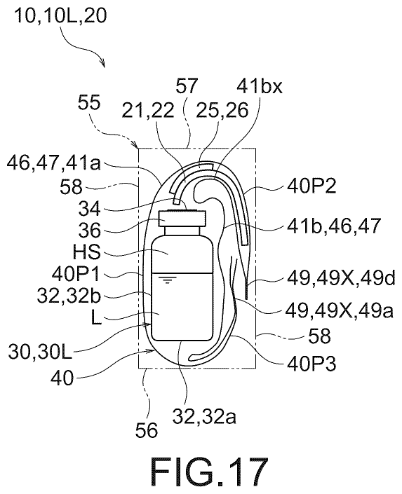

As illustrated in FIG. 17, in the liquid-containing combination container 10L, the second container 40 may be further folded. In the example illustrated in FIG. 17, the second container 40 is bent with the second film 41b inside. In FIG. 10, a first bending axis BA1 around which the second container 40 is folded is illustrated. Bending the second container 40 allows the second portion 40P2, which was located on one side (first side) of the first direction D1 with respect to the first portion 40P1 in the unfolded state of the second container 40, to face the first portion 40P1 of the second container 40 containing the first container 30 in the third direction D3. That is, the first portion 40P1 and the second portion 40P2 overlap in the third direction D3. The first portion 40P1 and the second portion 40P2 may be in contact with each other or may be separated from each other. The first portion 40P1 and the second portion 40P2 may be joined together.

The oxygen-absorbing member 22 including the oxygen absorber 21 is in sheet form. The oxygen-absorbing member 22 in sheet form is bent together with the second container 40. The intermediate portion of the bent oxygen-absorbing member 22 is located on the bend apex portion (folded apex) 41bx of the second film 41b. As illustrated in FIG. 17, the bend apex portion 41bx is the position of the bent second film 41b that projects most toward the first side in the first direction D1. The bend apex portion 41bx is the position furthest from the first container in the direction in which the stopper 34 is inserted into the container body 32.

As in the example illustrated in FIG. 17, the oxygen-absorbing member 22 in sheet form is folded together with the second film 41b, so that an oxygen transfer path connecting the first container 30 and the oxygen-absorbing member 22 can be more easily ensured. More specifically, a gap is easily formed among the oxygen-absorbing member 22, the stopper 34 of the first container 30, and the second film 41b. Since oxygen can stably move from the stopper 34 to the oxygen-absorbing member 22 through this gap, the oxygen concentration in the first container 30 and the amount of dissolved oxygen in the liquid L contained in the first container 30 can be stably reduced.

In the example illustrated in FIG. 17, the oxygen detection member 25 is located between the oxygen-absorbing member 22 and the first film 41a. The display portion 26 of the oxygen detection member 25 arranged in this manner can be easily observed through the transparent first film 41a.

Therefore, information regarding the oxygen concentration in the second container 40 can be stably obtained by observing the display portion 26 of the oxygen detection member 25.

In the example illustrated in FIG. 17, the second container 40 is bent twice with the second film 41b on the inside. In FIG. 10, in addition to the first folding axis BA1, a second folding axis BA2 around which the second container 40 is folded is illustrated. Bending at the second bending axis BA2 allows a third portion 40P3, which was located on the other side (second side) of the first direction D1 with respect to the first portion 40P1 in an unfolded state of the second container, to face the first portion 40P1 of the second container 40 containing the first container 30 in the third direction D3. That is, the first portion 40P1 and the third portion 40P3 overlap in the third direction D3. The first portion 40P1 and the third portion 40P3 may be in contact with each other or may be separated from each other.

The first portion 40P1 and the third portion 40P3 may be joined together. The second container 40 is bent around the second bending axis BA2 with the second film 41b inside. Bending the second container 40 twice allows the liquid-containing combination container 10L to be made compact.

By bending twice, the second portion 40P2 and the third portion 40P3 are located on the same side with respect to the first portion 40P1. The first film 41a in the first portion 40P1 is not covered with the second portion 40P2 and the third portion 40P3. Thus, the first container 30 can be clearly observed through the first film 41a of the second container 40. This makes it possible to easily observe the state of the first container 30 and the state of the liquid L contained in the first container 30. In addition, a label attached to the first container 30 can be easily observed. Information regarding the liquid L may be written on this label.

In the illustrated example, the first portion 40P1, the third portion 40P3, and the second portion 40P2 overlap in this order. The second portion 40P2 and the third portion 40P3 may be in contact with each other or may be separated from each other. The second portion 40P1 and the third portion 40P3 may be joined together. According to this example, the radius of curvature of the bend of the second portion 40P2 with respect to the first portion 40P1 can be increased. Thus, the oxygen transfer path connecting the first container 30 and the oxygen-absorbing member 22 can be more stably ensured.

This allows oxygen to stably move from the stopper 34 to the oxygen-absorbing member 22, so that the oxygen concentration in the first container 30 and the amount of dissolved oxygen in the liquid L contained in the first container 30 can be stably reduced.

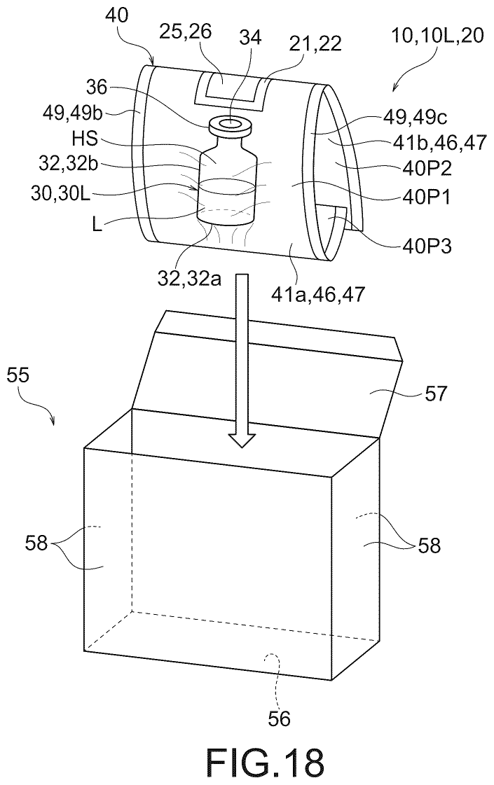

As illustrated in FIG. 18, the liquid-containing combination container 10L may further include an outer box 55 for housing the second container 40. The outer box 55 includes a bottom portion 56, a top portion 57 opposite the bottom portion 56, and a side wall portion 58 located between the bottom portion 56 and the top portion 57. As illustrated in FIG. 17, the second container 40 is bent in such a manner that the first portion 40P1, the second portion 40P2, and the third portion 40P3 overlap each other. As indicated by the dash-dot-dot line in FIG. 17, the second container containing the first container 30 may be housed in the outer box 55 in such a manner that the bottom portion 32a of the container body 32 of the first container 30 faces the bottom portion 56 of the outer box 55 and the stopper 34 of the first container 30 faces the top portion 57 of the outer box 55. According to this example, the liquid-containing combination container 10L can be stored with the bottom portion 56 positioned on a placement surface, such as a desk or shelf. At this time, the stopper 34 having oxygen permeability is separated from the liquid L and comes into contact with the gas in the headspace HS in the first container 30. Storing the liquid-containing combination container 10L in this state promotes oxygen permeation through the stopper 34, so that the oxygen concentration in the first container 30 and the amount of dissolved oxygen in the liquid L can be reduced in a short period of time after the first container 30 is placed in the second container 40.

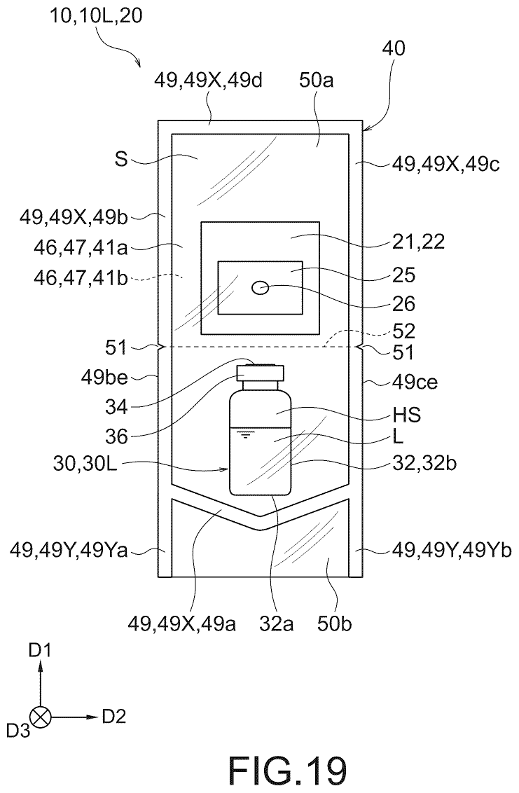

As described above, the second container 40 has the storage space S between the first side seal portion 49b and the second side seal portion 49c. As illustrated in FIG. 19, the second container 40 may include one or more notches 51 in one or both of the first side seal portion 49b and the second side seal portion 49c. Each notch 51 may be a slit or a cut. The second container 40 may be openable by cutting the first film 41a and the second film 41b with the notch 51 as a starting point. The illustrated second container 40 is easily openable with the first seal portion 49a as a starting point. However, depending on the situation, the second container 40 can be opened easily and reliably by cutting the first film 41a and the second film 41b with the notch 51 as a starting point, rather than pulling the first film 41a and the second film 41b apart at the first seal portion 49a. Thus, the liquid-containing combination container 10L can be more easily handled by forming the notches 51, each serving as a starting point for cutting the first film 41a and the second film 41b, on the outer edges 49be and 49ce of the side seal portions 49b and 49c.

As indicated by a dotted line in FIG. 19, the second container 40 may include a to-be-opened portion 52. The to-be-opened portion 52 is a portion where the films 41a and 41b will be cut when the second container 40 is opened. The to-be-opened portion 52 may be a portion connected to the notches 51. The to-be-opened portion 52 may have a configuration for enabling more reliable cutting at the to-be-opened portion 52. The to-be-opened portion 52 may be formed by the material of the first film 41a and the second film 41b, or by processing the first film 41a and the second film 41b. Specifically, the to-be-opened portion 52 may be formed by imparting anisotropy to the material of the first film 41a and the second film 41b by stretching or the like. The to-be-opened portion 52 may be formed by processing the first film 41a and the second film 41b, for example, half-cutting, laser processing, or straight cutting in which a cut is made in an intermediate layer film.

The first container 30 may be located on one side of the first film 41a and the second film 41b cut with the notch 51 as a starting point, and the oxygen-absorbing member 22 may be located on the other side of the first film 41a and the second film 41b with the notch 51 as a starting point. In other words, when the second container 40 is cut with the notch 51 as a starting point, the first container 30 may be contained on one side of the second container 40 with the cutting line as a boundary, and the oxygen-absorbing member 22 and the oxygen detection member 25 may be positioned on the other side of the second container 40. According to this example, when the second container 40 is opened, the first container 30 can be easily removed from the second container 40. This makes it possible to easily handle the liquid-containing combination container 10L. In the example illustrated in FIG. 19, the notches 51 are located between the first container 30 and the oxygen-absorbing member 22 in the first direction D1 in which the first container 30 and the oxygen-absorbing member 22 face each other. In the first direction D1 in which the first container 30 and the oxygen-absorbing member 22 face each other, the to-be-opened portion 52 is located between the first container 30 and the oxygen-absorbing member 22.

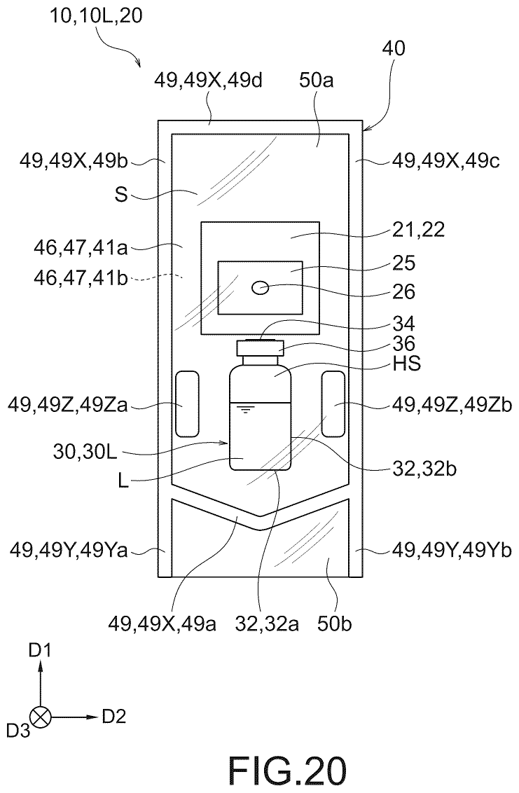

As illustrated in FIG. 20, the seal portion 49 may include the main seal portion 49X that defines the storage space S of the second container 40, and an additional seal portion 49Z that is positioned between the main seal portion 49X and the first container 30. The seal portion 49 includes the first side seal portion 49b and the second side seal portion 49c. The first container 30 is located between the first side seal portion 49b and the second side seal portion 49c in the second direction D2. The additional seal portion 49Z may be located between the first container 30 and at least one of the first side seal portion 49b and the second side seal portion 49c. In the example illustrated in FIG. 20, the additional seal portion 49Z includes a first additional seal portion 49Za located between the first side seal portion 49b and the first container 30 in the second direction D2, and a second additional seal portion 49Zb located between the second side seal portion 49c and the first container 30 in the second direction D2.

The additional seal portion 49Z is located away from the first seal portion 49a in the direction in which the first container 30 and the first seal portion 49a face each other.

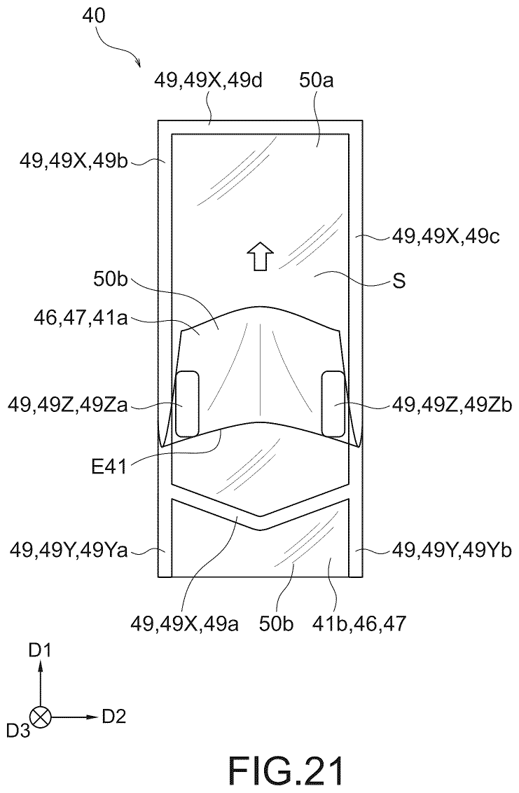

When the second container 40 is opened, first, the first film 41a and the second film 41b are peeled off at the first seal portion 49a. As illustrated in FIG. 21, the first film 41a and the second film 41b are then peeled off at the first side seal portion 49b and the second side seal portion 49c. The films 41a and 41b are peeled off at the side seal portions 49b and 49c from the end portion connected to the first seal portion 49a toward the end portion connected to the second seal portion 49d. That is, the peeling of the films 41a and 41b at the side seal portions 49b and 49c proceeds in the second direction D2, which is the longitudinal direction of the side seal portions 49b and 49c.

When the first film 41a and the second film 41b are peeled off, at least one of the first film 41a and the second film 41b is folded back so as to be separated from the other film. In the example illustrated in FIG. 21, only the first film 41a is folded back away from the second film 41b. As the peeling of the films 41a and 41b at the side seal portions 49b and 49c proceeds, the folded edge E41 of the film reaches the additional seal portion 49Z. Here, the bond strength between the first film 41a and the second film 41b is significantly high. In other words, a large force is suddenly required to peel off the first film 41a and the second film 41b. Thus, according to the additional seal portion 49Z, unintentional excessive peeling of the first film 41a and the second film 41b can be suppressed. This can suppress the sudden peeling of the first film 41a and the second film 41b at once, thus suppressing the fall of the first container 30 from the second container 40.

As illustrated in FIG. 20, in the first direction D1 in which the first seal portion 49a and the first container 30 face each other, the arrangement area of the additional seal portion 49Z and the arrangement area of the first container 30 may at least overlap. According to this example, when the first film 41a and the second film 41b are peeled off and the second container 40 is opened, the falling of the first container 30 from the second container 40 can be effectively suppressed. In addition, a change in the orientation of the first container 30 in the storage space S of the second container 40 can be suppressed. Thus, the first container 30 and the oxygen-absorbing member 22 can be maintained in a positioned state in the storage space S of the second container 40. This makes it possible to stably reduce the oxygen concentration in the first container 30 and the amount of dissolved oxygen in the liquid L.

In the first direction D1 in which the first seal portion 49a and the first container 30 face each other, the end portion of the first container 30 on a side adjacent to or near to the first seal portion 49a may be located at the same position as the end portion of the additional seal portion 49Z on a side adjacent to or near to the first seal portion 49a. As illustrated in FIG. 20, in the first direction D1, the end portion of the first container 30 on a side adjacent to or near to the first seal portion 49a may be located at a position closer to the first seal portion 49a than the end portion of the additional seal portion 49Z on a side adjacent to or near to the first seal portion 49a. According to these examples, when the folded edge E41 of the film comes into contact with the additional seal portion 49Z, the first container 30 located between the first film 41a and the second film 41b can be easily grasped. This makes it possible to easily handle the liquid-containing combination container 10L.

As illustrated in FIG. 21, the film folded edge E41 at the time of peeling off the first film 41a and the second film 41b is inclined with respect to the second direction D2 so as to be closer to the second seal portion 49d in the first direction D1 on the inner side in the second direction D2. Thus, as illustrated in FIG. 20, the additional seal portion 49Z may be spaced apart from the side seal portions 49b and 49c in the second direction D2. In other words, the additional seal portion 49Z need not be connected to the side seal portions 49b and 49c. The phrase “inner side in the second direction D2” refers to the side closer to the center of the second container 40 in the second direction D2. The phrase “outer side in the second direction D2” refers to the side further away from the center of the second container 40 in the second direction D2.

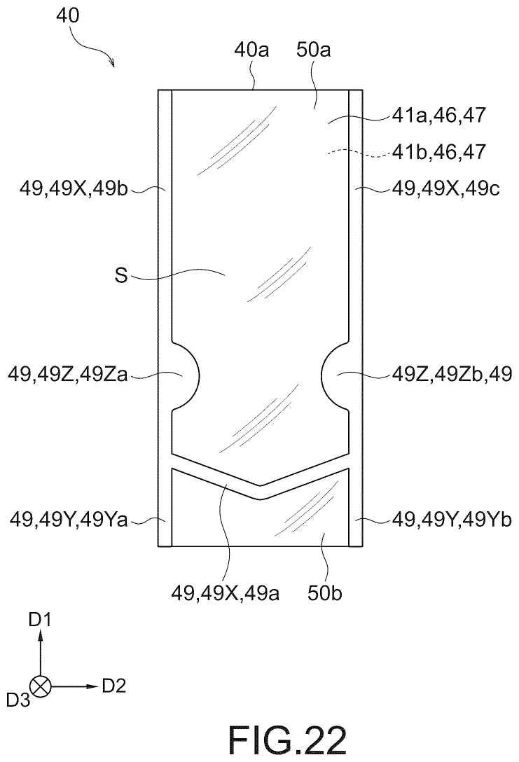

As illustrated in FIGS. 22 to 24, the additional seal portion 49Z may be connected to each of the side seal portions 49b and 49c. In the example illustrated in each of FIGS. 22 to 24, the first additional seal portion 49Za is connected to the first side seal portion 49b. The second additional seal portion 49Zb is connected to the second side seal portion 49c. The connection of the additional seal portion 49Z to each of the side seal portions 49b and 49c can more effectively suppress the unintentional excessive peeling of the first film 41a and the second film 41b.

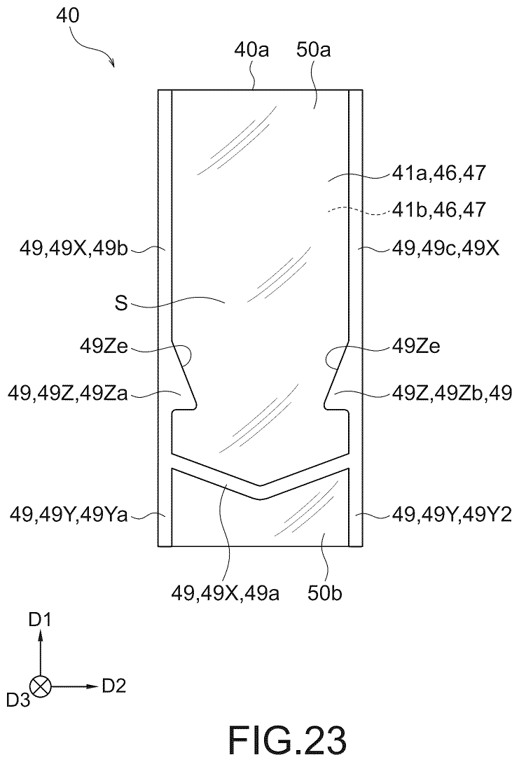

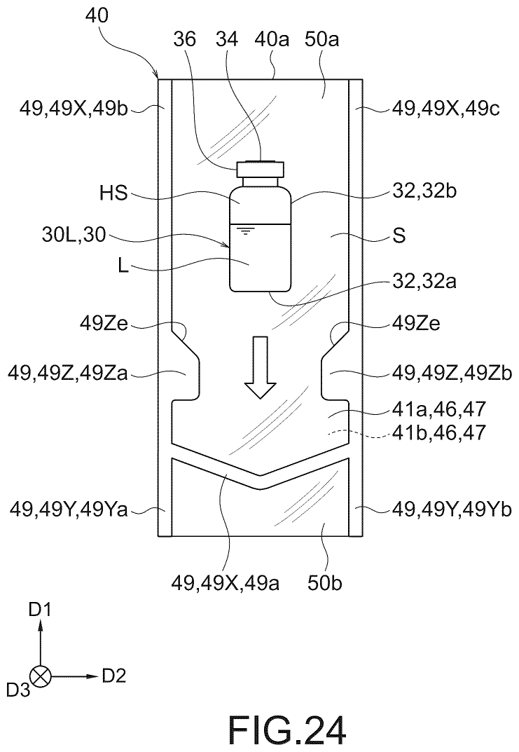

Furthermore, the shape of the additional seal portion 49Z in a plan view can also be changed in various ways. The additional seal portion 49Z may have any configuration as long as it can be reached by the film folded edge E41 when the first film 41a and the second film 41b are peeled off. In the example illustrated in FIG. 22, the additional seal portions 49Za and 49Zb have a semicircular shape when the second container 40 is unfolded flat. In the example illustrated in FIG. 23, the additional seal portions 49Za and 49Zb have a triangular shape or a triangular shape with rounded corners when the second container 40 is unfolded flat. In the example illustrated in FIG. 24, the additional seal portions 49Za and 49Zb have a trapezoidal shape or a trapezoidal shape with rounded corners when the second container 40 is unfolded flat.

As illustrated in FIGS. 23 and 24, the inner edge 49Ze of the additional seal portion 49Z facing the first container 30 may positioned further away from a corresponding one of the side seal portions 49b and 49c as the inner edge 49Ze is positioned closer to the first seal portion 49a in the first direction D1 in which the first seal portion 49a and the first container 30 face each other. In the example illustrated in each of FIGS. 23 and 24, the first additional seal portion 49Za includes the inner edge 49Ze positioned closer to the first container 30 toward the second side in the first direction D1 as the inner edge 49Ze is positioned further away from the first side seal portion 49b in the second direction D2. In the example illustrated in each of FIGS. 23 and 24, the second additional seal portion 49Zb includes the inner edge 49Ze positioned closer to the first container 30 toward the second side in the first direction D1 as the inner edge 49Ze is positioned further away from the second side seal portion 49c in the second direction D2. As illustrated in FIG. 24, the inner edge 49Ze functions as a guide to guide the first container 30 to a predetermined position when the first container 30 is inserted into the storage space S of the second container 40 through the opening 40a provided at the position of the second seal portion 49d. The inner edge 49Ze enables easy and stable positioning of the first container 30 in the storage space S of the second container 40 in a predetermined relative position with respect to the oxygen-absorbing member 22. Thus, the oxygen concentration in the first container 30 and the amount of dissolved oxygen in the liquid L can be stably reduced.

The seal strength of the seal portion 49 may be increased on the second seal portion 49d side of the first side seal portion 49b and the second side seal portion 49c. In other words, the bonding strength between the first film 41a and the second film 41b may be increased on the second seal portion 49d side of the first side seal portion 49b and the second side seal portion 49c. The processing temperature when the seal portion 49 is formed may be set to a higher temperature on the second seal portion 49d side of the side seal portions 49b and 49c. The number of times of processing when the seal portion 49 is formed may be increased on the second seal portion 49d side of the side seal portions 49b and 49c. In this example, it is easy to stop peeling of the first film 41a and the second film 41b, starting from the first seal portion 49a, in the middle of the side seal portions 49b and 49c. Thus, when the second container 40 is opened, the unintentional falling of the first container 30 from the inside of the second container 40 can be suppressed.

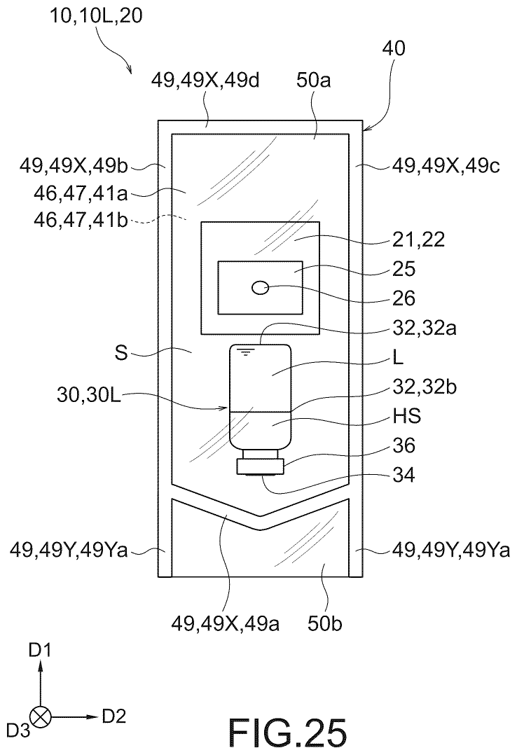

In the above-described example, the first container 30 is placed in the second container 40 in such a manner that the container body 32 faces the first seal portion 49a and the stopper 34 faces the oxygen-absorbing member 22. As illustrated in FIG. 25, the first container 30 may be placed in the second container 40 in such a manner that the stopper 34 faces the first seal portion 49a and the bottom portion 32a of the container body 32 faces the oxygen-absorbing member 22. The liquid-containing combination container 10L illustrated in FIG. 25 can also be expected to provide the following effects. That is, the first film 41a and the second film 41b can be easily peeled off at the first seal portion 49a with the bent first seal portion 49a as a starting point, and thus the second container 40 can be easily opened. Furthermore, when the second container 40 is opened, the first container 30 is located at the opening portion of the second container 40. In particular, the first container 30 is positioned in the second container 40 by the first seal portion 49a that projects toward the side away from the first container 30. Thus, when the second container 40 is opened, the first container 30 can be stably grasped. This makes it possible to remove the first container 30 from the second container 40.

That is, when the liquid L contained in the first container 30 is to be used, the first container 30 can be easily removed from the second container 40. Furthermore, when the second container 40 is opened, no waste such as scraps is generated. The oxygen-absorbing member 22 and the oxygen detection member 25 are still contained in the second container 40 after the first container 30 is removed from the second container 40. Thus, the second container 40, the oxygen-absorbing member 22, and the oxygen detection member 25, which are discarded after the second container 40 is opened, can be easily handled.

Specific examples of the laminate 47 that can be used in the second container 40 will be further described below. In the following description and in the drawings used in the following description, the same reference numerals are used for portions that can be configured in the same manner as in the above-described specific example or corresponding configurations, and redundant descriptions are omitted.

By improving the oxygen barrier property of the second container 40, the oxygen concentration (%) in the second container 40, the oxygen concentration (%) in the first container 30, and the amount of dissolved oxygen (mg/L) in the liquid L in the first container 30 can be sufficiently reduced and stably maintained in a reduced state. In addition, by improving the water vapor barrier property of the second container 40, when the liquid L in the first container 30 contains a nonaqueous solvent, an increase or decrease in the amount of water vapor in the first container 30 and the second container 40 can be suppressed. Furthermore, when the liquid L in the first container 30 contains an aqueous solvent, the concentration of the liquid L can be stably maintained. The aqueous solvent refers to a solvent in which the main component with the largest proportion by volume is water.

The laminate of, for example, films 41a to 41d included in the second container 40 includes a barrier layer having an oxygen barrier function and a water vapor barrier function. The barrier function of the laminate can be enhanced by increasing the thickness of the barrier layer included in the laminate.

However, usually, when the thickness of a barrier layer formed as a vapor-deposited film is increased, the adhesion strength between the barrier layer and an adjacent layer decreases. If the thickness of the barrier layer formed as a vapor-deposited film is increased, the barrier layer is more susceptible to cracking. For these reasons, there are limitations to the oxygen barrier properties and the water vapor barrier properties of laminates used in conventional containers. The inventors have conducted intensive studies on this issue and have created a laminate with an excellent barrier property. The laminate created by the inventors will be described below.

The laminate described below can be applied to the combination container 10 and the second container 40 included in the container set 20. More specifically, the laminate described below may include the films 41a to 41e of the second container 40, illustrated in FIGS. 1 and 7A to 7C. The laminate described below may constitute the container body 42 or the lid 44 of the second container 40 illustrated in FIG. 8. The laminate described below may constitute the films 41a and 41b of the second container 40, illustrated in FIGS. 10 to 25. Furthermore, the laminate described below is not limited to the second container 40, but can be used to containers (packages) used in a wide variety of fields, and can improve the barrier properties of the containers (packages).

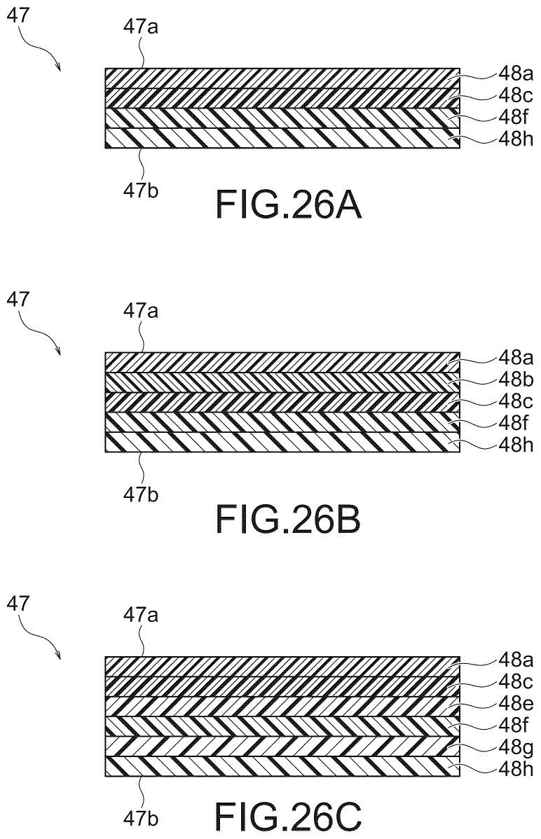

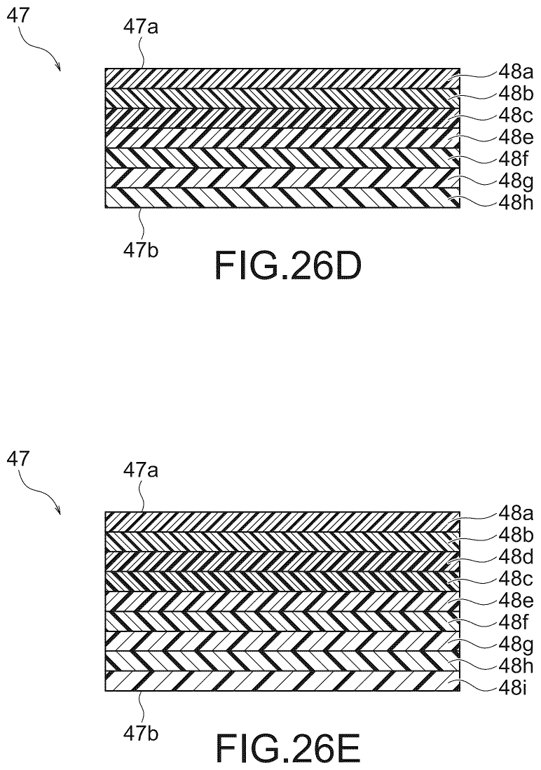

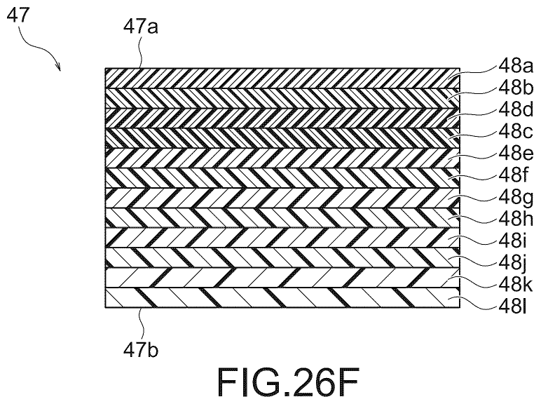

The laminate 47 includes an inner surface 47a facing the storage space S of the container, and an outer surface 47b opposite to the inner surface 47a. As illustrated in FIG. 26A, the laminate 47 may include a sealant layer 48a, a first barrier layer 48c, a resin layer 48f, and a second barrier layer 48h, in that order from the inner surface 47a toward the outer surface 47b. The laminate 47 includes two barrier layers 48c and 48h each having a barrier function. Thus, the laminate 47 has a high barrier property even if the thicknesses of the barrier layers 48c and 48h included in the laminate 47 are not increased. That is, the laminate 47 can exhibit a high barrier function while the cracking and the deterioration of the adhesion of the barrier layers 48c and 48h are suppressed.

Even if defects, such as pinholes and cracks, are formed in one of the barrier layers 48c and 48h, the laminate 47 can maintain a certain level of the barrier property due to the other of the barrier layers 48c and 48h. In particular, the resin layer 48f is disposed between the first barrier layer 48c and the second barrier layer 48h. The resin layer 48f, which functions as the substrate of the laminate 47, can suppress the formation of defects, such as pinholes and cracks, in both the first barrier layer 48c and the second barrier layer 48h.

When the laminate 47 is used for the container set 20 and the second container 40 of the combination container 10, the laminate 47 can exhibit a high oxygen barrier function and a high water vapor barrier function. By improving the oxygen barrier property of the second container 40, the oxygen concentration (%) in the second container 40, the oxygen concentration (%) in the first container 30, and the amount of dissolved oxygen in the liquid L (mg/L) can be sufficiently reduced and stably maintained in a reduced state. By improving the water vapor barrier property of the second container 40, when the liquid L in the first container 30 contains a nonaqueous solvent, an increase or decrease in the amount of water vapor in the first container 30 and the second container 40 can be suppressed. When the liquid L in the first container 30 contains an aqueous solvent, the concentration of the liquid L in the first container 30 can be stably maintained.

The generation of bubbles in the laminate 47 can be suppressed by disposing the resin layer 48f between the two barrier layers 48c and 48h. As a result, when the laminate 47 is used for the container set 20 and the second container 40 of the combination container 10, the state of the first container 30 can be observed from the outside of the second container 40. Furthermore, the oxygen concentration in the second container 40 can be measured using a non-contact-type oxygen content measurement device without opening the second container 40. Furthermore, when the container body 32 of the first container 30 is also transparent, the liquid L in the first container 30 can be observed from the outside of the second container 40. In this case, the oxygen concentration in the first container 30 can be measured using a non-contact-type oxygen content measurement device without opening the first container 30 and the second container 40. Similarly, the amount of dissolved oxygen in the liquid L in the first container 30 can be measured using a non-contact-type oxygen content measurement device without opening the first container 30 and the second container 40.

The laminate 47 may be transparent. The laminate 47 may include a transparent portion. As described above, the term “transparent” indicates that the transmission haze of the target portion is 80.0% or less so that the inside of the target portion can be observed from the outside. In order to allow the target portion to be more clearly observed from the outside, the transmission haze of at least a portion of the laminate 47 may be 58.0% or less, 29.0% or less, 14.5% or less, 7.0% or less, 3.5% or less, or 1.0% or less.

When the laminate 47 is transparent, the state of the first container 30 can be observed from the outside of the second container 40 for which the laminate 47 is used. The oxygen concentration in the second container 40 can be measured with a non-contact-type oxygen content measurement device without opening the second container 40. Furthermore, when the container body 32 of the first container 30 is also transparent, the liquid L in the first container 30 can be observed from the outside of the second container 40. In this case, the oxygen concentration in the first container 30 can be measured using a non-contact-type oxygen content measurement device without opening the first container 30 and the second container 40. Similarly, the amount of dissolved oxygen in the liquid L in the first container 30 can be measured with a non-contact-type oxygen content measurement device without opening the first container 30 and the second container 40.

The lower limit of the transmission haze of at least a portion of the laminate 47 is not particularly set. The transmission haze of at least a portion of the laminate 47 may be 0% or more, or more than 0%.

The total luminous transmittance of the whole or part or the laminate 47 may be 50% or more, 70% or more, 80% or more, or 90% or more. By setting the lower limit of the total luminous transmittance of the laminate 47, the state of the first container 30 can be clearly observed from the outside of the second container 40 for which the laminate 47 is used. The lower limit of the total luminous transmittance of the laminate 47 is not particularly set. The total luminous transmittance of the laminate 47 may be 0% or more, or more than 0%.

The laminate 47 may have a transmission haze in the above-mentioned predetermined range and a total luminous transmittance in the above-mentioned predetermined range.

The total luminous transmittance is measured using the D65 standard light source. Before measuring the total luminous transmittance, the D65 standard light source is turned on for 15 minutes to stabilize the output of the D65 standard light source. When the total luminous transmittance is measured, the incident angle on a sample is 0°. When the total luminous transmittance is measured, the test environment includes a temperature of 23 °C±2 °C and a relative humidity of 50%±5%. The sample is placed in the test environment for 16 hours before starting the test. When the total luminous transmittance is measured, other measurement conditions comply with JAS K7361-1:1997. The total luminous transmittance is the arithmetic mean value of five measured values. The five measured values are measured values measured at five measuring positions of the measurement sample to be evaluated.

The yellowness index (YI value) of whole or part of the laminate 47 may be 20 or less, 15 or less, 13 or less, or 10 or less. When the value is 20 or less, the color inside the package is easier to check, and the degree of discrimination of an indicator that is distinguished by color, such as Ageless-Eye, is improved. The yellowness index is an index indicating the degree of yellowish coloration of the laminate 47. The laminate 47 exhibits a high barrier property due to the two barrier layers. The use of two barrier layers, as compared to using one thick barrier layer, reduces the yellowness index of the laminate 47 to lower than or equal to the upper limit described above.

The yellowish coloring of the laminate 47 can be limited by setting the above upper limit for the yellowness index (YI value). By setting the above upper limit of the yellowness index (YI value), the state of the first container 30 can be clearly observed from the outside of the second container 40 for which the laminate 47 is used.

The lower limit of the yellowness index (YI value) of the laminate 47 is not particularly set. The yellowness index (YI value) of the laminate 47 may be 0 or more, or may be more than 0.

The yellowness index is measured using transmitted light. Tristimulus values X, Y, and Z in the XYZ color system were determined on the basis of transmittances measured by spectrophotometric colorimetry at 0.5 nm intervals in the range of 300 nm or more and 780 nm or less using supplementary illuminant C and a 2-degree field of view. The yellowness index (YI value) is calculated from the determined X, Y, and Z values using the following formula.

YI=100(1.2769X−1.0592Z)/Y

As the geometrical optical condition for measuring the yellowness index, the geometric optical condition e of JIS Z 8722:2009 is used. In order to eliminate the effect of stray light from the edges of a test piece, the diameter of a light beam incident on the test piece is made smaller than the diameter of the aperture. Before measuring the yellowness index, the light source of the measurement device is turned on for 15 minutes to stabilize the output of the D65 standard light source. The incident surface when measuring the yellowness index is the inner surface 47a of the laminate 47. The test environment for measuring the yellowness index is a temperature of 23 °C±2 °C and a relative humidity of 50%±5%. The sample is placed in the test environment for 16 hours before starting the test.

The yellowness index (YI value) is the arithmetic mean value of five measured values. The five measured values are measured values measured at five measuring positions of an optical sheet to be evaluated. The five measurement positions are located 10 mm or more apart from each other. When the yellowness index (YI value) is measured, other measurement conditions comply with JAS K7373-1:2006.

The laminate 47 may have one or more of the transmission haze in the above-described predetermined range and the total luminous transmittance in the above-described predetermined range, and may also have the yellowness index in the above-described predetermined range.

The oxygen transmission rate of the laminate 47 may be less than 0.20 (mL/(m²×day×atm)), 0.15 (mL/(m²×day×atm)) or less, or 0.14 (mL/(m²×day×atm)) or less. In the case of the oxygen transmission rate having such an upper limit, an extremely high oxygen barrier property is imparted to the second container 40, and the oxygen concentration (%) in the first container 30 and the amount of dissolved oxygen in the liquid L (mg/L) can be effectively and sufficiently reduced and can be stably maintained in a reduced state. The lower limit of the oxygen transmission rate permeability of the laminate 47 is not particularly set. The oxygen transmission rate of the laminate 47 may be more than or equal to 0 (mL/(m²×day×atm)), or more than 0 (mL/(m²×day×atm)).

The oxygen transmission rate of the laminate 47 may be 0 (mL/(m²×day×atm)) or more and less than 0.20 (mL/(m²×day×atm)), 0 (mL/(m²×day×atm)) or more and 0.15 (mL/(m²×day×atm)) or less, or 0 (mL/(m²×day×atm)) or more and 0.14 (mL/(m²×day×atm)) or less. The oxygen transmission rate of the laminate 47 may be more than 0 (mL/(m²×day×atm)) and less than 0.20 (mL/(m²×day×atm)), more than 0 (mL/(m²×day×atm)) and 0.15 (mL/(m²×day×atm)) or less, or more than 0 (mL/(m²×day×atm)) and 0.14 (mL/(m²×day×atm)) or less.

The water vapor transmission rate of the laminate 47 may be 0.50 (g/(m²×day)) or less, 0.30 (g/(m²×day)) or less, or 0.20 (g/(m²×day)) or less. In the case of the water vapor transmission rate having such an upper limit, an extremely high water vapor barrier property can be imparted to the second container 40. The permeation of water vapor in the second container 40 to the outside is suppressed; hence, the amount of evaporation of the liquid L can be suppressed, so that the change in concentration can be suppressed. The lower limit of the water vapor transmission rate of the laminate 47 is not particularly set. The water vapor transmission rate of the laminate 47 may be 0 (g/(m²×day)) or more, or more than 0 (g/(m²×day)).

The water vapor transmission rate of the laminate 47 may be 0 (g/(m²×day)) or more and 0.50 (g/(m²×day)) or less, or 0 (g/(m²×day)) or more and 0.30 (g/(m²×day)) or less, or 0 (g/(m²×day)) or more and 0.20 (g/(m²×day)) or less. The water vapor transmission rate of the laminate 47 may be more than 0 (g/(m²×day)) and 0.50 (g/(m²×day)) or less, more than 0 (g/(m²×day)) and 0.30 (g/(m²×day)) or less, or more than 0 (g/(m²×day)) and 0.20 (g/(m²×day)) or less.

The water vapor transmission rate is measured in accordance with JIS K 7129-2:2019. The water vapor transmission rate is measured with a PERMATRAN (3/33) transmission rate measurement device manufactured by MOCON Inc., USA in an environment of a temperature of 40 °C and a humidity of 90% RH.

The resin layer 48f functions as a resin substrate for the laminate 47 as a whole. The resin layer 48f may be a stretched film. The resin layer 48f may contain a thermoplastic resin as a main component.

The term “main component” refers to a component having the largest proportion by mass. A lower limit may be set for the thickness of the resin layer 48f. The thickness of each of the resin layer 48f may be 5 μm or more and 60 μm or less, or 7 μm or more and 30 μm or less. The resin layer 48f can function as resin substrates for the laminate 47 as a whole.

The resin layer 48f may be a substrate that supports at least one of the first barrier layer 48c and a first film substrate for barrier layer 48d.

The resin layer 48f, which functions as a resin substrate, imparts the mechanical properties required for the laminate 47, such as strength, hardness, Young's modulus, flexural rigidity, and the like.

The material of the resin layer 48f that functions as the resin substrate may be a polyamide, a polypropylene, or a polyethylene terephthalate.

As a specific example, the resin layer 48f may be made of stretched polyamide or stretched polyester. The stretched polyamide may be uniaxially stretched polyamide or biaxially stretched polyamide. Either uniaxially stretched nylon or biaxially stretched nylon may be used. The stretched polyester may be uniaxially stretched polyester, biaxially stretched polyester, uniaxially stretched polyethylene terephthalate, or biaxially stretched polyethylene terephthalate.

Stretched polyamide and stretched nylon have excellent puncture resistance, wear resistance, and flexural resistance. Thus, defects, such as pinholes and cracks, in the laminate 47 can be less likely to be formed by using stretched polyamide or stretched nylon for the resin layer 48f. The use of stretched polyamide or stretched nylon for the resin layer 48f allows the thickness of the laminate 47 to be reduced while the strength of the laminate 47 is maintained. In the case of using the resin layer 48f containing stretched polyamide or stretched nylon, even if defects, such as pinholes and cracks, are formed in one of the barrier layers 48c and 48h, the formation of the defects in the other of the barrier layers 48c and 48h can be suppressed. In this regard, stretched polyamide and stretched nylon are highly suitable for the resin layer 48f disposed between the two barrier layers 48c and 48h.

As illustrated in FIG. 26B, the laminate 47 may include an inner adhesive layer 48b positioned between the sealant layer 48a and the first barrier layer 48c. The inner adhesive layer 48b may be adjacent to the sealant layer 48a and the first barrier layer 48c. The inner adhesive layer 48b may be joined to the sealant layer 48a and the first barrier layer 48c. Alternatively, only a layer that is impermeable to water vapor, for example a polyethylene terephthalate layer (PET layer) having a thickness of 9 μm or more and 16 μm or less, may be located between the inner adhesive layer 48b and the first barrier layer 48c. According to this example, a change in the concentration of water vapor in the container can be sufficiently suppressed.

As illustrated in FIGS. 26C and 26D, the laminate 47 may further include a first adhesive layer 48e located between the first barrier layer 48c and the resin layer 48f, and a second adhesive layer 48g located between the resin layer 48f and the second barrier layer 48h. The first adhesive layer 48e may include a cured product of a curable resin composition. The second adhesive layer 48g may include a cured product of a curable resin composition. FIG. 26C illustrates a laminate with the adhesive layers 48e and 48g added to the laminate illustrated in FIG. 26A. FIG. 26D illustrates a laminate with the adhesive layers 48e and 48g added to the laminate illustrated in FIG. 26B.

During the curing treatment of the curable resin composition, bubbles may be generated to a small extent. The bubbles may contain, for example, carbon dioxide or water vapor. The generated bubbles cannot penetrate the barrier layers 48c and 48h.

On the other hand, the resin layer 48f is made of, for example, polyamide such as nylon, polypropylene, or polyethylene terephthalate, and has gas permeability. Bubbles generated from the first adhesive layer 48e can pass through one main surface (main surface on the inner surface 47a side) of the resin layer 48f, can proceed through the resin layer 48f, and then can be released to the outside of the container from the side end surface of the resin layer 48f. Bubbles generated from the second adhesive layer 48g can pass through the other main surface (main surface on the outer surface 47b side) of the resin layer 48f, can proceed through the resin layer 48f, and then can be released to the outside of the container from the side end surface of the resin layer 48f. That is, the resin layer 48f constitutes a permeation path for releasing bubbles generated during the curing treatment of the adhesive layers 48e and 48g.

The resin layer 48f is located between the first barrier layer 48c and the second barrier layer 48h. Thus, one of the first barrier layer 48c and the second barrier layer 48h can be bonded to the resin layer 48f with the adhesive layer, and then the other of the first barrier layer 48c and the second barrier layer 48h can be bonded to the resin layer 48f with the adhesive layer. The resin layer 48f having one surface that has been bonded to one of the barrier layers with the adhesive layer can expose the other surface. Thus, bubbles generated in the adhesive layer can be quickly removed by the penetration of the bubbles through the resin layer 48f. At this time, aging under appropriate conditions can promote the removal of bubbles.

This makes it possible to suppress bubbles from being trapped within the high-barrier laminate 47 including the two barrier layers. The clouding of the high-barrier laminate 47 containing the two barrier layers can be suppressed. Furthermore, the visible light transmittance of the laminate 47 is maintained high, and the first container 30 and the liquid L can be clearly observed from the outside of the second container 40. In addition, the oxygen concentration in the second container 40, the oxygen concentration in the first container 30, and the amount of dissolved oxygen in the liquid L in the first container 30 can be measured with high accuracy from the outside of the second container 40.

From the viewpoint of suppressing the generation of bubbles in the laminate 47, the resin layer 48f may contain polyester, such as polyethylene terephthalate. The resin layer 48f may contain polyester, such as polyethylene terephthalate, as a main component. The term “main component” refers to a component having the largest proportion by mass. The resin layer 48f may include a polyester film made of, for example, polyethylene terephthalate. The polyester film may be a uniaxially stretched polyester film, a biaxially stretched polyester film, or a stretched polyester film. The film may be a uniaxially stretched nylon film or a biaxially stretched nylon film.

From the viewpoint of increasing the puncture resistance of the laminate 47, the resin layer 48f may contain polyamide, such as nylon. The resin layer 48f may contain polyamide, such as nylon, as a main component. The term “main component” refers to a component having the largest proportion by mass. The resin layer 48f may include a polyamide film made of, for example, nylon. The polyamide film may be a uniaxially stretched polyamide film, a biaxially stretched polyamide film, or a stretched polyamide film. The film may be a uniaxially stretched nylon film or a biaxially stretched nylon film.

As illustrated in FIG. 26E, the laminate 47 may include the first film substrate for barrier layer 48d adjacent to the first barrier layer 48c. The laminate 47 may include a second film substrate for barrier layer 48i adjacent to the second barrier layer 48h. The first film substrate for barrier layer 48d may be a resin substrate that supports the first barrier layer 48c. The second film substrate for barrier layer 48i may be a resin substrate that supports the second barrier layer 48h.

In the illustrated example, the first film substrate for barrier layer 48d is located between first barrier layer 48c and inner adhesive layer 48b. With this arrangement, the first barrier 48c does not come into direct contact with the sealant layer 48a, which is prone to dimensional changes and deformations. The presence of the first film substrate for barrier layer 48d can reduce the influence of dimensional changes and deformations of the sealant layer 48a on the first barrier layer 48c. This can suppress the formation of defects, such as cracks and pinholes, in the first barrier layer 48c.

In the illustrated example, the second barrier layer 48h is located between the resin layer 48f and the second film substrate for barrier layer 48i. The second barrier layer 48h is located between the second adhesive layer 48g and the second film substrate for barrier layer 48i. That is, the second film substrate for barrier layer 48i may be closer to the outer surface 47b than the second barrier layer 48h, or may even constitute the outer surface 47b. With this arrangement, the second film substrate for barrier layer 48i is subjected to an external force due to contact with the outside or an external impact earlier than the second barrier layer 48h. The external force and impact received by the second barrier layer 48h are weakened by the second film substrate for barrier layer 48i. This can suppress the formation of defects, such as cracks and pinholes, in the second barrier layer 48h.

As illustrated in FIG. 26F, the laminate 47 may include three or more barrier layers. In the example illustrated in FIG. 26F, the laminate 47 further includes a second resin layer 48j and a third barrier layer 48k. In the case of a laminate including three or more barrier layers, the oxygen barrier property and the water vapor barrier property of the laminate 47 can be further improved. In FIG. 26F, the second resin layer 48j and the third barrier layer 48k are added to the laminate illustrated in FIG. 26E. The laminate 47 illustrated in FIG. 26F includes a third film substrate for barrier layer 48l. The third film substrate for barrier layer 48l constitutes the outer surface 47b. The third film substrate for barrier layer 48l may be a resin substrate that supports the third barrier layer 48k.

A third adhesive layer may be provided between the second resin layer 48j and the second film substrate for barrier layer 48i. A fourth adhesive layer may be provided between the second resin layer 48j and the third barrier layer 48k. The third adhesive layer and the fourth adhesive layer may be configured in the same manner as in the adhesive layers 48e and 48g.

Similarly, in the example illustrated in FIG. 26F, the first film substrate for barrier layer 48d may be located between the first barrier layer 48c and the inner adhesive layer 48b, for the reasons discussed above. Similarly, in the example illustrated in FIG. 26F, for the reasons described above, the second barrier layer 48h may be located between the resin layer 48f and the second film substrate for barrier layer 48i, or may be located between the second adhesive layer 48g and the second film substrate for barrier layer 48i.

In the example illustrated in FIG. 26F, the third barrier layer 48k may be located between the second resin layer 48j and the third film substrate for barrier layer 48l. The third barrier layer 48k may be located between the fourth adhesive layer and the third film substrate for barrier layer 48l. That is, the third film substrate for barrier layer 48l may be closer to the outer surface 47b than the third barrier layer 48k, or may even constitute the outer surface 47b. With this arrangement, the third film substrate for barrier layer 48l is subjected to an external force or impact due to contact with the outside earlier than the third barrier layer 48k. Thus, the external force and impact received by the third barrier layer 48k are weakened by the third film substrate for barrier layer 48l. This can suppress the formation of defects, such as cracks and pinholes, in the third barrier layer 48k.

Each layer that may be included in the laminate 47 will be described in further detail below.

The barrier layers 48c, 48h, and 48k may contain a metal or an inorganic oxide. The barrier layers may be formed by a chemical vapor deposition method (CVD method) or a physical vapor deposition method (PVD method). The barrier layers may be vapor-deposited layers. The barrier layers may include a vapor-deposited layer. The vapor-deposited layer is a layer produced by vapor deposition.

The vapor-deposited layer may contain a metal or an inorganic oxide. When a vapor-deposited layer is used, a thin barrier layer with an excellent barrier property can be obtained. The barrier layer may be a transparent vapor-deposited layer. The barrier layers may include a transparent vapor-deposited layer.

A transparent vapor-deposited layer is a transparent layer produced by vapor deposition. The barrier layers 48c, 48h, and 48k as transparent vapor-deposited layers allow the laminate 47 including the thin barrier layers with high barrier properties to be transparent, together with the other layers. The use of the transparent laminate 47 for the second container 40 enables observation of the first container 30 from the outside of the second container 40.

The metal contained in the barrier layers 48c, 48h, and 48k is not particularly limited. Examples of the metal include aluminum, tin, chromium, zinc, gold, silver, platinum, and nickel. Each of the barrier layers 48c, 48h, and 48k may contain two or more of these metals.

The inorganic oxide contained in the barrier layers 48c, 48h, and 48k is not particularly limited.

Examples of the inorganic oxide include oxides of silicon, aluminum, magnesium, calcium, potassium, tin, sodium, boron, titanium, lead, zirconium, and yttrium. Each of the barrier layers 48c, 48h, and 48k may contain two or more of these inorganic oxides. As a specific example, the inorganic oxide contained in the barrier layers 48c, 48h, and 48k may be aluminum oxide or silicon oxide. The inorganic oxide is represented by MOX, such as AlOX and SiOX. In the above formula, “M” represents an inorganic element. From the viewpoints of transparency and the gas barrier property, when M is aluminum (Al), the value of X may be 0.5 or more and 2.0 or less. When M is silicon (Si), the value of X may be 1 or more and 2 or less.

The thickness of each of the barrier layers 48c, 48h, and 48k may be 1 nm or more and 1.0 μm or less, 3 nm or more and 100 nm or less, 5 nm or more and 80 nm or less, or 8 nm or more and 50 nm or less.

The barrier layers 48c, 48h, and 48k may include multiple layers. The multiple layers may include base barrier layers formed by a chemical vapor deposition method (CVD method) or a physical vapor deposition method (PVD method). The base barrier layers may include a metal or an inorganic oxide. The base barrier layers may be vapor-deposited layers. The base barrier layers may be vapor-deposited layers with transparency, i.e., transparent vapor-deposited layers. The vapor-deposited layers are layers produced by vapor deposition. The vapor-deposited layers may contain a metal or an inorganic oxide.

Each of the barrier layers 48c, 48h, and 48k may include the base barrier layer and an overlayer in that order from the side of a corresponding one of the film substrate for barrier layers 48d, 48i, and 48l. Each of the barrier layers 48c, 48h, and 48k may include a first base barrier layer, an overlayer, and a second base barrier layer in that order from the side of a corresponding one of the film substrate for barrier layers 48d, 48i, and 48l. Each of the barrier layers 48c, 48h, and 48k may include the first base barrier layer, a first overlayer, the second base barrier layer, and a second overlayer in order from the side of a corresponding one of the film substrate for barrier layers 48d, 48i, and 48l.

The base barrier layer or the first base barrier layer may be formed directly on one surface of the corresponding film substrate for barrier layer 48d, 48i, or 48l by, for example, a chemical vapor deposition method (CVD method) or a physical vapor deposition method (PVD method). The base barrier layer or the first base barrier layer may be in contact with the film substrate for barrier layer 48d, 48i, or 48l. The second base barrier layer may be formed directly on the first overlayer. The second base barrier layer may be in contact with the first overlayer.

The overlayer, the first overlayer, or the second overlayer covers and protects any of the barrier layers. The overlayer, the first overlayer, or the second overlayer may cover the entire barrier layer to be protected. The overlayer or the first overlayer may be formed directly on the first base barrier layer. The overlayer or the first overlayer may be in contact with the first base barrier layer. The second overlayer may be formed directly on the second base barrier layer. The second overlayer may be in contact with the second base barrier layer.

The overlayer, the first overlayer, and the second overlayer may be coating films (coating layers). The overlayer, the first overlayer, and the second overlayer may be coatings of a resin composition. The overlayer, first overlayer, and second overlayer may be formed by solidifying or curing a coating film provided onto the barrier layer to be protected.

The overlayer, the first overlayer, and the second overlayer may contain a cured product of a curable resin composition. The curable resin composition may be a two-component curable resin composition, a thermosetting resin composition, or an ionizing radiation-curable resin composition. The ionizing radiation-curable resin composition may be an electron beam-curable resin composition or an ultraviolet ray-curable resin composition. The overlayer, the first overlayer, and the second overlayer may contain the same resin material as the resin material constituting the adhesive layers 48e and 48g.

The overlayer, the first overlayer, and the second overlayer may contain the same resin material as the resin material constituting the resin layers 48f and 48j. The same resin material as a resin material constituting the film substrate for barrier layers 48d, 48i, and 48l may be contained.

A material constituting the overlayer, the first overlayer, and the second overlayer may contain an alkoxide. As an alkoxide represented by nM(OR2)m, at least one of a partial hydrolysate of an alkoxide and a hydrolytic condensation product of an alkoxide can be used. The partial hydrolysate of the alkoxide is not limited to a partial hydrolysate in which all of the alkoxy groups are hydrolyzed, but may be a partial hydrolysate in which one or more alkoxy groups are hydrolyzed, or a mixture thereof; and furthermore, as the hydrolytic condensation product, a dimer or higher oligomer of the partially hydrolyzed alkoxide, specifically a dimer to a hexamer, may be used.

The overlayer, the first overlayer, and the second overlayer may be formed using a coating agent containing a polyvinyl alcohol-based resin and a silane compound. If necessary, an acid catalyst, an alkali catalyst, a photoinitiator, and so forth may be added to the coating agent.

Each of the thickness of the barrier layers 48c, 48h, and 48k including multiple layers may be 20 nm or more and 20 μm or less, 10 nm or more and 10 μm or less, 50 nm or more and 5.0 μm or less, or 100 nm or more and 1.0 μm or less.

The thickness of each of the base barrier layer, the first base barrier layer, and the second base barrier layer may be 1 nm or more and 1,000 nm or less, 3 nm or more and 500 nm or less, 5 nm or more and 500 nm or less, 5 nm or more and 300 nm or less, 8 nm or more and 100 nm or less, or 8 nm or more and 50 nm or less. The thickness of each of the overlayer, the first overlayer, and the second overlayer may be 10 nm or more and 10 μm or less, 50 nm or more and 5.0 μm or less, 100 nm or more and 1.0 μm or less, or 100 nm or more and less than 1.0 μm.

The first barrier layer 48c, the second barrier layer 48h, and the third barrier layer 48k may have the same configuration. The first barrier layer 48c, the second barrier layer 48h, and the third barrier layer 48k may have different configurations. The first barrier layer 48c, the second barrier layer 48h, and the third barrier layer 48k may contain different materials. The first barrier layer 48c, the second barrier layer 48h, and the third barrier layer 48k may be formed by different film formation methods.

The first barrier layer 48c, the second barrier layer 48h, and the third barrier layer 48k may have different thicknesses.

The film substrate for barrier layers 48d, 48i, and 48l serve as substrates when the barrier layers 48c, 48h, and 48k are formed as vapor-deposited layers. The film substrate for barrier layers 48d, 48i, and 48l are not particularly limited. The film substrate for barrier layers 48d, 48i, and 48l may be resin films. Examples of a resin material constituting the film substrate for barrier layers 48d, 48i, and 48l as resin films include polyolefins, such as polyethylene and polypropylene, cyclic polyolefins, polystyrene, acrylonitrile-styrene copolymers (AS), acrylonitrile-butadiene-styrene copolymers (ABS), (meth)acrylic resins, polycarbonates, polyvinyl alcohols, saponified ethylene-vinyl ester copolymers, polyesters, such as polyethylene terephthalate and polyethylene naphthalate, polyamides, such as nylon, polyurethanes, acetal resins, and cellulose resins. The film substrate for barrier layers 48d, 48i, and 48l may be laminated films using two or more types of films made of these resin materials. The term “(meth)acrylic” includes both “acrylic” and “methacrylic”.

The film substrate for barrier layers 48d, 48i, and 48l preferably have a high water vapor barrier property, a high gas barrier property, and a high oxygen barrier property. The material of the film substrate for barrier layers 48d, 48i, and 48l can preferably reduce the amount of deformation, such as shrinkage, during vapor deposition. From these viewpoints, the film substrate for barrier layers 48d, 48i, and 48l may contain polyethylene terephthalate, may contain polyethylene terephthalate as a main component, or may be a polyethylene terephthalate film.

The film substrate for barrier layers 48d, 48i, and 48l may be unstretched films, uniaxially stretched films, or biaxially stretched films. The term “unstretched film” includes not only a film that is not stretched at all, but also a film that is slightly stretched due to the tension applied during film formation.

The thickness of each of the film substrate for barrier layers 48d, 48i, and 48l may be 6 μm or more and 2,000 μm or less, or 9 μm or more and 100 μm or less.

The first film substrate for barrier layer 48d, the second film substrate for barrier layer 48i, and the third film substrate for barrier layer 48l may have the same configuration. The first film substrate for barrier layer 48d, the second film substrate for barrier layer 48i, and the third film substrate for barrier layer 48l may have different configurations. The first film substrate for barrier layer 48d, the second film substrate for barrier layer 48i, and the third film substrate for barrier layer 48l may contain different materials. The first film substrate for barrier layer 48d, the second film substrate for barrier layer 48i, and the third film substrate for barrier layer 48l may have different thicknesses.

The resin layers 48f and 48j serve to hold the layers included in the laminate 47. Each of the resin layers 48f and 48j is located between two corresponding layers of the barrier layers 48c, 48h, and 48k. Each of the resin layers 48f and 48j is located between the two corresponding layers of the barrier layers 48c, 48h, and 48k, and thus can effectively suppress the two corresponding layers of the barrier layers 48c, 48h, and 48k from being curved with a small radius of curvature. This can suppress the formation of defects, such as cracks, in the two corresponding layers of the barrier layers 48c, 48h, and 48k. The flexibility and stiffness of the laminate 47 can be easily adjusted by the resin layers 48f and 48j.

The resin layers 48f and 48j can suppress the clouding of the laminate 47 caused by bubbles generated during curing of the adhesive layer, as described above.

The resin layers 48f and 48j are not particularly limited. The resin layers 48f and 48j may be resin films. Examples of a resin material constituting the resin layers 48f and 48j as a resin film include polyesters (chemically recycled polyester, mechanically recycled polyester, fossil fuel polyester, and biomass polyester), (meth)acrylic resins, polyolefins, such as polyethylene, polypropylene, and polymethylpentene, vinyl resins, cellulose resins, ionomer resins, and polyamides, such as nylon 6, nylon 6,6, and polymetaxylylene adipamide (MXD6). Each of the resin layers 48f and 48j may be a laminated film using two or more types of films of these resin materials.

The resin layers 48f and 48j may be unstretched films or stretched films. The resin layers 48f and 48j may be uniaxially stretched films or biaxially stretched films. When the resin layers 48f and 48j are stretched films, sufficient mechanical properties can be imparted to the laminate 47.

The resin layers 48f and 48j may contain a thermoplastic resin. The resin layers 48f and 48j may contain a thermoplastic resin as a main component. The resin layers 48f and 48j may be thermoplastic resin films. The resin layers 48f and 48j containing a thermoplastic resin can promote the removal of bubbles and impart a low transmission haze and a high total luminous transmittance.

The thickness of each of the resin layers 48f and 48j may be 5 μm or more and 60 μm or less, or 7 μm or more and 30 μm or less. By setting the lower limit of the thickness of the resin layers 48f and 48j, serving as resin substrates for the entire laminate 47, can impart sufficient mechanical properties to the laminate 47. By setting the upper limit of the thickness of the resin layers 48f and 48j, appropriate flexibility can be imparted to the laminate 47 used for the second container 40. The setting of the upper limit of the thickness of the resin layers 48f and 48j can promote the removal of bubbles to provide a low transmission haze and a high total luminous transmittance.

The resin layer 48f and the second resin layer 48j may have the same configuration. The resin layer 48f and the second resin layer 48j may have different configurations. The resin layer 48f and the second resin layer 48j may contain different materials. The resin layer 48f and the second resin layer 48j may have different thicknesses.

Each of the adhesive layers 48e and 48g is a layer that joins the two layers together. Each of the adhesive layers 48e and 48g may include a cured product of a curable resin composition. The curable resin composition may be a two-component curable resin composition, a thermosetting resin composition, or an ionizing radiation-curable resin composition. The ionizing radiation-curable resin composition may be an electron beam-curable resin composition or an ultraviolet ray-curable resin composition. An adhesive used for the adhesive layers 48e and 48g may be a one-component or two-component curable adhesive for lamination, such as a vinyl-based, (meth)acrylic-based, polyamide-based, polyester-based, polyether-based, polyurethane-based, epoxy-based, or rubber-based adhesive. Specific examples of a material used for the adhesive layers 48e and 48g include a two-component curable polyurethane-based adhesive including an isocyanate compound or the like serving as a curing agent; and a polyester-based adhesive.

The thickness of each of the adhesive layers 48e and 48g may be 0.1 μm or more and 20 μm or less, 0.1 μm or more and 10 μm or less, 0.1 μm or more and 4.0 μm or less, 0.1 μm or more and 3.0 μm or less, 0.5 μm or more and 3.0 μm or less, 1.0 μm or more and 2.5 μm or less, or 1.0 μm or more and 2.0 μm or less.

The first adhesive layer 48e, the second adhesive layer 48g, the third adhesive layer, and the fourth adhesive layer may have the same configuration. The first adhesive layer 48e, the second adhesive layer 48g, the third adhesive layer, and the fourth adhesive layer may have different configurations. The first adhesive layer 48e, the second adhesive layer 48g, the third adhesive layer, and the fourth adhesive layer may contain different materials. The first adhesive layer 48e, the second adhesive layer 48g, the third adhesive layer, and the fourth adhesive layer may have different thicknesses.

The sealant layer 48a has heat sealability. The sealant layer 48a is not particularly limited, and the sealant layer 48a may be a resin film. The material of the sealant layer 48a may be a thermoplastic resin. The thermoplastic resin constituting the sealant layer 48a may be polyolefin. Examples of the thermoplastic resin constituting the sealant layer 48a include low-density polyethylene, medium-density polyethylene, high-density polyethylene, chain-like (linear) low-density polyethylene, ethylene-α-olefin copolymers polymerized in the presence of a metallocene catalyst, and ethylene-propylene copolymers, such as random or block copolymers of ethylene and propylene.

The sealant layer 48a may be formed by melt extrusion of the above-described resin material.

The sealant layer 48a may be formed on the first barrier layer 48c. In this example, the inner adhesive layer 48b may be omitted.

The thickness of the sealant layer 48a may be 10 μm or more and 300 μm or less, or may be 20 μm or more and 100 μm or less.

The inner adhesive layer 48b joins the sealant layer 48a and the first barrier layer 48c. The inner adhesive layer 48b may have the same configuration as the adhesive layers 48e and 48g described above. The inner adhesive layer 48b may include a cured product of a curable resin composition. The inner adhesive layer 48b may be formed between the sealant layer 48a and the first barrier layer 48c by melt extrusion of a resin material. The resin material used in the melt extrusion may be selected from the same range as the material of the sealant layer 48a. The thickness of the inner adhesive layer 48b may be selected from the same range as the thickness of each of the adhesive layers 48e and 48g.

Here, the results of the experiments performed by the inventors will be described.

### Example A

As a laminate according to Example A, the laminate 47 illustrated in FIG. 26E was produced. This laminate 47 included the sealant layer 48a, the inner adhesive layer 48b, the first film substrate for barrier layer 48d, the first barrier layer 48c, the first adhesive layer 48e, the resin layer 48f, the second adhesive layer 48g, the second barrier layer 48h, and the second film substrate for barrier layer 48i, in that order from the inner surface 47a toward the outer surface 47b.

As the first barrier layer 48c and the first film substrate for barrier layer 48d, a barrier film A was used in which an inorganic vapor-deposited layer corresponding to the first barrier layer 48c was disposed on a polyethylene terephthalate film corresponding to the first film substrate for barrier layer 48d. The barrier film A was IB-PET-PBIR available from Dai Nippon Printing Co., Ltd. The thickness of the barrier film A was 12 μm. The barrier layer 48 included in IB-PET-PBIR as the barrier film A included a first base barrier layer, a first overlayer, a second base barrier layer, and a second overlayer, in that order from the film substrate for barrier layer side. The first base barrier layer was a transparent vapor-deposited layer containing alumina. The second base barrier layer was a transparent vapor-deposited layer containing alumina.

As the second barrier layer 48h and the second film substrate for barrier layer 48i, the above-described barrier film A was used in which an inorganic vapor-deposited layer corresponding to the second barrier layer 48h was disposed on a polyethylene terephthalate film corresponding to the second film substrate for barrier layer 48i. That is, the second barrier layer 48h and the second film substrate for barrier layer 48i were formed of the same barrier film A as the first barrier layer 48c and the first film substrate for barrier layer 48d.

The resin layer 48f was made of Emblem ONMB-RT available from Unitika Ltd. The resin layer 48f was a biaxially stretched nylon film. The thickness of the resin layer 48f was 15 μm. Both the first adhesive layer 48e and the second adhesive layer 48g were made using Rockbond RU77T/H-7 as a thermosetting resin available from Rock Paint Co., Ltd. The thickness of the first adhesive layer 48e and the thickness of the second adhesive layer 48g were both 3 μm.

The sealant layer 48a was TPF-4 available from Okamoto Industries, Inc. The thickness of the sealant layer 48a was 30 μm. The inner adhesive layer 48b was a layer made from Rockbond RU77T/H-7 as a thermosetting resin available from Rock Paint Co., Ltd. The thickness of the inner adhesive layer 48b was 3 μm.

A laminate was produced from the above materials using a dry laminator with a gravure coating unit as described below. The resin layer 48f was laminated on the barrier film A constituting the first barrier layer 48c and the first film substrate for barrier layer 48d with the first adhesive layer 48e interposed therebetween. The barrier film A constituting the second barrier layer 48h and the second film substrate for barrier layer 48i was laminated on the resin layer 48f of the resulting laminate with the second adhesive layer 48g interposed therebetween. The sealant layer 48a was laminated on the resulting laminate with the inner adhesive layer 48b interposed therebetween. In this manner, the laminate according to Example A was produced.

### Example B

As the laminate according to Example B, the laminate 47 illustrated in FIG. 26E was produced in the same manner as the laminate according to Example A. The laminate according to Example B differed from the laminate of Example A in that a barrier film B was used instead of the barrier film A according to Example A. The laminate according to Example B was the same as the laminate according to Example A in terms of the sealant layer 48a, the inner adhesive layer 48b, the first adhesive layer 48e, the resin layer 48f, and the second adhesive layer 48g. A method for producing the laminate according to Example B was the same as the method for producing the laminate according to Example A, except that the barrier films were different.

In the laminate according to Example B, as the first barrier layer 48c and the first film substrate for barrier layer 48d, a barrier film B was used in which an inorganic vapor-deposited layer corresponding to the first barrier layer 48c was disposed on a polyethylene terephthalate film corresponding to the first film substrate for barrier layer 48d. The barrier film B was IB-PET-PXB2 available from Dai Nippon Printing Co., Ltd. The thickness of the barrier film B was 12 μm. The barrier layer included in IB-PET-PXB2 as the barrier film B included a first base barrier layer, a first overlayer, a second base barrier layer, and a second overlayer, in that order from the film substrate for barrier layer side. The first base barrier layer was a transparent vapor-deposited layer containing alumina. The second base barrier layer was a transparent vapor-deposited layer containing alumina.

In the laminate according to Example B, as the second barrier layer 48h and the second film substrate for barrier layer 48i, the above-described barrier film B was used in which an inorganic vapor-deposited layer corresponding to the second barrier layer 48h was disposed on a polyethylene terephthalate film corresponding to the second film substrate for barrier layer 48i. That is, the second barrier layer 48h and the second film substrate for barrier layer 48i were made of IB-PET-PXB2, similar to the first barrier layer 48c and the first film substrate for barrier layer 48d.

### Example C

As the laminate according to Example C, the laminate 47 illustrated in FIG. 26E was produced in the same manner as the laminate according to Example A. The laminate according to Example C differed from Example A in the resin film used for the sealant layer 48a, but was otherwise the same as Example A.

In the laminate according to Example C, the sealant layer 48a was CF7601A available from Toray Advanced Film Co., Ltd. The thickness of the sealant layer 48a was 30 μm.

A method for producing the laminate according to Example C was the same as the method for producing the laminate according to Example A, except that the resin film used for the sealant layer was different.

### Example D

As the laminate according to Example D, the laminate 47 illustrated in FIG. 26E was produced in the same manner as the laminate according to Example A. The laminate according to Example D differed from Example A in the resin film used for the resin layer 48f, but was otherwise the same as Example A.

In the laminate according to Example D, the resin layer 48f was E5102 available from Toyobo Co., Ltd. The resin layer 48f was a biaxially stretched polyethylene terephthalate film. The thickness of the resin layer 48f was 16 μm.

A method for producing the laminate according to Example D was the same as the method for producing the laminate according to Example A, except that the resin film used for the resin layer was different.

### Comparative Example A

The laminate of Comparative Example A included the sealant layer 48a, the inner adhesive layer 48b, the resin layer 48f, the first adhesive layer 48e, the first film substrate for barrier layer 48d, the first barrier layer 48c, the second adhesive layer 48g, the second barrier layer 48h, and the second film substrate for barrier layer 48i, in that order from the inner surface 47a toward the outer surface 47b. In the laminate according to Comparative Example A, the positions of the barrier film A constituting the first barrier layer 48c and the first film substrate for barrier layer 48d, and the resin layer 48f were reversed from those in the laminate according to Example A.

The laminate according to Comparative Example A was prepared as described below. The barrier film A constituting the second barrier layer 48h and the second film substrate for barrier layer 48i was laminated on the barrier film A constituting the first barrier layer 48c and the first film substrate for barrier layer 48d with the second adhesive layer 48g interposed therebetween. The resin layer 48f was laminated on the resulting laminate with the first adhesive layer 48e interposed therebetween, and then the sealant layer 48a was laminated thereon with the inner adhesive layer 48b interposed therebetween. In this manner, the laminate according to Comparative Example A was produced.

### Comparative Example B

The laminate of Comparative Example B included the sealant layer 48a, the inner adhesive layer 48b, the resin layer 48f, the first adhesive layer 48e, the first film substrate for barrier layer 48d, the first barrier layer 48c, the second adhesive layer 48g, the second barrier layer 48h, and the second film substrate for barrier layer 48i, in that order from the inner surface 47a toward the outer surface 47b. In the laminate according to Comparative Example B, the positions of the barrier film A constituting the first barrier layer 48c and the first film substrate for barrier layer 48d, and the resin layer 48f were reversed from those in the laminate according to Example C.

As a result, the laminate according to Comparative Example B differed from Comparative Example A in the resin film used for the sealant layer 48a, but was otherwise the same as Comparative Example A. The sealant layer 48a in the laminate according to Comparative Example B was CF7601A available from Toray Advanced Film Co., Ltd. The thickness of the sealant layer 48a was 30 μm.

A method for producing the laminate according to Comparative Example B was the same as the method for producing the laminate according to Comparative Example A, except that the resin film used for the sealant layer was different.

### Comparative Example C

The laminate according to Comparative Example C included the sealant layer 48a, the inner adhesive layer 48b, the resin layer 48f, the first adhesive layer 48e, the first barrier layer 48c, and the first film substrate for barrier layer 48d, in that order from the inner surface 47a toward the outer surface 47b.

In the laminate according to Comparative Example C, the sealant layer 48a, the inner adhesive layer 48b, the resin layer 48f, the first adhesive layer 48e, the first barrier layer 48c, and the first film substrate for barrier layer 48d had the same configurations as in the laminate according to Example A.

That is, in the laminate according to Comparative Example C, the sealant layer 48a was TPF-4 available from Okamoto Industries, Inc. The thickness of the sealant layer 48a was 30 μm. The inner adhesive layer 48b was a layer made from Rockbond RU77T/H-7 as a thermosetting resin available from Rock Paint Co., Ltd. The thickness of the inner adhesive layer 48b was 3 μm. The resin layer 48f was made of Emblem ONMB-RT available from Unitika Ltd. The thickness of the resin layer 48f was 15 μm. The first adhesive layer 48e was made using Rockbond RU77T/H-7 as a thermosetting resin available from Rock Paint Co., Ltd. The thickness of the first adhesive layer 48e was 3 μm. As the first barrier layer 48c and the first film substrate for barrier layer 48d, a barrier film A was used in which an inorganic vapor-deposited layer corresponding to the first barrier layer 48c was disposed on a polyethylene terephthalate film corresponding to the first film substrate for barrier layer 48d. The barrier film A was IB-PET-PBIR available from Dai Nippon Printing Co., Ltd. The thickness of the barrier film A was 12 μm.

The first barrier layer 48c was a vapor-deposited layer containing alumina.

The laminate according to Comparative Example C was produced as described below. The resin layer 48f was laminated on the barrier film A constituting the first barrier layer 48c and the first film substrate for barrier layer 48d with the first adhesive layer 48e interposed therebetween, and then the sealant layer 48a was laminated thereon with the inner adhesive layer 48b interposed therebetween. In this manner, the laminate according to Comparative Example C was produced.

### Evaluation 1 (Oxygen Transmission Rate)

The oxygen transmission rates (mL/(m²×day×atm)) of the laminates according to Examples A to D and Comparative Examples A to C, and Examples E and F and Comparative Example D described below, were measured. The oxygen transmission rate was measured in an environment of a temperature of 23 °C and a relative humidity of 40% RH with an OXTRAN (2/21) transmission rate measurement device manufactured by MOCON Inc., USA. The results are presented in the “Evaluation 1” column of Tables 4 and 5.

### Evaluation 2 (Water Vapor Transmission Rate)

The water vapor transmission rates (g/(m²×day)) of the laminates according to Examples A to D and Comparative Examples A to C were measured. The water vapor transmission rate was determined by measuring the weight change of a container containing calcium chloride as described below. First, using the laminates according to Examples A to C and Comparative Examples A to C, test containers having four-sided seal portions as illustrated in FIG. 7B were produced. The internal space of each test container was a 10 cm×10 cm square in plan view when the container was unfolded flat. The inner surface area of the test container was 200 cm². In the test container, 50 g of calcium chloride was placed. Immediately after closing the test container, the test container was stored in a test environment having a temperature of 40 °C and a humidity of 90% RH for 14 days. The weight increase of the test container before and after the placement of the test container in the test environment was measured as the amount of water vapor permeation (g) per 200 cm² of the laminate. From the measurement results, the water vapor permeability (g/(m²·day)) of each of the laminates according to the examples and comparative examples was determined. The results are presented in the “Evaluation 2” column in Table 4.

### Evaluation 3 (Transmission Haze)

From the laminates of Examples A to D and Comparative Examples A to C, samples each measuring 5 cm×10 cm were cut out. The samples were visually inspected to ensure there were no defects such as dust or scratches. The transmission haze of the laminate according to each example was measured by the method described above. The incident surface during the measurement was the inner surface 47a. The transmission haze was measured with an “HM-150” haze meter manufactured by Murakami Color Research Laboratory. The results of the transmission haze measurements are presented in Table 4.

### Evaluation 4 (Presence or Absence of Bubbles)

The laminates according to the examples and comparative examples were checked for the presence or absence of bubbles. The laminates were observed with the naked eye without using a microscope or the like. The evaluation criteria were as described below. The evaluation results are presented in the “Evaluation 4” column in Table 4.
A: The laminate was found to have minute bubbles when observed under a microscope, but no bubbles were observed from a distance of 30 cm with the naked eye, and the laminate was determined to be acceptable.
B: The laminate was found to have bubbles when observed with the naked eye from a distance of 30 cm, and the laminate was determined to be unacceptable.

TABLE 4
Evaluation results

| | | | | | Comparative | Comparative | Comparative |
|---|---|---|---|---|---|---|---|
| | Example A | Example B | Example C | Example D | Example A | Example B | Example C |
| Evaluation 1: | 0.14 | 0.04 | 0.14 | 0.04 | 0.14 | 0.14 | 0.20 |
| Oxygen transmission rate | | | | | | | |
| (mL/(m² × day × atm)) | | | | | | | |
| Evaluation 2: | 0.04 | 0.02 | 0.04 | 0.02 | 0.04 | 0.04 | 0.09 |
| Water vapor transmission rate | | | | | | | |
| (g/(m² × day)) | | | | | | | |
| Evaluation 3: | 11.7 | 12.9 | 56.2 | 12.1 | 13.2 | 58.2 | 58.2 |
| Transmission haze (%) | | | | | | | |
| Evaluation 4: | A | A | A | A | B | B | A |
| Bubbles | | | | | | | |

Regarding the appearance, the following evaluation was further performed.

### Example E

As a laminate according to Example E, a laminate excluding the sealant layer 48a and the inner adhesive layer 48b from the laminate 47 illustrated in FIG. 26E was produced. The laminate included the first film substrate for barrier layer 48d, the first barrier layer 48c, the first adhesive layer 48e, the resin layer 48f, the second adhesive layer 48g, the second barrier layer 48h, and the second film substrate for barrier layer 48i, in that order from the inner surface 47a toward the outer surface 47b.

In the laminate of Example E, as the first barrier layer 48c and the first film substrate for barrier layer 48d, a barrier film B was used in which an inorganic vapor-deposited layer corresponding to the first barrier layer 48c was disposed on a polyethylene terephthalate film corresponding to the first film substrate for barrier layer 48d. The barrier film B was IB-PET-PXB2 available from Dai Nippon Printing Co., Ltd. The thickness of the barrier film B was 12 μm. The first barrier layer 48c was a transparent vapor-deposited layer containing alumina.

In the laminate of Example E, as the second barrier layer 48h and the second film substrate for barrier layer 48i, the above-described barrier film B was used in which an inorganic vapor-deposited layer corresponding to the second barrier layer 48h was disposed on a polyethylene terephthalate film corresponding to the second film substrate for barrier layer 48i. That is, the second barrier layer 48h and the second film substrate for barrier layer 48i were made of IB-PET-PXB2, similar to the first barrier layer 48c and the first film substrate for barrier layer 48d.

The resin layer 48f was made of Emblem ONMB-RT available from Unitika Ltd. The resin layer 48f was a biaxially stretched nylon film. The thickness of the resin layer 48f was 15 μm. Both the first adhesive layer 48e and the second adhesive layer 48g were made using Rockbond RU77T/H-7 as a thermosetting resin available from Rock Paint Co., Ltd. The thickness of the first adhesive layer 48e and the thickness of the second adhesive layer 48g were both 3 μm.

A laminate was produced using the above-described materials as described below. The resin layer 48f was laminated on the barrier film B constituting the first barrier layer 48c and the first film substrate for barrier layer 48d with the first adhesive layer 48e interposed therebetween. The barrier film B constituting the second barrier layer 48h and the second film substrate for barrier layer 48i was laminated on the resin layer 48f of the resulting laminate with the second adhesive layer 48g interposed therebetween. The adhesive layers were applied with a bar coater. The resulting laminate was pressed with a press machine at a pressure of about 10 MPa for bonding. The laminate was then stored in an oven at 40 °C for 72 hours to cure the adhesive layers. In this manner, the laminate according to Example E was produced.

### Example F

As a laminate according to Example F, a laminate excluding the sealant layer 48a and the inner adhesive layer 48b from the laminate 47 illustrated in FIG. 26E was produced in the same manner as for the laminate according to Example E. The laminate according to Example F differed from Example E in the resin film used for the resin layer 48f, but was otherwise the same as Example E. In the laminate according to Example F, E5102 available from Toyobo Co., Ltd. was used as the resin layer instead of Emblem ONMB-RT used as the resin layer in Example E. The resin layer 48f was a biaxially stretched polyethylene terephthalate film. The thickness of the resin layer 48f was 16 μm. A method for producing the laminate according to Example F was the same as the method for producing the laminate according to Example E, except that the resin layer was different.

### Comparative Example D

The laminate according to Comparative Example D included the first film substrate for barrier layer 48d, the first barrier layer 48c, the second adhesive layer 48g, the second barrier layer 48h, and the second film substrate for barrier layer 48i, in that order from the inner surface 47a toward the outer surface 47b. The laminate according to Comparative Example D differed from Examples E and F in that the laminate did not include the first adhesive layer 48e and the resin layer 48f between the barrier film B constituting the first barrier layer 48c and the first film substrate for barrier layer 48d and the barrier film B constituting the second barrier layer 48h and the second film substrate for barrier layer, but otherwise had the same configuration as Examples E and F.

A method for producing the laminate according to Comparative Example D was the same as the method for producing the laminates according to Comparative Examples E and F, except that the laminate according to Comparative Example D did not include the first adhesive layer 48e and the resin layer 48f.

### Evaluation 5 (Cloudiness)

The laminates according to the examples and the comparative examples were checked for the presence or absence of cloudiness. The laminates were observed with the naked eye without using a microscope or the like. The evaluation criteria were as described below. The evaluation results are presented in the “Evaluation 5” column in Table 5.
AA: The laminate exhibited no cloudiness and was determined to be acceptable.
A: The laminate exhibited cloudiness, but it was slight, so the laminate was determined to be acceptable.
B: The laminate exhibited cloudiness and was determined to be unacceptable.

### Evaluation 6 (Puncture Resistance)

The puncture resistance is measured according to the puncture strength test of JIS Z1707:2019. A test piece was fixed with a jig, and a semicircular needle having a diameter of 1.0 mm and a tip radius of 0.5 mm was pierced into the outer surface (the surface formed by the second film substrate for barrier layer) at a test speed of 50±5 mm/min, and the maximum force (N) until the needle penetrated was measured. Since the target samples did not have a sealant, the puncture resistance from the direction of the outer surface 47b was evaluated.

The maximum force (N) as the evaluation results was the arithmetic mean value of the measurements at five points. The evaluation results are presented in the “Evaluation 6” column in Table 5.

### [Table 5]

TABLE 5
Evaluation results

| | | | Comparative |
|---|---|---|---|
| | Example E | Example F | Example D |
| Evaluation 1: | 0.04 | 0.04 | 0.04 |
| Oxygen transmission rate | | | |
| (mL/(m² × day × atm)) | | | |
| Evaluation 5: | A | AA | B |
| Appearance (cloudiness) | | | |
| Evaluation 6: | 25.6 | 23.1 | 24.8 |
| Puncture resistance (N) | | | |

The evaluation results of Examples E and F, and Comparative Example D reveal that the appearance (cloudiness) is improved by disposing the resin layer between the two barrier layers. It is believed that the generation of bubbles was effectively suppressed in Examples B and D due to a phenomenon similar to the evaluation results.

Example E, in which the biaxially stretched nylon film was used as the resin layer, was excellent in puncture resistance.

In Example F, in which the biaxially stretched polyethylene terephthalate film was used as the resin layer, clouding was more effectively suppressed. Since the appearance (cloudiness) of Example F was good, a higher production speed was achieved in Example D.

Although the embodiments have been described with reference to specific examples, the above specific examples do not limit the embodiments. The embodiments described above can be carried out in various other specific examples, and various omissions, substitutions, changes, additions, and so forth can be made without departing from the gist thereof.

The first container 30 may include a label 37 (see FIG. 10). The label 37 may display information about the liquid. The label 37 may be attached to the container body 32. To allow the observation of the inside of the container body 32, the label 37 need not extend all the way around the body. To allow observation of the description on the label 37, the label 37 may face the second container 40. When the first container 30 is a vial, the container body 32 may be exposed between the label 37 and the stopper 34 and the fixture 36 by 10 mm or more, preferably 20 mm or more. The liquid in the first container 30 can be observed through the transparent container body 32. The amount of oxygen in the first container 30 can be measured by irradiation of light through the transparent container body 32. In this case, in addition to the neck portion 32c of the container body 32, the body portion 32b may be exposed between the label 37 and the stopper 34 and the fixture 36.

In the above-described specific example, the first container 30 includes the container body 32 and the stopper 34, and the stopper 34 has oxygen permeability. However, at least a portion of the container body 32 may have oxygen permeability, and the stopper 34 may have an oxygen barrier property. The specific configuration of the second container 40 described above is merely an example, and various changes can be made.

To maintain the relative position between the oxygen absorber 21 or the oxygen-absorbing member 22 and the oxygen-permeable portion of the first container 30, the oxygen absorber 21 or the oxygen-absorbing member 22 may be fixed to the first container 30 using heat sealing or a bonding material. The oxygen absorber 21 or the oxygen-absorbing member 22 may be fixed to a portion of the first container 30 other than the oxygen-permeable portion. With these configurations, an appropriate relative positional relationship is maintained between the oxygen absorber 21 or the oxygen-absorbing member 22 and the oxygen-permeable portion of the first container 30, and the transfer of oxygen from the inside to the outside of the first container 30 can be stably promoted.

In the example illustrated in each of FIGS. 1 and 8, the container body 32 and the fixture 36 have the oxygen barrier property, and the stopper 34 has oxygen permeability. In the example illustrated by the dash-dot-dot line in each of FIGS. 1 and 8, the oxygen-absorbing member 22 including the oxygen absorber 21 is disposed to face the stopper 34 having oxygen permeability. The oxygen-absorbing member 22 including the oxygen absorber 21 may be in contact with the stopper 34 having oxygen permeability. The oxygen-absorbing member 22 including the oxygen absorber 21 may be in contact with only a portion of the stopper 34 having oxygen permeability. The oxygen-absorbing member 22 including the oxygen absorber 21 may be disposed with a gap provided between it and the stopper 34 having oxygen permeability. The oxygen absorber 21 and the oxygen-absorbing member 22 indicated by the dash-dot-dot line in each of FIGS. 1 and 8 can promote the transfer of oxygen from the inside to the outside of the first container 30. The second container 40, which has flexibility and the oxygen barrier property, can be suppressed from coming into contact with the stopper 34 of the first container 30, which has oxygen permeability.

The oxygen-absorbing member 22 may be fixed to the first container 30 in order to maintain the relative position of the oxygen-absorbing member 22 and the stopper 34. The oxygen-absorbing member 22 including the oxygen absorber 21 may be fixed to the stopper 34, the fixture 36, or the first container 30 using heat sealing or a bonding material. When the oxygen-absorbing member 22 is fixed to the stopper 34, the oxygen-absorbing member 22 may be fixed to a portion of the stopper 34. The oxygen-absorbing member 22 may be fixed to the fixture 36 so as to ensure a gap between the oxygen-absorbing member 22 and the stopper 34.

### REFERENCE SIGNS LIST

D1 first direction
D2 second direction
D3 third direction
HS headspace
L30 length
S storage space
E41 folded edge
L liquid
10 combination container
10L liquid-containing combination container
15 supply pipe
15a outlet
20 container set
21 oxygen absorber
22 oxygen-absorbing member
22a package
22b water-retaining agent
23 oxygen-absorbing film
23a base material
24 dehydrator
25 oxygen detection member
26 display portion
30 first container
30X portion
30L liquid-containing first container
32 container body
33 opening portion
34 stopper
34a plate-shaped portion
34b insertion protruding portion
36 fixture
37 label
40 second container
40a opening
41a first film
41b second film
41bx bend apex portion
41c first gusset film
41d second gusset film
41x folded portion
42 container body
42a storage portion
42b flange portion
44 lid
46 laminate
47 laminate
47a inner surface
47b outer surface
48a sealant layer
48b inner adhesive layer
48c first barrier layer
48d first film substrate for barrier layer
48e first adhesive layer
48f resin layer
48g second adhesive layer
48h second barrier layer
48i second film substrate for barrier layer
48j second resin layer
48k third barrier layer
48l third film substrate for barrier layer
49 seal portion
49a first seal portion
49ae outer edge
49b first side seal portion
49be outer edge
49c second side seal portion
49ce outer edge
49d second seal portion
49X main seal portion
49Y auxiliary seal portion
49Ya first auxiliary seal portion
49Yb second auxiliary seal portion
49Z additional seal portion
49Ze inner edge
49Za first additional seal portion
49Zb second additional seal portion
50a main portion
50b extension portion
51 notch
52 to-be-opened portion
55 outer box
56 bottom portion
57 top portion
58 side wall portion
60 syringe
62 cylinder
63 cylinder body
64 needle
66 piston
67 piston body
68 gasket
69 cap
70 test container
71 partition wall portion
72 main wall portion
72A through-hole
73 barrier joint material
76 first flow path
77 second flow path
78 test chamber
78A supply line
78B discharge line
79 oxygen measurement device

1. A liquid-containing combination container, comprising:
a first container containing a liquid and having oxygen permeability; and
a second container containing the first container and having an oxygen barrier property,
wherein the second container includes a laminate,
the laminate includes an inner surface facing a storage space of the second container and an outer surface opposite to the inner surface,
the laminate includes a sealant layer, a first barrier layer, a first adhesive layer, a resin layer, a second adhesive layer, and a second barrier layer, in that order from the inner surface toward the outer surface,
each of the first adhesive layer and the second adhesive layer contains a cured product of a curable resin composition, and
the first adhesive layer is in contact with the resin layer and the second adhesive layer is in contact with the resin layer.

2. The liquid-containing combination container according to claim 1, wherein the resin layer contains a thermoplastic resin.

3. The liquid-containing combination container according to claim 2, wherein the resin layer is a stretched film.

4. The liquid-containing combination container according to claim 1, wherein the resin layer has a thickness of 5 μm or more.

5.-6. (canceled)

7. The liquid-containing combination container according to claim 1, wherein the laminate further includes a first film substrate for barrier layer in contact with the first barrier layer, and
the first barrier layer is positioned between the first adhesive layer and the first film substrate for barrier layer.

8. The liquid-containing combination container according to claim 1, wherein the second adhesive layer is in contact with the resin layer.

9. The liquid-containing combination container according to claim 8, wherein the laminate further includes a second film substrate for barrier layer in contact with the second barrier layer, and
the second barrier layer is positioned between the second adhesive layer and the second film substrate for barrier layer.

10. The liquid-containing combination container according to claim 1, wherein the first barrier layer is a transparent vapor-deposited layer, and the second barrier layer is a transparent vapor-deposited layer.

11. The liquid-containing combination container according to claim 1, wherein the resin layer contains a polyamide.

12. The liquid-containing combination container according to claim 1, wherein the laminate further includes a second resin layer and a third barrier layer, and
the second barrier layer, the second resin layer, and the third barrier layer are arranged in that order from the inner surface toward the outer surface.

13. The liquid-containing combination container according to claim 1, wherein the laminate has an oxygen transmission rate of less than 0.20 mL/(m²×day×atm).

14. The liquid-containing combination container according to claim 1, further comprising an oxygen absorber that absorbs oxygen in the second container.

15. The liquid-containing combination container according to claim 1, wherein an oxygen detection member that detects a state of oxygen in the second container is provided.

16. The liquid-containing combination container according to claim 1, further comprising:
an oxygen-absorbing member contained in the second container,
wherein the oxygen-absorbing member contains an oxygen absorber that absorbs oxygen in the second container,
the second container includes a first film and a second film, the first container being contained between the first film and the second film,
the first film and the second film are joined at a seal portion,
the seal portion includes a first seal portion positioned to face the first container,
the first seal portion is bent so as to project toward a side away from the first container in a direction in which the first seal portion and the first container face each other, and
the first container is positioned between the first seal portion and the oxygen-absorbing member in the direction in which the first seal portion and the first container face each other.

17. The liquid-containing combination container according to claim 16, wherein the second container is bent with the second film inside so that a first portion of the second container containing the first container and a second portion of the second container overlap,
the second portion is positioned on one side of the first portion in the direction in which the first seal portion and the first container face each other in a state where the second container before being bent is unfolded, and
the oxygen-absorbing member is bent together with the second container, with a middle portion of the oxygen-absorbing member positioned at a bend apex portion of the second film.

18. The liquid-containing combination container according to claim 1,
wherein the second container includes a first film and a second film, the first container being contained between the first film and the second film,
the first film and the second film are joined at a seal portion,
the seal portion includes a first seal portion positioned to face the first container,
the first seal portion is bent so as to project toward a side away from the first container in a direction in which the first seal portion and the first container face each other, and
the seal portion further includes a first side seal portion connected to one end of the first seal portion, a second side seal portion connected to the other end of the first seal portion, and an additional seal portion positioned between the first container and at least one of the first side seal portion or the second side seal portion.

19. A method for manufacturing a liquid-containing container using the liquid-containing combination container according to claim 1, the method comprising:
closing the second container containing the first container; and
adjusting an oxygen concentration by absorbing oxygen in the second container with an oxygen absorber,
wherein in the step of adjusting the oxygen concentration, oxygen in the first container permeates the first container to move outside the first container and is absorbed by the oxygen absorber in the second container.

20. A container set, comprising:
a first container containing a liquid; and
a second container containing the first container,
wherein the first container has oxygen permeability,
the second container has an oxygen barrier property,
the second container includes a laminate,
the laminate includes an inner surface facing a storage space of the second container and an outer surface opposite to the inner surface,
the laminate includes a sealant layer, a first barrier layer, a first adhesive layer, a resin layer, a second adhesive layer, and a second barrier layer, in that order from the inner surface toward the outer surface,
each of the first adhesive layer and the second adhesive layer contains a cured product of a curable resin composition, and
the first adhesive layer is in contact with the resin layer and the second adhesive layer is in contact with the resin layer.

21.-22. (canceled)
